(19) United States
(12) Patent Application Publication
(10) Pub. No.: US 2026/0361092 A1
(43) Pub. Date: Nov. 12, 2026

(54) Computer-Automated Systems and Methods for Evaluating and Predicting Distributed Energy Utilization

(71) Applicant: 8x Energy LLC, Sheridan, WY (US)

(72) Inventors: John Bradley Dukes, Frederick, MD (US); Babi Das, Naples, FL (US)

(73) Assignee: 8x Energy LLC, Sheridan, WY (US)

(21) Appl. No.: 19/670,918

(22) Filed: May 7, 2026

Related U.S. Application Data
(60) Provisional application No. 63/803,011, filed on May 9, 2025.

(51) Int. Cl. H02J 3/388; G05B 15/02; H02J 13/12; H02J 103/30; H02J 103/35

(52) U.S. Cl. CPC H02J 3/388; G05B 15/02; H02J 13/12; H02J 2103/30; H02J 2103/35; Y04S 10/50

(57) ABSTRACT

A computer-implemented method, system, and non-transitory computer-readable medium generate recommended distributed energy resource (DER) system configurations for customers. The method includes creating customer-specific data by receiving customer-provided data, external data, or generating synthetic data. A plurality of DER system variants are evaluated using the customer-specific data to predict performance characteristics. Candidate DER system configurations are generated based on the predicted performance characteristics. A DER recommendation output is produced comprising at least one selected DER system configuration and associated analytical data, including financial models, emission reduction projections, and resilience performance metrics. The DER recommendation output is then outputted. This approach enables efficient and accurate evaluation of complex DER options tailored to specific customer needs and goals.

### CROSS-REFERENCE TO RELATED APPLICATIONS

This application claims priority to U.S. Prov. Pat. App. No. 63/803,011, filed on May 9, 2025, entitled, “Computer-Automated Systems and Methods for Evaluating and Predicting Distributed Energy Utilization,” which is hereby incorporated by reference herein.

### BACKGROUND

The energy landscape is undergoing a significant transformation with the increasing adoption of distributed energy resources (DERs). These systems, which include solar photovoltaic panels, wind turbines, energy storage devices, and other localized power generation technologies (e.g. linear generation, combined heat and power, simple cycle, fuel cell, etc.), are reshaping how electricity is produced, stored, interconnected, distributed, and consumed. DERs enhance energy efficiency, reduce environmental impact, and increase grid resilience. As these technologies become more accessible and cost-effective, residential, commercial, industrial, public sector, and federal agency energy consumers are exploring methods to maximize integrating DERs into their energy strategies.

Traditional approaches to energy management and resource planning have primarily focused on centralized power generation, transmission, storage, and distribution systems. However, these methods face limitations in addressing the complexities introduced by DERs. The integration of diverse energy sources, each with its own generation profile and operational characteristics, presents challenges for system operators and energy consumers alike. Conventional energy assessment tools often struggle to accurately model the interactions between multiple DER components and their impact on overall customer energy consumption patterns and integration with the Utility Distribution Company(s) and the Independent System Operator(s) (“grid”). Additionally, existing methods for evaluating the financial viability of DER implementations may not fully capture the nuanced benefits and costs associated with these systems, including factors such as time-of-use pricing, demand charges, rebates, grants, tax deductions, and potential revenue streams from energy export or grid services (frequency regulation, demand response, load shedding).

There is a growing need for comprehensive tools and methodologies that can effectively evaluate and predict distributed energy utilization at the energy consumer level, and integration with the grid (solution). Such a solution would enable energy consumers to make informed decisions about DER investments, optimize system configurations, and maximize the benefits of these technologies. Furthermore, utilities and grid operators require advanced capabilities to assess the impact of widespread DER adoption on grid stability and plan for future infrastructure requirements. Addressing these challenges could facilitate the broader integration of DERs, supporting the transition towards a more sustainable and resilient energy ecosystem.

### SUMMARY

The sole purpose of this summary is to present some concepts related to some exemplary non-limiting embodiments in a simplified form as a prelude to the more detailed description of the various embodiments that follow.

Embodiments of the present invention relate to systems and methods for evaluating and recommending distributed energy resource (DER) configurations. The energy landscape is undergoing a significant transformation with the increasing adoption of DERs, driven by factors such as the need for enhanced energy efficiency, reduced environmental impact, and increased grid resilience. As these technologies become more accessible and cost-effective, residential, commercial, industrial, public sector, and federal agency energy consumers are exploring ways to integrate DERs into their energy strategies for existing and new facilities.

DERs may include various technologies for behind the utility meter (localized) power generation, storage, and operational management. Examples of DERs may include solar photovoltaic panels, wind turbines, energy storage devices (thermal, electrical), fuel cells, combined heat and power systems, linear generation, and other small/medium/large-scale power generation technologies. These systems may be installed behind the utility meter at the point of energy consumption, or in front of the utility meter allowing for more efficient energy distribution and utilization.

In addition to DERs, distributed energy services (DESs) play a role in the evolving energy ecosystem. While DERs typically refer to physical assets or technologies, DESs may encompass a broader range of energy-related services and solutions. DESs may include energy management systems, sequential operation matching generation system(s) to load(s) enabling a microgrid, demand response programs, virtual power plant services, and other software-based or service-oriented offerings that complement and enhance the functionality of DERs. These services may help optimize the performance of DERs, facilitate grid integration, and provide additional value streams for energy consumers and utilities alike.

The current marketplace for DERs and DESs is characterized by fragmentation, with numerous providers offering a wide array of technologies, services, and solutions. This fragmentation presents challenges for energy consumers seeking to identify and implement optimal DER configurations for their specific needs. The diversity of options, while potentially beneficial, also contributes to increased complexity in the decision-making process.

Evaluating DER options involves numerous complexities and obstacles. Energy consumers face difficulties in accurately assessing the potential benefits and drawbacks of different DER configurations across various performance metrics. Traditional approaches to energy management and resource planning struggle to address the intricacies introduced by DERs, particularly when considering the interactions between multiple DER components and their impact on overall energy consumption patterns.

Furthermore, existing methods for evaluating the financial viability of DER implementations do not fully capture the nuanced benefits and costs associated with these systems. Factors such as time-of-use pricing, demand charges, rebates, grants, tax deductions, and potential revenue streams from energy export or grid services may add layers of complexity to the financial analysis. Additionally, the rapidly evolving regulatory landscape and technological advancements in the DER field further complicate the evaluation process, often requiring frequent reassessment of options and strategies or abandonment of the DER project due to the time and expense of evaluating multiple potential DER's.

Embodiments of the present invention provide an integrated platform that enables users to efficiently assess and select optimal DER solutions tailored to their specific energy needs and goals. This Digital Engagement Energy Marketplace (DEEM) platform may streamline the complex process of analyzing and purchasing DER options by leveraging data integration, machine learning, and simulation techniques. In some cases, embodiments of the invention may synthesize customer-specific information with external market, regulatory, and environmental data to generate DER recommendations.

The DEEM platform may address the challenges of market fragmentation and evaluation complexity by providing a centralized hub for DER assessment and implementation. By consolidating diverse data sources and applying sophisticated analytical techniques, the platform may simplify the decision-making process for energy consumers. The system may offer a standardized approach to evaluating different DER configurations, potentially reducing the time and resources typically required to assess multiple options across various performance metrics.

Embodiments of the present invention may offer several potential benefits. For example, the systems and methods may enable more informed decision-making regarding DER investments by providing detailed technical and financial analysis. Additionally, the integrated platform approach may help users navigate the fragmented marketplace by offering a comprehensive view of available technologies and services. The DEEM platform may also adapt to evolving regulatory landscapes and technological advancements, potentially providing up-to-date and relevant recommendations over time.

In some embodiments, the DEEM platform employs machine learning and data science techniques to analyze complex datasets and generate insights. These techniques may include predictive modeling, pattern recognition, and optimization algorithms that can process large volumes of energy consumption data, market information, and technical specifications. The platform may utilize these capabilities to identify trends, predict future energy needs, and evaluate the potential performance of various DER configurations.

The system may generate tailored recommendations by considering multiple factors specific to each user's situation. For example, the platform may analyze historical energy usage patterns, local climate data, available physical space, financial constraints, and energy goals to propose DER configurations that best meet the user's needs. In some cases, the system may employ adaptive algorithms that refine recommendations based on user feedback and changing conditions, potentially improving the accuracy and relevance of suggestions over time.

Embodiments of the present invention may include a stage conceptual design capability, which may provide users with a preliminary design and layout for recommended DER configurations. This feature may offer visual representations and technical specifications that illustrate how the proposed systems could be integrated into existing infrastructure or planned new infrastructure. The stage conceptual design may represent a specific threshold of completion that could be any percentage, such as 10%, 20%, 30%, 40%, 50%, 60%, 70%, 80%, 90%, or 100%, depending on project requirements and complexity. In construction engineering practice, a 30% stage conceptual design typically includes basic floor plans, elevations, major design elements, preliminary cost and schedule estimates, and identification of key project requirements and constraints. This threshold may serve as an inflection point in project development, potentially empowering decision-makers in customer sectors to receive a reliable technical and financial foundation for moving forward and may function as a starting point for more detailed engineering and implementation planning, potentially streamlining the transition from evaluation to project execution. The purpose of establishing such a threshold is to provide sufficient detail for informed decision-making while avoiding unnecessary design costs before project approval. In some cases, this capability may help users better understand the practical implications of different DER technical and financial options and make more informed decisions about which configurations to pursue. The stage conceptual design approach may align with industry practices where design milestones (such as 30-60-90) represent progressively more detailed levels of design completion, with documentation requirements that may vary by project type, organization, and applicable guidelines.

In some embodiments, the DEEM platform may provide technical and financial evaluations of potential DER configurations. The system may analyze factors such as energy production power (measured in Watts, Kilowatts, Megawatts, Gigawatts), energy output (measured in kilowatt hours, megawatt hours, gigawatt hours), energy capacity (maximum output), capacity factor (actual use compared to potential), system efficiency, operational control sequencing, and integration requirements to assess the technical feasibility of different options. Financial evaluations may include detailed cost-benefit analyses, return on investment calculations, internal rate of return, simple payback, life cycle cost benefit analysis, and long-term financial projections that account for factors such as equipment costs, installation expenses, maintenance requirements, IRS useful life, and potential energy or non-energy revenue streams.

The platform may generate DER listings (DERLs) that offer detailed technical and financial evaluations tailored to each user's energy utilization objectives. These DERLs may include specifications of recommended DER components, system configurations, operational control sequencing, and performance projections. In some cases, DERLs may also provide comparisons between different DER options, highlighting the relative advantages and trade-offs of each configuration. Users may be able to review and compare multiple DERLs to identify the most suitable solutions for their specific needs.

Embodiments of the present invention may incorporate various distributed energy services (DESs) into the platform offerings. These services may include energy management systems that optimize DER performance, microgrid control and management capabilities, demand response programs, frequency regulation, load shedding or other Utility Distribution Company programs, that enable users to participate in grid stabilization efforts, financial energy arbitrage, and virtual power plant services that aggregate multiple DER systems at a single or multitude of location(s) for enhanced grid integration and market participation. The platform may also offer predictive maintenance services, real-time performance monitoring, and automated control systems as part of its DES offerings. By integrating these services with DER recommendations, the DEEM platform may provide users with comprehensive energy solutions that extend beyond hardware installations to ongoing operational support and optimization.

The DEEM platform may serve a diverse range of stakeholders in the energy sector. Potential users may include residential homeowners, commercial building managers, industrial facility operators, energy consultants, utility companies, public sector entities, federal entities, A&E firms, and municipal energy planners. In some cases, the platform may also be valuable for renewable energy developers, financial institutions, manufacturers, and policymakers seeking to understand and optimize DER implementations.

Users may leverage the platform to compare various DER options and make informed decisions. The system may provide interactive tools that allow users to adjust parameters such as budget constraints, energy goals, project schedule comparisons, and technology preferences to see how different configurations perform under various scenarios. In some embodiments, the platform may offer side-by-side comparisons of multiple DER configurations, highlighting key performance metrics, financial projections, and environmental impacts to facilitate decision-making.

Embodiments of the present invention may include additional features to support the entire DER implementation process. For example, the platform may offer a contractor selection module that matches users with qualified installation and maintenance providers based on project requirements and location, and finance companies willing to extend financing of the DER; and third party ownership where the DER is owned by a third party and energy is sold to the user through a power purchase agreement or energy services agreement. The system may also incorporate energy trading capabilities, allowing users to participate in peer-to-peer energy markets or grid services programs. In some cases, the platform may provide ongoing performance tracking and optimization recommendations to ensure that implemented DER systems continue to meet user needs and adapt to changing conditions over time.

Embodiments of the present invention may offer several potential benefits for users seeking to evaluate and implement DER. The DEEM platform may provide a comprehensive solution that addresses the challenges of market fragmentation and complex decision-making in the DER environment. By integrating data analysis, machine learning techniques, and tailored recommendations, the system may enable more informed and efficient DER planning and implementation.

The platform's ability to generate detailed technical and financial evaluations, along with visual conceptual designs, may help users better understand and compare different DER options. This holistic approach may potentially reduce the time and resources required for DER assessment and selection. Additionally, the incorporation of DES and ongoing optimization features may extend the value of the platform beyond initial implementation, supporting long-term energy management and efficiency.

By offering a centralized marketplace for DER solutions, contractor options, A&E firms, maintenance providers, financial services, asset ownership, and energy trading capabilities, embodiments of the present invention may streamline the entire DER ecosystem from planning to operation. This integrated approach may help various stakeholders in the energy sector navigate the complexities of DER adoption and maximize the benefits of these technologies. As the energy landscape continues to evolve, the DEEM platform may adapt to new technologies, market conditions, and regulatory changes, potentially providing users with up-to-date and relevant recommendations for their energy needs.

Other features and advantages of various aspects and embodiments of the present invention will become apparent from the following description and from the claims.

### BRIEF DESCRIPTION OF THE DRAWINGS

FIGS. 1A-1F are swim lane business process flow charts for evaluating and implementing distributed energy resource solutions according to one embodiment of the present invention.

FIGS. 1G-1I are business process flow charts for emission reduction prioritization according to one embodiment of the present invention.

FIG. 2 is a flowchart of a method for generating distributed energy resource recommendations according to one embodiment of the present invention.

FIG. 3 is a block diagram of a distributed energy resource recommendation system according to one embodiment of the present invention.

### DETAILED DESCRIPTION

Embodiments of the present invention relate to systems and methods for evaluating and recommending DER configurations.

Various embodiments may provide an integrated platform that enables users to efficiently assess and select optimal DER solutions tailored to their specific energy needs and goals.

The systems and methods described herein may streamline the complex process of analyzing DER options by leveraging advanced data integration, machine learning, and simulation techniques. In some cases, embodiments of the invention may synthesize customer-specific information with other similar customers, external market, regulatory, and environmental data to generate comprehensive DER recommendations.

Embodiments of the present invention may offer several potential benefits. For example, the systems and methods may enable more informed decision-making regarding DER investments by providing detailed technical and financial analysis. Additionally, the integrated platform approach may reduce the time and resources typically required to evaluate multiple DER configurations across various performance metrics.

In some embodiments, the systems and methods may include functionality to facilitate communication between users and the evaluation platform. This may allow for efficient data input, iterative refinement of recommendations, and clear presentation of results to support the DER selection process.

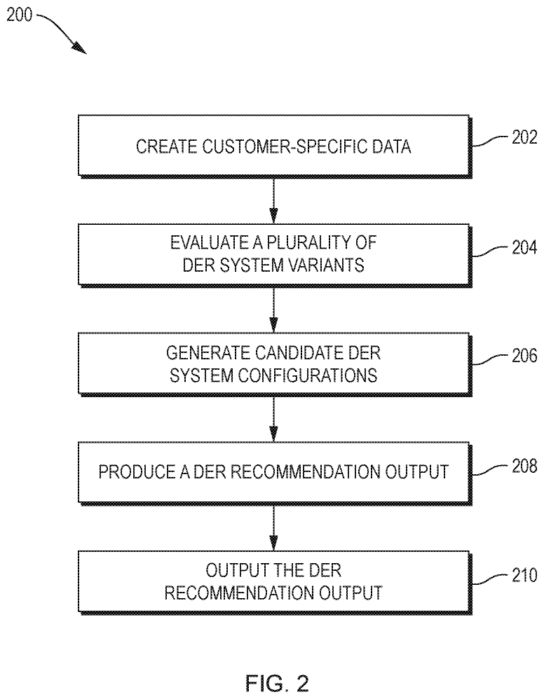

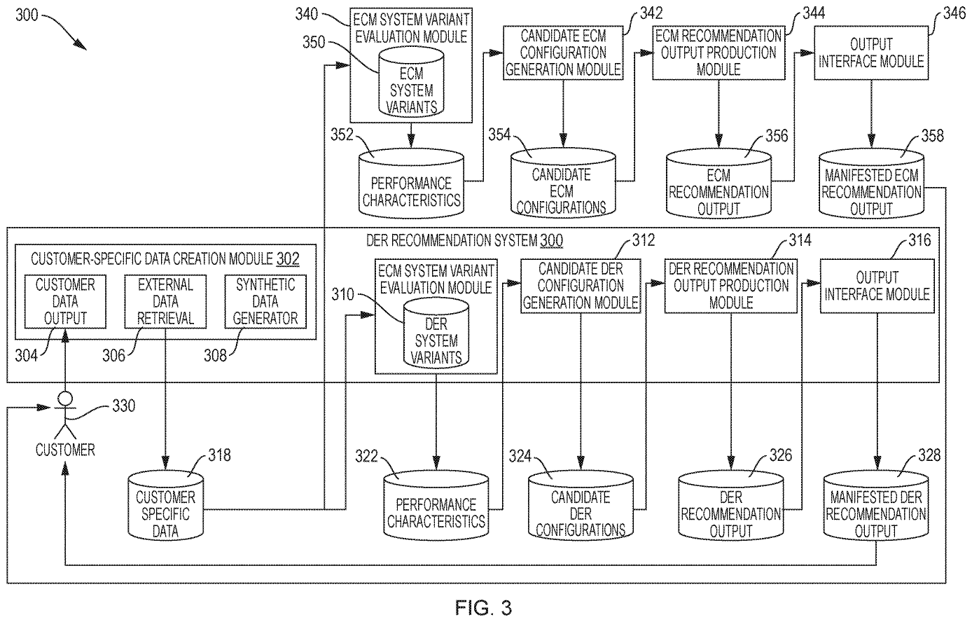

Embodiments of the present invention may provide a computer-implemented method for generating recommended DER system configurations for customers. This method may be implemented by the method 200 illustrated in FIG. 2 and may be performed by components of the recommendation system 300 of FIG. 3. The method 200 may include operations for processing customer-specific data, evaluating DER options, and producing tailored DER recommendations. These operations may work together to transform raw customer and market data into actionable DER configuration recommendations.

In some embodiments, the method 200 may begin with creating customer-specific data through any of a variety of means such as direct customer input, external data retrieval, and/or synthetic data generation. This customer-specific data may then be used to evaluate multiple DER system variants and predict their performance characteristics and their likelihood of satisfactorily meeting the customers' energy needs and goals. Based on this evaluation, the method 200 may generate candidate DER system configurations tailored to the customer's needs and goals.

The method 200 may culminate in the production and output of a DER recommendation. This recommendation output may include one or more selected DER system configurations along with supporting analytical data such as financial models, emission reduction projections, and/or resilience performance metrics.

By following this method 200, embodiments of the present invention may provide customers with comprehensive, data-driven recommendations for implementing DERs tailored to their specific circumstances and objectives.

Embodiments of the present invention may include creating customer-specific data 318 (FIG. 2, operation 202) as part of generating one or more recommended distributed energy resource (DER) system configurations. In some cases, the creation of the customer-specific data 318 may be performed by a customer-specific data creation module 302 of the recommendation system 300 shown in FIG. 3.

The data creation module 302 may include any of a variety of components for generating the customer-specific data 318. For example, the data creation module 302 may comprise any one or more of a customer data input module 304, an external data retrieval module 306, and a synthetic data generation module 308. These components may work together and/or independently to create customer-specific data 318 for use in subsequent DER evaluation and recommendation processes.

In some embodiments, creating the customer-specific data 318 may include receiving customer-provided data from the customer 330 via the customer data input module 304. For example, the customer 330 may input information such as any one or more of energy usage patterns, energy types, site characteristics, financial goals, energy goals, and preferences regarding DER technologies. This customer-provided data may form a basis for tailoring DER recommendations to the specific needs and circumstances of the customer 330.

The creation of the customer-specific data 318 may, additionally or alternatively, include receiving external data via the external data retrieval module 306. This external data may come from one or more sources other than the customer 330, such as any one or more of utility companies, state energy agencies, weather services, equipment manufacturers, financial companies, contractor companies, federal agencies, or regulatory databases. External data may provide additional context and constraints for DER evaluation, such as local energy prices, climate conditions, interconnect requirements, or available incentive programs.

Additionally or alternatively, the data creation module 302 may generate synthetic customer-specific data using the synthetic data generation module 308. This synthetic data generation may, for example, involve using machine learning models or statistical techniques to create artificial data that mimics real-world patterns and relationships. Synthetic data may be particularly useful when certain types of customer data are unavailable, incomplete, or subject to privacy restrictions. As this implies, the data creation module 302 may generate synthetic customer-specific data to supplement the customer-provided customer-specific data and/or the external customer-provided customer-specific data.

Any reference herein to “creating” the customer-specific data 318 may include receiving, generating, and/or otherwise processing such data. The customer-specific data 318 may include any one or more of the customer-provided customer-specific data received from the customer 330, the external customer-specific data received from at least one source other than the customer 330, and the synthetic customer-specific data, in any combination.

The data creation process performed by the data creation module 302 may involve performing various data processing techniques to ensure the quality and usability of the customer-specific data 318. These techniques may include, for example, any one or more of data cleaning, normalization, aggregation, or transformation. In some cases, the data creation module 302 may apply validation checks to verify the consistency and accuracy of the data from different sources.

In some embodiments, the terms “user,” “customer,” and “owner” may be used interchangeably to refer to an individual, organization, or entity that is considering, evaluating, or implementing a particular Distributed Energy Resource Listing (DERL). A user may include one or more entities that are currently consuming energy or those that anticipate future energy consumption or both. The user, customer, or owner may represent any of a variety of types of energy consumers, such as residential homeowners, commercial businesses, industrial facilities, educational institutions, healthcare providers, or government organizations. It should be understood that a customer may be an organization that includes one or a plurality of people. For example, a corporate customer may include a plurality of humans, each of whom may perform the functions disclosed herein by the customer 330 at the same or different times. For example, multiple such humans may provide different subsets of the customer-provided customer-specific data via the customer data input module 304. In such cases, the collective inputs from multiple individuals within the organization would together constitute the customer-provided customer-specific data from the customer 330.

The terms “manufacturer,” “contractor,” and “equipment” may, in some cases, be used interchangeably to denote entities or products involved in the supply chain of Distributed Energy Resources (DERs). A manufacturer may refer to a company that produces DER components or systems. A contractor may encompass service providers involved in the design, installation, or maintenance of DER solutions. Equipment may refer to the physical components, devices, or systems that comprise a DER installation. These entities or products may be interested in having their offerings included in the DERL service provided by the Digital Engagement Energy Marketplace (DEEM) platform.

In some embodiments, the system 300 may facilitate interactions between users and manufacturers, contractors, and/or equipment providers. The system 300 may enable users to access information about various DER options, while allowing suppliers to showcase their products or services through the DERL listings. This approach may create a comprehensive ecosystem for evaluating, selecting, and implementing DER solutions tailored to specific User requirements and preferences.

The creation of customer-specific data 318 may be an ongoing process. For example, the data creation module 302 may repeatedly (e.g., continuously) update and refine the customer-specific data 318 as new information becomes available or as the customer's circumstances change. As this implies, the system 300 may include multiple instances of the customer-specific data 318 at the same time and/or at different times. When changes (e.g., additions, deletions, or modifications) are made to the customer-specific data 318, the system 300 may replace the changed data with the new data in the customer-specific data 318, or supplement the old data with the new data, such as by storing a history (e.g., audit trail) of changes. This dynamic approach to data creation may allow the recommendation system 300 to provide up-to-date and relevant DER recommendations over time, thereby yielding new decisions for new DERLs.

By creating comprehensive and accurate customer-specific data, embodiments of the present invention may enable more precise and relevant DER recommendations tailored to each customer's unique circumstances and objectives. The method 200 and system 300 may be applied to different customers, each with their own customer-specific data. As this implies, the customer-specific data 318 may include different customer-specific data for different customers, and the method 200 may be performed separately for each customer's customer-specific data 318.

Embodiments of the present invention may include evaluating a single or a plurality of distributed energy resource (DER) system variants 320 using the customer-specific data 318 to predict a single or plurality of performance characteristics 322 of the DER system variants 320 (FIG. 2, step 204). In some cases, this evaluation may be performed by a variant evaluation module 310 of the recommendation system 300 shown in FIG. 3.

As used herein, the term “variant” may refer to a collection of attributes with specific values that define a particular configuration or instance of a distributed energy resource (DER) system. Different variants may have different attributes and/or attribute values, allowing for the representation of diverse DER system configurations.

Examples of variants particularly relevant to the invention may include:
Solar PV System Variant: Attributes: Panel type, total capacity, total power, total energy, inverter type, mounting system. Values: Monocrystalline panels, 100 kW capacity, string inverters, rooftop mounting.
Battery Storage System Variant: Attributes: Battery chemistry, storage capacity, power rating, cycle life. Values: Lithium-ion, 500 kWh capacity, 250 kW power rating, 5000 cycles.
Combined Heat and Power (CHP) System Variant: Attributes: Fuel type, electrical output, thermal output, efficiency. Values: Natural gas, 2 MW electrical, 2.5 MW thermal, 80% overall efficiency.
   Wind Turbine System Variant: Attributes: Turbine type, hub height, rotor diameter, rated power. Values: Horizontal axis, 80 m hub height, 100 m rotor diameter, 3 MW rated power.
Microgrid Control System Variant: Attributes: Control strategy, communication protocol, islanding capability, load management. Values: Hierarchical control, Modbus protocol, seamless islanding, dynamic load shedding.
Linear Generation System Variant: Attributes: Fuel type, power output, emissions profile, ramp rate. Values: Natural gas, 1.5 MW output, ultra-low NOx, 0-100% in 10 minutes.
Fuel Cell System Variant: Attributes: Cell technology, electrical output, fuel source, operating temperature. Values: Solid oxide, 200 kW output, hydrogen, 800 °C operation.
Small Modular Reactor (SMR) Variant: Attributes: Reactor type, thermal capacity, electrical output, cooling system. Values: Pressurized water reactor, 300 MWt, 100 MWe, passive cooling system.

These examples illustrate how variants may represent different DER technologies, sizes, configurations, and/or operational characteristics, allowing the system 300 to evaluate and compare a wide range of potential solutions for a given customer's needs.

The variant evaluation module 310 may utilize any of a variety of analytical techniques to assess the potential performance of different DER system variants. For example, the variant evaluation module 310 may employ one or more machine learning algorithms (e.g., one or more machine learning models), cognitive computing, automated reasoning, generative AI, contextual AI, or predictive analytics, individually or in any combination, to process the customer-specific data 318 and generate accurate performance predictions for each of the DER system variants 320.

The variant evaluation module 310 may include a plurality of hard layers for processing and analyzing the customer-specific data 318 and DER system variants 320. These hard layers may enable the variant evaluation module 310 to learn complex relationships and patterns across various input features. In some cases, the hard layers may consist of densely connected neural network layers that progressively extract higher-level representations from the input data. The number and configuration of these hard layers may be adjusted based on the complexity of the evaluation task and the volume of available data. By incorporating multiple hard layers, the variant evaluation module 310 may be able to capture intricate interactions between different aspects of DER systems and customer requirements, potentially leading to more accurate and comprehensive performance predictions.

The variant evaluation module 310 may include a plurality of soft layers for learning correlations for prespecified features identified by the customer 330. These soft layers are specialized neural network layers that focus on specific priority features such as resiliency, decarbonization, or financial considerations. Each soft layer may learn correlations for a particular feature category, enabling more nuanced evaluation of DER options based on the customer's specific preferences or priorities. Soft layers may also incorporate external data sources, such as web scraping for financial incentives, rebates, tax treatments, equipment pricing, tariff rate structures, or fuel costs, to enhance the accuracy of feature-specific evaluations. Examples of soft layers include those focused on equipment, labor, heat rates, efficacy, fuel usage, generation output of electricity, generation output of thermal, geotechnical considerations, irradiance, storage efficacy, and the like.

The method 200 may involve using the variant evaluation module 310 to assess multiple DER system variants 320 against the customer-specific data 318 created by the data creation module 302. This evaluation process may consider factors such as energy production capacity, efficiency, cost-effectiveness, compatibility with existing infrastructure, and enablement of operation through the Utility Distribution Company.

In some cases, the variant evaluation module 310 may analyze how different DER system variants 320 may perform under various conditions represented in the customer-specific data 318. For example, the variant evaluation module 310 may evaluate solar panel performance based on historical weather data, or assess battery storage systems against typical load profiles.

The output of this evaluation process may be a set of predicted performance characteristics 322 for each of the plurality of DER system, individually or combined, variants 320. These performance characteristics 322 may include metrics such as expected energy production, cost savings, emission reductions, and resilience improvements.

In some embodiments, the variant evaluation module 310 may perform comparative analyses between the customer's emission baseline data and their emission reduction goals, as well as between the baseline data and the potential emission reductions achievable through various DER variant options. The variant evaluation module 310 may first establish the customer's emission baseline using historical energy consumption data from the customer-specific data 318. This baseline may be calculated by applying appropriate emission factors to the customer's energy usage, taking into account the local grid's energy mix and any existing on-site generation.

Once the baseline is established, the module may compare it to the customer's stated emission reduction goals, which may be part of the customer-provided data and/or be derived from regulatory requirements applicable to the customer's industry or location. This comparison may yield a quantitative “emissions gap” that needs to be addressed through DER implementations.

The variant evaluation module 310 may assess each DER system variant 320 for its potential to reduce emissions. This assessment may include simulating the operation of each variant within the context of the customer's energy profile and local grid characteristics. The module may calculate the expected emissions reduction for each variant by considering factors such as any one or more of the following:
The carbon intensity of the energy displaced by the DER variant
The emissions associated with the manufacturing and installation of the DER equipment
Any ongoing emissions from the operation of the DER (e.g., for fuel-based systems)
The impact on grid emissions due to changes in the customer's load profile

The variant evaluation module 310 may compare the emission reduction potential of each DER variant against both the customer's baseline and their reduction goals. This comparison may result in a ranking of DER variants based on their effectiveness in meeting or exceeding the customer's emission objectives. For example, the module might determine that a solar PV system variant could reduce the customer's emissions by 30% compared to their baseline, while a combined solar PV and battery storage variant could achieve a 45% reduction. If the customer's goal is a 40% reduction, the module would identify the latter option as meeting the target, while the former falls short.

Furthermore, the variant evaluation module 310 may analyze combinations of DER variants to identify synergistic effects that could lead to even greater emission reductions. For instance, it might determine that combining solar PV, battery storage, and a smart energy management system could potentially reduce emissions by 60%, surpassing the customer's original goal.

This comparative analysis may be integrated into the broader evaluation process, allowing the variant evaluation module 310 to generate performance characteristics 322 that not only reflect the technical and financial aspects of each DER variant but also their alignment with the customer's emission reduction objectives. These insights may then feed into the configuration generation module 312, enabling the creation of candidate DER system configurations 324 that are optimized for emission reduction while still meeting other performance criteria.

By performing these detailed comparisons, the variant evaluation module 310 may provide customers with a clear understanding of how different DER options align with their emission reduction goals, and how these options compare to both their current baseline and the maximum potential reductions achievable through DER implementation.

By leveraging the techniques disclosed herein, embodiments of the present invention may provide detailed and accurate evaluations of multiple DER options tailored to each customer's specific circumstances and goals.

The performance characteristics 322 may include any of a variety of different performance characteristics in any combination. These characteristics may be particularly useful for evaluating DER system variants and their potential impact on a customer's energy profile. Some examples of performance characteristics that may be included in the performance characteristics 322, individually or in any combination, are:
Heat rate: This metric may measure the efficiency of fuel-based DER systems, indicating the amount of fuel required to produce a unit of electrical energy. A lower heat rate may suggest higher efficiency and potentially lower operational costs.
Financial performance: This may encompass various financial metrics such as net present value (NPV), internal rate of return (IRR), payback period, and levelized cost of energy (LCOE). These metrics may help assess the economic viability and long-term financial benefits of different DER configurations.
Emission impact: This characteristic may quantify the potential reduction in greenhouse gas emissions and other pollutants associated with each DER system variant. It may include metrics such as carbon dioxide equivalent (CO2e) emissions avoided or reduced.
Load matching: This metric may evaluate how well a DER system variant aligns with the customer's energy demand profile. It may consider factors such as peak demand reduction, load factor improvement, and the ability to shift energy consumption to optimal times.
Environmental impact: Beyond emissions, this may include broader environmental considerations such as land use, water consumption, noise pollution, and impact on local ecosystems.
Resilience metrics: These may assess the ability of DER system variants to maintain the capacity and quality of power supply during grid outages or other disruptions. Metrics may include expected outage duration reduction, critical load coverage percentage, and system reliability indices.
Power quality: This characteristic may evaluate the DER system's ability to maintain stable voltage and frequency levels, minimize harmonics, and reduce power factor issues.
Scalability and flexibility: These metrics may assess how easily a DER system variant can be expanded or modified to accommodate future changes in energy demand or technology advancements.
Integration complexity: This may evaluate the ease of integrating a DER system variant with existing infrastructure, considering factors such as grid interconnection requirements, control system compatibility, and installation challenges.
Operational performance: This may include metrics such as capacity factor, availability factor, and mean time between failures (MTBF) to assess the reliability and consistency of energy production.
Energy storage performance: For variants including storage components, this may encompass metrics such as round-trip efficiency, depth of discharge, and cycle life.
Demand response capability: This characteristic may evaluate a DER system variant's ability to participate in demand response programs, including metrics such as load reduction potential and response time.
Power Rating (Capacity): Maximum instantaneous power output (e.g., kW, MW).
Energy Rating: Total energy stored or produced over time (e.g., kWh, MWh for batteries).
Ramp Rate: Speed at which output can increase or decrease (e.g., MW per minute).
Efficiency: Ratio of useful output to input (e.g., % conversion efficiency).
Response Time: How fast the DER responds to a signal (e.g., seconds, milliseconds).
Dispatchability: Whether the resource can be controlled to turn on/off or vary output on command.
Availability: Percentage of time the DER is operational and available for service.
Capacity Factor: Ratio of actual output over a time period to maximum possible output.
Reliability: Consistency of performance without failure.
Resiliency: Ability to maintain operation during grid disturbances.
Power Quality Support: Ability to manage voltage, frequency, and harmonic distortion.
Voltage Control: Ability to support or regulate local voltage levels.
Frequency Regulation: Ability to help stabilize grid frequency by adjusting output.
Black Start Capability: Ability to restart without external grid power.
Inertia Contribution: (For some DERs) How much rotational inertia they provide to help grid stability.
State of Charge (for storage): Current energy stored relative to total capacity (important for batteries).
Thermal Limits: Maximum temperatures for safe operation (especially for batteries, inverters).
Emissions Profile: Amount of pollutants released, if any (e.g., for gas-powered DERs).
Grid Interconnection Standards Compliance: Adherence to rules like IEEE 1547 for safe grid operation.
Island Mode Operation: Ability to operate independently when disconnected from the main grid.
Degradation Rate: Speed at which performance declines over time (especially for batteries and solar).
Maintenance Requirements: Frequency and complexity of service needed to maintain optimal performance.
Cybersecurity Readiness: Security features to prevent cyberattacks.
Market Participation Capability: Ability to join energy markets (e.g., sell ancillary services).
Load Following: Ability to track and match varying consumer demand.
Bidirectional Flow: Ability to both consume and supply energy.
Levelized Cost of Energy (LCOE): A measure of the average cost per unit (e.g. MWh generated)
Levelized Cost of Storage (LCOS): A measure of the average cost per unit (e.g. MWh stored)

By considering these diverse performance characteristics, the variant evaluation module 310 may assess each DER system variant's potential performance across multiple dimensions. This multifaceted evaluation approach may enable the recommendation system 300 to generate more informed and tailored DER recommendations for each customer's unique energy needs and objectives.

Embodiments of the present invention may include generating a plurality of candidate distributed energy resource (DER) system configurations 324 based on the predicted plurality of performance characteristics 322 (FIG. 2, step 206). In some cases, this generation of candidate configurations may be performed by a configuration generation module 312 of the recommendation system 300 shown in FIG. 3.

Although FIG. 3 shows only the performance characteristics 322 as being provided as input to the candidate DER configuration generation module 312, this is merely an example embodiment. In practice, the configuration generation module 312 may receive and utilize any data disclosed herein to generate the candidate DER configurations 324. This may include, but is not limited to, any of the customer-specific data 318 in addition to the performance characteristics 322. As a result, although certain descriptions herein may refer to the use of the performance characteristics 322 to generate the candidate configurations 324, such descriptions should be understood to apply more generally to the use of any suitable data disclosed herein to generate the candidate configurations 324.

Incorporating the customer-specific data 318 into the configuration generation may offer benefits beyond what the performance characteristics 322 alone provide. For example, the customer-specific data 318 may include detailed information about energy usage patterns, physical site constraints, regulatory environments, long-term business plans, aesthetic preferences, and existing or planned energy infrastructure. By leveraging this context, the configuration generation module 312 may produce candidate DER configurations 324 that are not only optimized for performance but also closely aligned with the customer's specific needs, preferences, financial considerations, and circumstances. This approach enables the creation of forward-looking configurations that accommodate both current requirements and anticipated future changes in the customer's energy profile or operations, resulting in more integrated and adaptable DER solutions.

The configuration generation module 312 may utilize the performance characteristics 322 predicted by the variant evaluation module 310 to create one or a plurality of potential DER system configurations tailored to the customer 330's specific needs and goals. These candidate DER system configurations 324 may represent different combinations and arrangements of DER technologies that are expected to meet the customer 330's requirements based on the results of the evaluation performed by the variant evaluation module 310.

In some embodiments, the configuration generation module 312 may apply one or more optimization algorithms to identify the most promising DER system configuration(s), or identify the least promising by way of process elimination or both individually or simultaneously, while considering various energy storage options including electrical, thermal, and other forms of energy storage. The configuration generation module 312 may, additionally or alternatively, conduct output generation of any possible DER and seek to match any or all DER potential to the user load profile, instead of or in addition to computing the historical user data to search for the right combination of DER solutions. Examples of techniques that the configuration generation module 312 may use include genetic algorithms, particle swarm optimization, or multi-objective optimization to explore the solution space and generate the candidate configurations 324.

The method 200 may involve using the configuration generation module 312 to consider factors such as system size, technology mix, financial considerations, and operational strategies when creating candidate DER system configurations 324. For example, the configuration generation module 312 may generate configurations with different combinations of solar panels, differing methods of construction, battery storage, and backup generators, and/or explore various control strategies for demand response participation and grid integration for load following supply.

In some cases, the configuration generation module 312 may incorporate constraints derived from the customer-specific data 318 and/or market data when generating candidate configurations. These constraints may include factors such as available space for equipment installation, budget limitations, Utility Distribution Company requirements, and/or specific performance targets set by the customer 330.

The output of this configuration generation process may be a set of candidate DER system configurations 324, each representing a potential solution to meet the customer's energy needs. These candidate configurations 324 may vary in terms of technology composition, system size, expected performance, and other relevant characteristics.

Embodiments of the present invention may include producing a distributed energy resource (DER) recommendation output 326 (FIG. 2, step 208). In some cases, this production of the DER recommendation output 326 may be performed by an output production module 314 of the recommendation system 300 shown in FIG. 3.

The output production module 314 may utilize the candidate DER system configurations 324 generated by the configuration generation module 312 to create a comprehensive recommendation output. This DER recommendation output 326 may include at least one DER system configuration (i.e., one or a plurality of DER system configurations) selected from the plurality of candidate DER system configurations 324.

Although FIG. 3 shows only the candidate DER configurations 324 as being provided as input to the DER recommendation output production module 314, this is merely an example embodiment. In practice, the output production module 314 may receive and utilize any data disclosed herein to produce the DER recommendation output 326. This may include, but is not limited to, any of the customer-specific data 318 and/or the performance characteristics 322 in addition to the candidate DER configurations 324. As a result, although certain descriptions herein may refer to the use of the candidate DER configurations 324 to produce the DER recommendation output 326, such descriptions should be understood to apply more generally to the use of any suitable data disclosed herein to produce the DER recommendation output 326.

Incorporating additional data into the recommendation output production may offer benefits beyond what the candidate DER configurations 324 alone provide. For example, the customer-specific data 318 may include detailed information about customer preferences, financial constraints, and long-term energy goals. The performance characteristics 322 may provide insights into the expected performance of different DER configurations under various scenarios. By leveraging this additional context, the output production module 314 may generate DER recommendation outputs 326 that are not only based on optimal configurations but also tailored to the customer's specific circumstances and objectives. This approach may enable the creation of more comprehensive and personalized recommendations that consider a wider range of factors influencing the customer's decision-making process.

In some embodiments, the output production module 314 may generate one or more DER system configurations based on criteria such as performance metrics, cost-effectiveness, and/or alignment with the customer 330's stated preferences. The generation process may involve scoring, ranking, and/or filtering the candidate configurations 324 to identify the most suitable options.

The method 200 may involve using the output production module 314 to generate associated analytical data for each selected DER system configuration. This analytical data may provide detailed insights into the expected performance and impacts of the recommended DER systems.

For example, the associated analytical data may include at least one corresponding financial model for each selected configuration. These financial models may present projections of costs, savings, incentives, tax interdependencies, and return on investment over the partial or total lifetime of the DER system for one or more asset class owners.

These financial models may present projections of costs, savings, incentives, tax interdependencies, and return on investment over the partial or total lifetime of the DER system for one or more asset class owners. In some cases, the financial models may account for factors such as equipment costs, installation expenses, ongoing maintenance, fuel costs, tax, and potential revenue streams from energy sales or incentive programs.

The output production module 314 may generate at least one corresponding emission profile that when compared to the historical emission profile will demonstrate the reduction projection for each selected DER configuration. These projections may estimate the potential decrease in greenhouse gas emissions or other pollutants resulting from the implementation of the recommended DER system. The emission reduction projections may consider factors such as the carbon intensity of the local grid, the renewable energy content of the proposed DER system, the carbon intensity of using localized liquid or gaseous fuel, and the customer 330's current emission profile.

The associated analytical data may include at least one corresponding resilience performance metric for each selected configuration. These metrics may assess the ability of the recommended DER system to maintain power supply and power quality during grid outages or other disruptions. Resilience performance may be quantified through measures such as expected outage duration reduction, critical load coverage, black start capability, island mode capability, system availably, outage avoidance costs, voltage and frequency stability, curtailment response, cyber-resilient control systems, geographic dispersal benefits, or system reliability indices.

In some embodiments, the DER recommendation output 326 may include DER listings (DERLs) with technical and/or financial evaluations tailored to the customer 330's energy utilization objectives. These DERLs may provide detailed specifications of the recommended DER systems, including equipment types, sizes, and configurations. The technical evaluations may cover aspects such as energy production capacity, efficiency, and integration with existing local, regional, or national infrastructure. Financial evaluations within the DERLs may present cost-benefit analyses, payback periods, and long-term financial impacts.

By producing comprehensive DER recommendation outputs with selected configurations and associated analytical data, embodiments of the present invention may provide customers with detailed, data-driven insights to support informed decision-making regarding DER investments.

Embodiments of the present invention may include outputting the distributed energy resource (DER) recommendation output 326 to produce manifested DER recommendation output (FIG. 2, step 210). In some cases, this outputting of the DER recommendation output 326 may be performed by an interface module 316 of the recommendation system 300 shown in FIG. 3. This manifested DER recommendation output 328 may represent the final form in which the DER recommendations are presented to the customer 330.

As used herein, the term “manifesting” data may include generating any kind of output based on some or all of the data, such as producing visual (e.g., text, images, and/or video), auditory, and/or haptic output based on some or all of the data. The output produced by manifesting data may be referred to herein as “manifested” data or a “manifestation” of the data. Any reference herein to manifesting data may include manifesting some or all of the data. Manifesting data may include manifesting the data via one or more user interfaces to provide manifested data that is perceived or perceptible directly by a human user.

In some embodiments, the interface module 316 may provide interactive features that allow the customer 330 to explore and act upon the DER recommendations. For example, the interface module 316 may enable the customer 330 to compare different equipment options or financing arrangements or emission profiles or resiliency options associated with the recommended DER configurations.

The method 200 may involve using the interface module 316 to present options for implementing the recommended DER systems. In some cases, the interface module 316 may allow the customer 330 to select contractors to provide final design and implementation and operations and maintenance services for the chosen DER configuration.

The interface module 316 may facilitate transactions related to the recommended DER systems. For example, the interface module 316 may provide functionality for the customer 330 to arrange financing for the DER system(s). This may include presenting various financing options, terms, potential lenders and potential alternative ownership.

In some embodiments, the interface module 316 may support energy-related transactions. For instance, the interface module 316 may enable the customer 330 to sell and/or purchase electricity, gas, or renewable energy products generated by their implemented DER systems. This functionality may help customers maximize the value of their DER investments by participating in energy markets.

The outputting process may involve various digital and print data visualization methods and user interface/engagement techniques to ensure the DER recommendations are presented in a clear and actionable manner. The interface module 316 may generate graphical representations, empirical and/or formulaic calculations, specifications, interactive charts, or detailed reports to communicate the recommendations effectively.

By providing an intuitive and feature-rich interface for outputting DER recommendations, embodiments of the present invention may enable customers to easily understand, evaluate, and act upon the suggested DER configurations, supporting informed decision-making and efficient implementation of distributed energy resources.

In some embodiments, the interface module 316 may enable the customer 330 to store one or more candidate DER system configurations as saved configurations in a persistent data store. For example, the customer 330 may select a candidate DER system configuration from the recommendation output 326 and save it for later retrieval and comparison. The system 300 may associate each saved configuration with a unique identifier and preserve the associated analytical data, such as financial projections, emission reduction calculations, and operational continuity metrics, as they existed at the time the configuration was saved. In some cases, the customer 330 may adjust one or more of the weighting parameters or the site-specific data via the interface module 316, and the system 300 may generate a revised plurality of candidate DER system configurations in response to the adjustment. The interface module 316 may then present a comparative analysis of the saved configuration and at least one of the revised candidate DER system configurations. This comparative analysis may quantify differences between the saved configuration and the revised configurations across one or more performance dimensions, such as cost, emissions reduction, and operational continuity metrics. For example, the interface module 316 may display side-by-side comparisons showing the change in projected cost savings, the change in estimated emission reductions, and the change in resilience performance metrics resulting from the parameter adjustment. This save-and-compare functionality may enable the customer 330 to explore the impact of different priorities and assumptions on the recommended DER configurations, facilitating more informed decision-making by allowing the customer 330 to understand the trade-offs associated with different weighting parameter selections.

Embodiments of the customer data input module 304 may provide various ways for the customer 330 to input customer-provided customer-specific data via one or more user interfaces. For example, in some cases, the customer data input module 304 may offer a web-based interface accessible through standard web browsers on various computing devices, such as desktop computers, laptop computers, smartphones, and tablet computers. This interface may present one or more forms/questionnaires for the customer 330 to fill out, capturing information such as energy usage patterns, facility characteristics, and business operations. The web interface may include user interface elements, such as dropdown menus, slider bars, checkboxes, upload capability(s) and/or text fields to streamline the data entry process.

The customer data input module 304 may provide a mobile application interface, allowing customers to input data using smartphones or tablets. This mobile interface may offer features such as camera integration for uploading utility bills or site photos, and GPS functionality for precise location data.

The customer data input module 304 may support direct file uploads. Customers may be able to upload spreadsheets, containing historical energy consumption data, equipment inventories; site CAD or PDF or other formatted building, electrical, mechanical, plumbing, architectural drawings; PDF or word or other formatted contracts or proposals, or other relevant information as part of the customer-provided customer-specific data. The customer data input module 304 may include file parsing capabilities to extract and process data from various file formats.

The system 300 may offer an API (Application Programming Interface) for customers with more advanced technical capabilities. This API may allow customers to programmatically submit data from their own systems or databases directly to the customer data input module 304.

The customer data input module 304 may include a voice-based interface, utilizing speech recognition technology. This may allow customers to provide information verbally, which may be particularly useful for initial consultations or quick updates.

The customer data input module 304 may include a graphical interface for inputting spatial data. This may include tools for customers to draw or annotate site layouts, mark equipment locations, or indicate areas for potential DER installations.

The system 300 may implement a wizard-style interface that guides customers through a predefined multi-stage onboarding protocol derived from an expert DER assessment methodology. This interface may provide a structured approach to collecting comprehensive customer-specific data necessary for accurate DER evaluation and recommendation.

The wizard-style interface may begin with an initial stage focused on gathering verified organizational and precise geospatial location data. This stage may prompt customers to input their organization's name, industry sector, and primary business activities. The interface may then utilize mapping tools and address validation services to capture and verify the exact geospatial coordinates of the customer's facility. This information may be useful for defining the operational context and determining the applicable regulatory jurisdiction for DER implementations.

In a subsequent stage, the wizard may guide customers through the process of uploading or inputting historical, time-series interval energy consumption data. The interface may request at least one or more months of data to capture seasonal variations in energy usage patterns. Customers may have the option to specify the resolution of the data, which may range from daily, hourly to 15-minute intervals or greater detail, depending on the availability and granularity of their energy metering systems. The wizard may include data validation checks to ensure the completeness and consistency of the uploaded information.

During this stage, the interface may also present customers with a selection of project prioritization objectives. Customers may be asked to explicitly choose and rank their priorities from an evolving set consisting of cost minimization, emissions reduction, and resilience maximization. The interface may provide explanatory information about each objective to help customers guide informed decisions.

The wizard may progress to a quantitative site assessment stage. Here, the interface may present a series of questions and input fields designed to capture detailed information about physical DER installation constraints. This may include prompts for available roof space for solar panels or other systems, land area for ground-mounted systems or other systems, electrical switchgear capacity for battery storage or other systems, and existing infrastructure details that may impact DER placement.

In the final stage, the wizard may focus on gathering customer-defined financial parameters. This may involve input fields for specifying budget constraints, tax status, preferred financing methods, short term and long-term financial goals, and required investment return thresholds. The interface may offer guidance on typical ranges for these parameters and potentially provide benchmarks based on industry standards or similar projects.

Throughout the wizard process, the interface may employ various data visualization techniques to help customers understand the information they are providing. This may include real-time feedback on data completeness, progress indicators for each stage, and summary views of inputted data for verification purposes.

The wizard-style interface may also incorporate adaptive logic, adjusting subsequent questions based on previous responses to ensure that only relevant information is requested from each customer. This approach may help streamline the data collection process and improve the overall user experience.

By guiding customers through this structured, multi-stage onboarding protocol, the wizard-style interface may enable the system to collect comprehensive and accurate customer-specific data. This data may then serve as the foundation for generating tailored DER recommendations that align closely with each customer's unique circumstances and objectives. The particular stages and sequence disclosed above is merely an example and not a limitation of how a wizard-style interface may be implemented.

The customer data input module 304 may include validation and/or feedback mechanisms, which may operate in real-time. For example, as customers input data, the interface may provide feedback on data quality, completeness, or potential inconsistencies, helping to ensure the accuracy of the customer-provided information.

The customer data input module 304 may offer a collaborative interface allowing multiple users from the customer's organization to contribute data simultaneously. This may include features such as shared workspaces, role-based access controls, multifactor authentication protocols, and version tracking.

The customer data input module 304 may provide integration with common third-party software used in energy management or facility operations. This may allow customers to import data directly from tools they already use, reducing duplicate data entry efforts.

The customer data input module 304 may provide any one or more of the features disclosed herein, in any combination. By offering these interface options, embodiments of the present invention may enhance the flexibility and user-friendliness of the customer data input process, thereby improving the quality and completeness of the customer-provided customer-specific data used in subsequent DER evaluations and recommendations.

Embodiments of the present invention may include automatically aggregating and integrating specifically targeted external data correlated to the customer context from one or a plurality of authoritative source types. Such external data may, for example, include any one or more of utility (e.g., electric and/or gas) tariff structures, meteorological records including solar irradiance, regional grid emission factors, governmental and utility DER incentive program parameters, and DER equipment performance specifications. This process may be part of the customer-specific data creation process (step 202) in method 200 of FIG. 2, and may be executed by components of the recommendation system 300 shown in FIG. 3.

The external data may be retrieved through various methods, which may include any one or more of: RESTful APIs, SOAP web services, GraphQL interfaces, direct SQL database connections, ODBC/JDBC database interfaces, FTP file transfers, SFTP secure transfers, XML data feeds, JSON data streams, CSV file imports, EDI (Electronic Data Interchange), OAuth authenticated connections, websocket real-time data streams, RSS/Atom feeds, screen scraping techniques, RPA (Robotic Process Automation), HTTP/HTTPS requests, proprietary utility data portals, MQTT protocols for IoT devices, blockchain-based data retrieval, OPC UA industrial protocols, SCADA system interfaces, CIM (Common Information Model) standard exchanges, Green Button energy data standard, OpenADR demand response protocols, vendor-specific equipment APIs, weather service data feeds, satellite imagery APIs, GIS data services, public dataset repositories, PDF data extraction tools, OCR for document processing, email data extraction, and webhook-based notifications. In some cases, the system may implement data caching, rate limiting, and retry mechanisms to optimize the retrieval process and handle potential connectivity issues.

The customer data input module 304 may present a data access request interface to the customer 330. This interface may take various forms, such as a web-based form, a mobile app screen, or a dedicated software application. The interface may explain the types of data the system is requesting access to and why this data is requested for the DER evaluation process.

The digital consent mechanism may be implemented in any of a variety of ways, such as any one or more of the following:
Checkbox confirmation: The customer 330 may check a box indicating they have read and agree to the data access terms.
Digital signature: The customer 330 may provide an electronic signature to authorize data access.
Two-factor authentication: The system may require the customer 330 to confirm their identity and consent through a secondary device or communication channel.
Biometric confirmation: For mobile applications, the system may use fingerprint or facial recognition to verify the customer 330's identity and consent.
Click-through agreement: The customer 330 may need to click an “I Agree” button after reviewing the terms of data access.
Letter of Authorization (LOA): The system may generate customized LOAs based on customer information and utility requirements, as described in the automated LOA management capabilities. These LOAs may be electronically approved by customers and automatically submitted to relevant utility companies to facilitate secure access to digital interval data.

Upon receiving authorization, the external data retrieval module 306 may initiate secure data retrieval from one or more user-authorized sources. These sources may include, for example, any one or more of the following:
Utility companies: To access historical energy consumption data and billing information. This may be facilitated through the automated LOA process, where the system submits approved LOAs to utilities and processes the returned data.
Smart meter systems: To retrieve detailed energy usage profiles.
Building management systems: To access data on facility operations and equipment performance.
Energy management systems: To access data on facility energy operations and equipment performance.
Weather services: To obtain local climate data relevant to renewable energy production.
Financial institutions: To retrieve information relevant to credit assessments or financing options.
Government databases: To access information on available incentives or regulatory requirements.
IoT devices: To collect data from connected energy-related devices within the customer's facility.

The retrieved data may be stored and processed in the customer-specific data 318 in compliance with applicable privacy and/or security standards. The interface module 316 may allow the customer 330 to access, delete, and/or modify the collected data or adjust their preferences. This interface may include features such as data visualization tools, edit functions, and/or options to revoke access to specific data sources. In some cases, the interface may also provide real-time status tracking of LOA submissions, allowing customers to monitor the progress of their utility data retrieval requests.

The synthetic data generation module 308 may selectively generate synthetic interval data, such as to augment identified deficiencies critical for simulation accuracy or to generate an implied load curve for new construction. This synthetic data, along with the validated customer-specific data and targeted external data, may be integrated to form a unified, time-aligned, integrated data set structured for computational DER evaluation. In some cases, when utility data access through LOAs is delayed or incomplete, the synthetic data generation module 308 may temporarily fill these gaps until the authorized data is received.

This data aggregation and integration process may have a variety of benefits, such as:
Enhanced data accuracy: By retrieving data directly from authorized sources, the system may reduce errors associated with manual data entry.
Time efficiency: Automated data retrieval may save customers time compared to manually inputting large amounts of historical data. The automated LOA management may further streamline this process by handling utility communications and data receipt.
Improved customer control: Giving customers the ability to manage their data may increase trust and transparency in the DER evaluation process.
Data privacy compliance: The explicit consent and user control mechanisms may help ensure compliance with data protection regulations.
Comprehensive data collection: Access to multiple authorized sources may allow for a more complete picture of the customer's energy profile and needs.
Real-time updates: The system may be able to periodically refresh data from authorized sources (e.g., daily, weekly, monthly), or in response to events (e.g., utility rate changes, equipment price updates, new incentive programs, or customer-initiated requests), ensuring recommendations are based on the most current information.
Customization: Customers may have the flexibility to choose which data sources to authorize, allowing for personalized evaluations.
Standardized utility engagement: The automated LOA management may provide a consistent approach to obtaining utility data across different providers with varying requirements.

By implementing this method, the DER recommendation system 300 may provide a more user-centric, efficient, and accurate data collection process, potentially leading to more tailored and effective DER recommendations.

The method 200 and system 300 may utilize various types of customer-specific data to generate and evaluate DER system recommendations. These data types may include strategic data and operational data, each providing valuable insights for the recommendation process.

Strategic data may for example, include historical (actual) and/or potential data. Historical data may include energy consumption records over multiple time periods (e.g., days, months, and/or years), which may help identify long-term trends, seasonal patterns, and overall energy usage behavior. Past utility bills and rate structures submitted by Utility Distribution Companies (electric) or Local Distribution Companies (natural gas) to their respective Public Utility Commissions, whether already decided or still pending, may provide insights into historical energy costs, future energy rate changes, and potential areas for cost reduction. Information about previous energy efficiency upgrades or DER installations may inform the system about the customer's existing energy infrastructure and past improvement efforts.

Potential data within the strategic category may, for example, include projected business growth and/or facility expansion or reduction plans, which may allow the system 300 to anticipate future energy needs and scale DER recommendations accordingly. Planned changes in operations or equipment may help predict shifts in energy demand patterns and adjust DER configurations to match. Target sustainability goals or emission reduction objectives may guide the system in prioritizing DER options that align with the customer's environmental aspirations.

The customer-specific data 318 may include operational data, which may provide valuable insights for evaluating DER system variants 320. In some cases, operational data may include energy data such as real-time power consumption from various facility systems, which may enable the system 300 to understand current energy usage patterns and identify peak demand periods. The operational data may include power quality measurements, such as voltage fluctuations and harmonics, which may help assess the suitability of certain DER technologies and potential grid integration challenges. Thermal energy requirements for heating and cooling may be included in the operational data, potentially informing recommendations for combined heat and power systems or thermal storage solutions.

Interval data may represent another important component of operational data within the customer-specific data 318. This may include high-resolution energy usage data, such as measurements taken at 1-minute intervals, industry standard 15-minute intervals, settlement and billing 30-minute intervals, time of use billing and basic analysis 60-minute intervals, which may allow for detailed analysis of load profiles and more precise DER sizing and configuration. Time-of-use electricity rates and demand charges may be incorporated into the interval data, potentially helping optimize DER recommendations to maximize cost savings during peak pricing periods. In some embodiments, the operational data may include renewable energy generation or other sources of generation data from existing systems, which may provide insights into the performance of current DERs and potential for expansion or integration. By incorporating these various types of operational data, the data creation module 302 may develop a comprehensive understanding of the customer's energy usage patterns and requirements, potentially enabling more accurate and relevant DER system recommendations and asset ownership potential.

The customer-specific data 318 may include various types of data that may enhance the accuracy and relevance of DER recommendations. For example, geospatial data of the customer's facility may help assess potential for solar installations, determine optimal equipment placement, and evaluate site constraints. Local weather patterns and solar irradiance data may inform predictions of renewable energy generation potential and system performance. Utility interconnection requirements and policies may guide DER recommendations to ensure compliance with local grid integration standards.

In some cases, the customer-specific data 318 may include information about available incentives, rebates, and tax credits for DER installations, which may influence the financial analysis and prioritization of different DER options. Facility occupancy schedules and operational hours may help tailor DER recommendations to match the customer's specific energy usage patterns. Equipment inventory and specifications may allow the system 300 to identify opportunities for energy efficiency improvements or equipment upgrades as part of the DER strategy.

The customer-specific data 318 may include Utility Distribution Company programs like demand response program participation history, which may inform recommendations for DER configurations that can enhance demand response capabilities. Energy storage capacity and performance data may help optimize recommendations for integrating new storage solutions with existing systems. Additionally, microgrid islanding and/or blackstart capabilities and critical load requirements may guide recommendations for enhancing energy resilience and backup power solutions. These various types of data, when incorporated into the customer-specific data 318, may provide a more comprehensive foundation for the variant evaluation module 310 to assess potential DER system variants 320.

The external data retrieval module 306 may retrieve various types of external data to incorporate into the customer-specific data 318, enhancing the accuracy and comprehensiveness of DER system recommendations. In some cases, the external data retrieval module 306 may access market data including wholesale electricity prices, day ahead prices, capacity market prices, ancillary services market data, fuel price forecasts, equipment cost trends, technology adoption rates, energy storage pricing data, and demand response program rates. This market data may provide valuable context for evaluating the economic viability of different DER system variants 320.

Regulatory data may form an important component of the customer-specific data 318. The external data retrieval module 306 may gather information on net metering policies, renewable portfolio standards, energy efficiency mandates, carbon pricing mechanisms, utility rate structures, interconnection standards, building energy codes, and permitting requirements. This regulatory information may help ensure that generated DER system configurations 324 comply with applicable rules and take advantage of available incentives.

Compliance data may be incorporated into the customer-specific data 318 to address various operational and safety requirements. The external data retrieval module 306 may collect information related to emissions reporting standards, carbon credits, white tags, safety regulations for energy systems, cybersecurity requirements for grid-connected devices, power quality standards, metering and telemetry requirements, environmental impact assessment guidelines, and occupational health and safety regulations. This compliance data may help ensure that recommended DER configurations meet all necessary standards and requirements.

Environmental data may be relevant for evaluating renewable energy components of DER systems. The external data retrieval module 306 may gather solar irradiance data, wind speed and direction data, temperature and humidity profiles, air quality indices, precipitation patterns, seasonal weather variations, extreme weather event frequency, degradation impacts, and topographical information. This environmental data may enable more accurate prediction of renewable energy production and system performance under various conditions.

The external data retrieval module 306 may collect other relevant data to further enhance the customer-specific data 318. This may include grid reliability statistics, transmission and distribution system constraints, local energy resource availability, community energy initiatives, renewable energy credits, demographic and economic indicators, energy consumption patterns by industry sector, technological advancements in DER equipment, and case studies of similar DER implementations. By incorporating these diverse types of external data, embodiments of the present invention may provide a more comprehensive foundation for evaluating DER system variants 320 and generating tailored recommendations for each customer 330.

The external data retrieval module 306 may access data from various authoritative sources such as government agencies, regulatory bodies, and industry-specific databases. For example, the module may retrieve energy market data from government energy information websites (e.g., EIA.gov), renewable energy information from government energy department websites (e.g., DOE.gov), weather data from meteorological agency websites (e.g., NOAA.gov), financial data from securities regulation websites (e.g., SEC.com), and utility rate information from utility company websites. The system may maintain a list of trusted external sources and implement secure protocols for accessing and integrating this data into the customer-specific data 318.

Synthetic data generation (SDG) may enhance the capabilities and performance of the distributed energy resource (DER) recommendation method 200 and system 300. For example, as part of step 202 of method 200 and implemented through the synthetic data generation module 308 of system 300, SDG may involve the creation of artificial data that mimics the statistical properties and patterns of real-world energy-related information.

In some aspects, SDG may address challenges associated with data scarcity, privacy concerns, and the need for diverse datasets to train and validate DER recommendation models. By generating synthetic data, the system 300 may augment limited real-world data, fill gaps in existing datasets, and create scenarios that may be rare or difficult to obtain from actual customer information.

The synthetic data generation module 308 may, for example, employ any of a variety of statistical modeling techniques and/or machine learning algorithms to produce realistic and statistically representative synthetic data. This artificially created data may include, for example, any one or more of the following: synthetic interval data, simulated DER performance metrics, and hypothetical customer profiles. In some cases, the generated synthetic data may be seamlessly integrated with customer-provided customer-specific data and/or external data to form a comprehensive dataset in the customer-specific data 318 for DER evaluation.

SDG may offer a variety of benefits to the DER recommendation process. It may enable more robust model training by providing larger and more diverse datasets, potentially improving the accuracy and generalizability of recommendations. As another example, synthetic data may facilitate testing and validation of the system 300 under a wide range of scenarios, including edge cases that may be rare in real-world data. As another example, by reducing reliance on sensitive customer information, SDG may help address privacy concerns and regulatory compliance issues.

In the context of the DER recommendation system 300, synthetic data generation may be particularly valuable for creating realistic energy consumption profiles, simulating DER performance under various conditions, and generating hypothetical customer scenarios to test and refine the recommendation algorithms. This approach may allow the system 300 to provide more accurate and tailored recommendations even in situations where real-world data may be limited or unavailable.

Synthetic interval data generation may include creating one or more artificial energy load profiles that closely mimic real-world patterns while preserving privacy and enabling testing of the DER recommendation system 300. In this context, an “interval” refers to a specific time period for which energy consumption or production data is measured and recorded, typically ranging from 1-second to 60-minute periods. Common intervals include 15-minute intervals (the standard for many utility companies), 30-minute intervals (used in some regional markets), 5-minute intervals (for more granular analysis), and 1-minute or even 1-second intervals (for highly detailed operational monitoring). For example, synthetic interval data might include artificially generated electricity consumption values for each 15-minute period throughout a day, week, or year, creating a complete time series that exhibits realistic patterns such as daily peaks, seasonal variations, and random fluctuations while not corresponding to any actual customer's usage data.

The synthetic data generation module 308 may employ any of a variety of techniques to generate realistic synthetic interval data. For example, one or more Generative Adversarial Networks (GANs) may be utilized to create highly realistic energy consumption profiles. In a GAN-based approach, two neural networks—a generator and a discriminator—may compete against each other. The generator may produce synthetic load profiles, while the discriminator may attempt to distinguish between real and synthetic data. Through iterative training, this process may result in the generation of synthetic interval data that closely resembles actual energy consumption patterns. Another technique that may be used to classify or predict an outcome the K-Nearest Neighbors Algorithm which uses cross-validation to find optimal values.

Variational Autoencoders (VAEs) may offer another powerful method for synthetic data generation. VAEs may learn a compressed representation of real energy load profiles and then generate new, statistically similar profiles from this learned distribution. This approach may be particularly useful for capturing the underlying structure and variability of energy consumption patterns across different customer types and time periods.

In some embodiments, the synthetic data generation module 308 may employ a diffusion model to generate synthetic load profile data. A diffusion model may operate by gradually adding noise to real load profile data over a series of steps until the data becomes indistinguishable from random noise, and then learning to reverse this process to generate new synthetic load profiles from noise. The iterative denoising process of a diffusion model may produce synthetic load profiles with high fidelity and diversity, and may offer advantages in training stability compared to other generative approaches. Additionally or alternatively, the synthetic data generation module 308 may employ a transformer-based generative model to generate synthetic load profile data. A transformer-based generative model may use self-attention mechanisms to capture long-range temporal dependencies in energy consumption patterns, such as correlations between energy usage at different times of day or across different seasons. The transformer-based generative model may be trained on sequences of historical load profile data to learn the temporal structure of energy consumption, and may then generate new synthetic load profile sequences that preserve these learned temporal relationships. In some cases, the synthetic data generation module 308 may combine diffusion models, transformer-based generative models, or any other generative techniques disclosed herein, individually or in any combination, to generate synthetic load profile data.

In some embodiments, the synthetic data generation module 308 may apply one or more probabilistic generative models that learn a probability distribution over historical load profiles to generate synthetic load profile data. For example, the synthetic data generation module 308 may employ a Bayesian network to model the conditional dependencies among variables that influence energy consumption, such as time of day, day of week, season, weather conditions, and facility occupancy. By learning the joint probability distribution over these variables from historical load profile data, the Bayesian network may generate synthetic load profiles that reflect realistic correlations among these factors. Additionally or alternatively, the synthetic data generation module 308 may employ a normalizing flow model to generate synthetic load profile data. A normalizing flow model may transform a simple base distribution (such as a Gaussian distribution) through a series of invertible transformations to learn a complex target distribution that matches the distribution of historical load profiles. The invertible nature of normalizing flows may allow the synthetic data generation module 308 to both generate new synthetic load profiles by sampling from the learned distribution and evaluate the likelihood of observed load profiles under the learned distribution. In some cases, the synthetic data generation module 308 may employ a variational inference model to approximate the posterior distribution over latent variables that characterize energy consumption patterns. Variational inference models, which may include but are not limited to variational autoencoders, may learn a lower-dimensional latent representation of load profile data and generate new synthetic load profiles by sampling from the learned latent space. These probabilistic generative models may be used individually or in any combination with each other and with the GAN-based and VAE-based approaches described herein.

Time-series models, such as Autoregressive Integrated Moving Average (ARIMA) models or more advanced variants like Prophet, may also be employed to generate synthetic interval data. These models may capture temporal dependencies, seasonality, and trends in energy consumption, allowing for the creation of realistic time-series data that reflects both short-term fluctuations and long-term patterns in energy usage.

Privacy-preserving data generation methods may be integrated into the synthetic data generation process to address data privacy concerns. For instance, differential privacy techniques may be applied to add controlled noise to the generated data, ensuring that individual customer information cannot be inferred from the synthetic datasets. This approach may allow for the creation of large, diverse datasets for model training and testing without compromising customer privacy.

The synthetic data generation module 308 may generate edge cases and anomalies that may be rare in real-world data but crucial for comprehensive system testing. For example, the synthetic data generation module 308 may create synthetic load profiles representing sudden spikes in energy demand, extended periods of low consumption, and/or patterns indicative of equipment malfunctions. These synthetic edge cases may help ensure that the DER recommendation system 300 can handle a wide range of scenarios and provide robust recommendations.

The generated synthetic interval data may be integrated with the customer-specific data 318, augmenting and enriching the available information for DER system evaluation. This combined dataset 318 may feed into step 204 of method 200, where the variant evaluation module 310 evaluates a plurality of DER system variants. By incorporating synthetic data, this evaluation process may benefit from a more diverse and comprehensive set of scenarios, potentially leading to more accurate and reliable performance predictions for different DER configurations.

In some cases, the synthetic data generation module 308 may create conditional synthetic data based on specific customer characteristics or environmental factors. For instance, it may generate synthetic load profiles conditioned on building type, climate zone, elevation, and/or industry sector. This approach may allow for the creation of tailored synthetic datasets that closely match the characteristics of specific customer segments, further enhancing the relevance and accuracy of the DER recommendations.

The synthetic interval data generation process may incorporate validation mechanisms to ensure the quality and realism of the generated data. These may include, for example, statistical tests to compare the distributions and temporal characteristics of synthetic and real data. Another example is domain-specific checks to verify that the synthetic load profiles adhere to known constraints and patterns in energy consumption.

By leveraging such synthetic data generation techniques, the DER recommendation system 300 may overcome limitations in available real-world data, enhance privacy protection, and improve its ability to provide accurate and tailored recommendations across a wide range of scenarios and customer types.

Synthetic DER performance data generation may be a component of the synthetic data generation module 308. This process may involve creating artificial data that simulates the performance characteristics of one or more distributed energy resource (DER) technologies under different operating conditions in parallel or in unison.

In some cases, the synthetic data generation module 308 may employ physics-based models to simulate DER output under various conditions. For example, the module 308 may generate synthetic time-series data representing the expected energy output of solar photovoltaic systems based on simulated solar irradiance, temperature, and/or panel characteristics. As another example, the module 308 may create synthetic performance data for wind turbines by modeling wind speed variations and turbine power curves. As another example, the module 308 may create synthetic performance data for natural gas fired generation systems based on the fuel mix/content to properly estimate fuel costs.

The synthetic data generation module 308 may focus on modeling the degradation of DER performance over time. This may involve creating synthetic datasets that simulate the gradual reduction in efficiency or capacity of DER systems over their operational lifetimes. For instance, the module 308 may generate performance curves showing how solar panel efficiency decreases over years of exposure to environmental factors, or how battery storage capacity fades with repeated charge-discharge cycles, or how routine maintenance decreases the rate or progression of degradation.

In some embodiments, the synthetic data generation module 308 may augment limited real-world training data with synthetic DER performance data. This approach may enable the system 300 to train more robust evaluation models, particularly for newer DER technologies or configurations where extensive real-world operational data may not be available. The augmented dataset may combine real performance data with synthetically generated scenarios, potentially improving the accuracy and generalizability of the DER evaluation process.

The synthetic DER performance data generated by the module 308 may be directly integrated with the DER system variants 320 in the system 300. This integration may allow the variant evaluation module 310 to assess a wider range of potential DER configurations, including those that may not have extensive real-world operational data or be considered prototypes. By incorporating synthetic performance data, the system 300 may evaluate hypothetical or innovative DER combinations that could offer improved performance or cost-effectiveness for specific customer scenarios.

Furthermore, the synthetic DER performance data may contribute to the prediction of performance characteristics 322 within the system 300. The variant evaluation module 310 may use this synthetic data to estimate performance metrics such as energy production, efficiency, and/or reliability for different DER system variants. This approach may enable more comprehensive and accurate predictions of how various DER configurations might perform under different operating conditions or over extended time periods.

In some cases, the synthetic data generation module 308 may create conditional synthetic DER performance data based on specific environmental and/or operational factors. For example, it may generate synthetic performance data for combined heat and power systems under varying thermal generation conditions, or for energy storage systems with different charge-discharge profiles and round-trip efficiencies. This conditional generation approach may allow for more nuanced and context-specific evaluation of DER system variants.

The synthetic DER performance data generation process may incorporate validation mechanisms to ensure the realism and accuracy of the generated data. These may include comparisons against known physical constraints, manufacturer specifications, and available real-world benchmarks. By rigorously validating the synthetic performance data, the system 300 may maintain the integrity and reliability of its DER evaluation and recommendation processes.

The synthetic data generation module 308 may generate synthetic customer profiles and/or preferences to enhance the capabilities of the DER recommendation system 300. This process may involve creating artificial customer data that reflects diverse characteristics, goals, and constraints relevant to DER implementation.

In some cases, the synthetic data generation module 308 may generate archetypal customer profiles representing typical segments within the DER market. These synthetic profiles may include attributes such as energy consumption patterns, financial constraints, sustainability goals, and/or risk tolerance. For example, the module 308 may create profiles for large industrial users focused primarily on cost savings, small commercial businesses prioritizing decarbonization with moderate budgets, or healthcare facilities emphasizing energy resilience above all else.

The synthetic data generation module 308 may also create diverse synthetic profiles specifically designed for testing the recommendation logic of the system 300. These profiles may incorporate a wide range of customer characteristics, preferences, and constraints to ensure the robustness of the recommendation module 314. For instance, the module 308 may generate profiles with varying combinations of energy usage patterns, financial parameters (e.g., preferred payback periods, investment thresholds), and/or prioritization of different objectives (e.g., cost reduction, emission reduction, resilience enhancement).

The synthetic customer profiles and preferences may influence steps 206 and 208 of method 200. In step 206, where the configuration generation module 312 generates candidate DER system configurations, the synthetic customer profiles may be used to tailor the generation process. The module 308 may leverage the synthetic profile data to create configurations that align with the specific characteristics and preferences of different customer archetypes. This approach may result in a more diverse and relevant set of candidate configurations, potentially improving the overall quality of recommendations.

In step 208, where the output production module 314 produces the DER recommendation output 326, the synthetic customer profiles and preferences may play a role in shaping the final recommendations. The module 314 may use the synthetic profile data to customize the presentation and prioritization of recommended DER configurations. For example, for a synthetic profile representing a customer highly focused on sustainability, the output production module 314 may emphasize configurations with greater emission reduction potential in the recommendation output. As an additional example, for a synthetic profile representing a customer highly focused on resiliency, the output production module 314 may emphasize configurations with great ability to recover for shocks or disruptions.

The synthetic customer profiles and preferences may also enable more comprehensive testing and validation of the recommendation system's performance across a wide range of customer scenarios. By generating a diverse set of synthetic profiles, the system 300 may evaluate its ability to provide tailored and effective recommendations for various customer types, potentially identifying areas for improvement or refinement in the recommendation algorithms.

In some embodiments, the synthetic data generation module 308 may create conditional synthetic customer profiles based on specific market segments, geographic regions, and/or industry sectors. This approach may allow for the generation of highly targeted synthetic datasets that closely match the characteristics of particular customer groups, potentially enhancing the relevance and accuracy of the DER recommendations for those segments.

The process of generating synthetic customer profiles and preferences may incorporate one or more validation mechanisms to ensure the realism and representativeness of the created data. These mechanisms may include comparisons against known customer demographics, market research data, and expert knowledge of customer behavior in the DER domain. By rigorously validating the synthetic customer profiles, the system 300 may maintain the integrity and reliability of its recommendation process across diverse customer scenarios.

The synthetic data generation module 308 may generate one or more synthetic utility rate structures to enhance the capabilities of the DER recommendation system 300. This process may involve creating artificial tariff structures that reflect the complexity and diversity found in real-world utility pricing schemes.

In some cases, the synthetic data generation module 308 may generate diverse tariff structures with varying combinations of time-of-use (TOU) periods, demand charge levels, tiered energy rates, and/or fixed costs. For example, the module 308 may create synthetic rate structures that include multiple TOU periods with different pricing for peak, mid-peak, and off-peak hours, combined with tiered energy rates that change based on total monthly consumption. These synthetic structures may incorporate various demand charge configurations, such as ratcheted demand charges or charges based on different measurement intervals.

The synthetic data generation module 308 may create edge cases and/or unusual tariff structures to stress-test the financial calculation logic of the system 300. For instance, the module 308 may generate synthetic rate structures with complex seasonal variations, multiple demand charge ratchets, or intricate rider fees. These synthetic edge cases may help ensure that the financial modeling components of the system 300 can handle a wide range of complex pricing scenarios and provide accurate cost projections for different DER configurations.

The synthetic utility rate structures may play a role in step 208 of method 200, where the output production module 314 produces the DER recommendation output 326. The financial models generated as part of the associated analytical data for each selected DER system configuration may leverage these synthetic rate structures to provide more comprehensive financial projections. By incorporating a diverse range of synthetic tariff structures, the system 300 may evaluate the financial performance of recommended DER configurations under various pricing scenarios, potentially improving the robustness and applicability of the financial models across different utility territories.

In some embodiments, the synthetic data generation module 308 may create conditional synthetic rate structures based on specific geographic regions, utility types, and/or customer classes. This approach may allow for the generation of targeted synthetic datasets that closely match the characteristics of particular utility pricing environments, potentially enhancing the relevance and accuracy of the financial projections in the DER recommendations.

The process of generating synthetic utility rate structures may incorporate one or more validation mechanisms to ensure the realism and representativeness of the created data. These mechanisms may include, for example, comparisons against known utility tariff structures, regulatory guidelines, and/or historical pricing trends. By rigorously validating the synthetic rate structures, the system 300 may maintain the integrity and reliability of its financial modeling processes across diverse utility pricing scenarios.

By leveraging these synthetic utility rate structures, the DER recommendation system 300 may provide more comprehensive and accurate financial projections as part of its recommendation output. This approach may enable customers to better understand the potential cost savings and financial implications of different DER configurations across a wide range of utility pricing scenarios.

The synthetic data generation module 308 may employ various techniques to ensure the realism and statistical validity of the synthetic data generated for use in the DER recommendation system 300. These validation techniques may maintain the integrity and reliability of the system's evaluation and recommendation processes.

In some cases, the synthetic data generation module 308 may utilize statistical comparison methods to validate the synthetic data against real-world datasets. For example, the module 308 may compare the distributions, correlations, and temporal patterns of synthetic interval data with those of actual energy consumption profiles. This comparison may involve techniques such as Kolmogorov-Smirnov tests for distribution similarity, autocorrelation analysis for time-series data, and/or machine learning-based anomaly detection to identify unrealistic patterns in the synthetic data.

The synthetic data generation module 308 may incorporate domain-specific validation rules based on physical constraints and expert knowledge. For instance, when generating synthetic DER performance data, the module 308 may apply checks to ensure that the simulated energy output remains within realistic bounds based on equipment specifications and environmental conditions. Similarly, for synthetic utility rate structures, the module 308 may validate that the generated tariffs adhere to common regulatory frameworks and pricing logic.

In some embodiments, the synthetic data generation module 308 may employ a feedback loop with the variant evaluation module 310 to iteratively refine the quality of synthetic data. The variant evaluation module 310 may provide specific feedback in the form of performance metrics (such as prediction accuracy, statistical similarity to real data, or model confidence scores) and/or error signals (such as mean squared error, distribution divergence measurements, or anomaly detection flags) based on how well the synthetic data supports accurate DER evaluations. This feedback may be used to adjust various aspects of the synthetic data generation process, including algorithm parameters, statistical distribution settings, temporal correlation factors, or feature importance weightings. For example, if the variant evaluation module 310 detects that synthetic load profiles lack realistic peak-to-base ratios, it may send targeted feedback to modify the generation parameters specifically for those characteristics. The feedback mechanism may operate continuously during system operation or at scheduled intervals, potentially improving the realism, relevance, and usefulness of the generated data over time.

The integration of synthetic data with real data in the DER evaluation process may be managed through various methods within the system 300. The data creation module 302 may combine synthetic customer-specific data generated by the synthetic data generation module 308 with real customer data received through the customer data input module 304 and external data retrieved by the external data retrieval module 306. This integration may result in a comprehensive customer-specific data 318 set that leverages the strengths of both real and synthetic data.

In some cases, the system 300 may use a weighted approach when integrating synthetic and real data. For example, the variant evaluation module 310 may assign higher confidence to real performance data when available, while using synthetic data to fill gaps or extend the range of scenarios considered. This weighted integration may help balance the reliability of real-world data with the expanded coverage provided by synthetic data.

The configuration generation module 312 may leverage the integrated dataset to create a diverse range of candidate DER system configurations 324. By incorporating both real and synthetic data, this module may generate configurations that are grounded in real-world constraints while also exploring innovative or hypothetical scenarios enabled by synthetic data.

The output production module 314 may utilize the integrated data throughout the process of generating the DER recommendation output 326. For instance, when producing financial models or emission reduction projections, this module 314 may clearly indicate which aspects of the analysis are based on real data versus synthetic data, providing transparency to the customer 330 about the basis of the recommendations.

The flow of both real and synthetic data through the system 300 may be managed to ensure consistency and traceability. Each data point, whether real or synthetic, may be tagged with metadata indicating its source and any transformations applied. This tagging may allow the system to track the influence of synthetic data on the final recommendations and provide appropriate caveats or confidence levels in the manifested DER recommendation output 328.

By carefully validating synthetic data and integrating it seamlessly with real data, the DER recommendation system 300 may leverage the benefits of expanded data coverage and scenario exploration while maintaining the reliability and relevance of its recommendations. This approach may enable the system to provide more comprehensive and nuanced DER evaluations, potentially improving its ability to meet diverse customer needs and adapt to evolving market conditions.

Embodiments of the present invention may leverage synthetic data in various ways to enhance the DER recommendation process. The synthetic data generation module 308 may produce diverse datasets that augment real-world data, potentially improving the robustness and accuracy of the DER recommendation system 300.

In some cases, synthetic data may enhance model training for the variant evaluation module 310. For example, the module 310 may use synthetically generated interval data to train one or more machine learning models that predict energy consumption patterns and/or DER performance. This approach may allow the system 300 to learn from a wider range of scenarios than might be available in real-world data alone, potentially improving the model's ability to generalize across different customer types and operating conditions.

The variant evaluation module 310 may also utilize synthetic data for testing and/or validation of its evaluation algorithms (FIG. 2, step 204). For instance, the module 310 may generate synthetic DER performance data representing edge cases or rare events, such as extreme weather conditions or equipment failures or long duration grid outages. By evaluating DER system variants 320 against these synthetic scenarios, the module may identify potential weaknesses or limitations in its evaluation methods, allowing for refinement and improvement of the algorithms.

Synthetic data may play a role in scenario planning and stress testing within the DER recommendation process. The configuration generation module 312 may leverage synthetic utility rate structures or hypothetical market conditions to generate candidate DER system configurations 324 that are robust across a wide range of potential future scenarios (FIG. 2, step 206). For example, the module 312 may use synthetically generated future energy price trajectories to evaluate the long-term financial performance of different DER configurations under various market conditions.

In some embodiments, the system 300 may employ synthetic customer profiles to stress test the recommendation process. The configuration generation module 312 may generate candidate DER system configurations 324 for synthetic customers with extreme and/or unusual characteristics, such as highly variable energy consumption patterns or unique financial constraints. This approach may help ensure that the recommendation system can provide suitable solutions for a diverse range of customer needs.

The use of synthetic data may extend to the validation of the overall recommendation process. The output production module 314 may generate DER recommendation outputs 326 for synthetic customer scenarios and compare the results against expected outcomes or expert judgments. This validation process may help identify areas where the recommendation system performs well and areas that may require further refinement.

Embodiments of the present invention may integrate synthetic data seamlessly with real-world data throughout the DER recommendation process. For example, in step 204 of method 200, the variant evaluation module 310 may combine real historical performance data with synthetic future scenarios to provide a more comprehensive evaluation of DER system variants 320. Similarly, in step 206, the configuration generation module 312 may use a mix of real and synthetic data to explore a wider range of possible DER configurations while still grounding the recommendations in real-world constraints and performance characteristics.

The synthetic data generation module 308 may also create conditional synthetic datasets tailored to specific evaluation or configuration generation tasks. For instance, the module 308 may generate synthetic interval data conditioned on specific building types or geographic locations, allowing for more targeted and relevant evaluations in step 204. In step 206, the module may produce synthetic financial data representing various economic scenarios, enabling the configuration generation module 312 to assess the robustness of different DER configurations under uncertain future conditions.

By leveraging synthetic data in these ways, embodiments of the present invention may enhance the capabilities of the DER recommendation system 300, potentially leading to more accurate, comprehensive, and tailored recommendations for diverse customer needs and market conditions.

In some embodiments, the customer-specific data 318 may include customer load profile data. Customer load profile data, also referred to as user load profile data, may represent information about a customer's energy consumption patterns over time. This data may be useful for accurately evaluating and recommending DER configurations that align with the customer 330's specific energy usage patterns.

Customer load profile data may include time-series measurements of electricity demand, showing how energy usage varies over different time intervals.

These intervals may, for example, range from 1-second to 60-minute periods, including common durations such as 5-minute, 15-minute (the standard for many utility companies), 30-minute (used in some regional markets), and hourly intervals, with some advanced monitoring systems even capturing millisecond-level data for highly sensitive applications. Customer load profile data may span various durations, potentially covering days, weeks, months, or even years of energy consumption history.

Components of customer load profile data may include, but are not limited to:
Power consumption: Measurements of electrical power usage, often recorded in kilowatts (kW) or megawatts (MW), at each time interval.
Energy consumption: The total energy used over a specific period, typically measured in kilowatt-hours (kWh) or megawatt-hours (MWh).
Peak demand values: The highest levels of power consumption reached during specific time periods, which may be crucial for sizing DER systems.
Base load levels: The minimum amount of power drawn by the customer over extended periods.
Time-of-use patterns: Information on how energy usage varies during different times of day, days of the week, or seasons.
Power factor: A measure of how efficiently electrical power is being used, which may be important for certain types of customers or DER configurations.
Reactive power consumption: Data on the portion of electricity that does not perform useful work but may be necessary for operating certain electrical equipment.

In some cases, customer load profile data may include additional contextual information such as any one or more of the following:
Temperature data: Corresponding weather information that may help explain variations in energy usage.
Occupancy schedules: For commercial or industrial customers, data on when facilities are typically in use.
Production data: For industrial customers, information on energy consumption related to specific production processes or equipment.
Electric vehicle charging patterns: For customers with electric vehicles, data on when and how much energy is used for charging.
On-site generation data: For customers with existing renewable energy systems, information on how much energy is being produced and when.

The customer-specific data 318 may include customer load profile data in various forms. For example, the customer-provided customer-specific data received from the customer 330 may include historical load profile data from the customer's utility bills and/or energy management systems. The external customer-specific data received from sources other than the customer 330 may include load profile data obtained from utility companies and/or third-party energy data providers. The synthetic customer-specific data generated by the system may include artificially created load profiles based on statistical models and/or simulations.

Any component of the customer-specific data 318 (e.g., the customer-provided customer-specific data, the external customer-specific data, or the synthetic customer-specific data) may, individually or in combination, represent customer load profile data. For instance, the system 300 may combine actual historical load data provided by the customer with synthetic data generated to fill gaps or project future usage patterns. Alternatively, the system 300 may use externally sourced load profile data to validate or augment customer-provided information.

The data creation module 302 may process and integrate these various sources of customer load profile data to create a comprehensive energy usage profile for the customer 330. This integrated load profile data may then be used by other components of the system 300, such as the variant evaluation module 310 and the configuration generation module 312, to assess DER options and generate tailored recommendations that align with the customer's specific energy consumption patterns.

The DER system variant evaluation module 310 may employ various techniques to evaluate the DER system variants 320 and predict the plurality of performance characteristics 322. Examples of such techniques include machine learning and non-machine learning approaches.

Examples of machine learning techniques that the variant evaluation module 310 may use to evaluate the system variants 320 include any one or more of the following:
Neural Networks: The module may utilize deep neural networks to analyze complex relationships between input variables and predict performance characteristics. For example, a neural network may be trained on historical energy consumption data, weather patterns, and equipment specifications to forecast energy production and efficiency for different DER configurations.
Random Forest: This ensemble learning method may be used to evaluate multiple decision trees simultaneously, potentially improving the accuracy of predictions for various performance metrics such as cost savings, emission reductions, and system reliability.
Support Vector Machines (SVM): The module may employ SVM algorithms to classify DER variants based on their predicted performance across multiple criteria, helping to identify optimal configurations for specific customer needs.
Gradient Boosting: Techniques like XGBoost or LightGBM may be used to create powerful predictive models that can handle a wide range of input features and provide accurate estimates of performance characteristics. XGBoost may offer advantages in processing speed and memory efficiency, while LightGBM may provide benefits through its leaf-wise tree growth strategy for handling large datasets of energy consumption patterns.
Reinforcement Learning: The module may implement reinforcement learning algorithms to optimize DER system control strategies, potentially improving overall system performance and adaptability to changing conditions.

Examples of non-machine learning techniques that the variant evaluation module 310 may use to evaluate the system variants 320 include any one or more of the following:
Physics-based Modeling: The module may utilize detailed mathematical models based on physical principles to simulate the performance of different DER components and system configurations.
Statistical Analysis: Traditional statistical methods such as regression analysis, time series forecasting with ARIMA or Prophet models, and Monte Carlo simulations may be employed to predict performance characteristics based on historical data and probabilistic scenarios. Prophet may be particularly useful for forecasting energy demand with strong seasonal patterns, while ARIMA models may help in capturing temporal dependencies in energy consumption data.
Rule-based Systems: The module may incorporate expert knowledge in the form of predefined rules and decision trees to evaluate DER variants based on established industry best practices and regulatory requirements.
Optimization Algorithms: Techniques such as linear programming, genetic algorithms like NSGA-II for multi-objective optimization, or particle swarm optimization may be used to find optimal DER configurations that maximize desired performance characteristics while meeting specified constraints. NSGA-II may be particularly valuable for balancing competing objectives such as cost minimization, emission reduction, and resilience maximization.
Mathematical Programming Formulations: The module may additionally or alternatively employ mathematical programming formulations to optimize DER configurations. For example, the module may use mixed integer linear programming (MILP) to model DER sizing and dispatch decisions as a combination of continuous and discrete variables subject to linear constraints. MILP formulations may be particularly useful for problems involving binary decisions, such as whether to include a particular DER component in a configuration, combined with continuous decisions such as the optimal capacity of that component. Other mathematical programming approaches that the module may use include quadratic programming, mixed integer nonlinear programming (MINLP), or stochastic programming formulations that account for uncertainty in input parameters such as future energy prices or weather conditions.
Scenario Analysis: The module may generate and evaluate multiple scenarios for each DER variant, considering factors such as varying energy prices, weather conditions, and equipment degradation over time.
Benchmarking: The performance of DER variants may be compared against industry benchmarks and similar implemented systems to provide context for the predicted performance characteristics.
Sensitivity Analysis: The module may assess how changes in various input parameters affect the predicted performance characteristics, helping to identify critical factors and potential risks for each DER variant. Techniques like SHAP (SHapley Additive exPlanations) values may be used to quantify the contribution of each input feature to the predicted performance.
Multi-criteria Decision Analysis: This approach may be used to evaluate DER variants across multiple, potentially conflicting criteria, helping to identify balanced solutions that meet diverse customer objectives. Explainability techniques such as LIME (Local Interpretable Model-agnostic Explanations) may be incorporated to provide transparent justifications for the recommendations.

The DER system variant evaluation module 310 may combine these techniques in various ways to provide comprehensive and robust evaluations. For example, the module 310 may use machine learning models to generate initial predictions, which are then refined using physics-based models and/or expert rules. The module 310 may employ ensemble methods that combine the outputs of multiple evaluation techniques to improve overall accuracy and reliability.

By utilizing this diverse set of evaluation methods, the DER system variant evaluation module 310 may provide thorough and nuanced assessments of the DER system variants 320, enabling the generation of more accurate and tailored recommendations for each customer's specific needs and objectives.

In some embodiments, evaluating the plurality of DER system variants 320 may involve simulating the performance of some or all of the system variants 320 to predict the plurality of performance characteristics 322. The variant evaluation module 310 may employ simulation techniques in conjunction with the machine learning and non-machine learning techniques described previously, creating a comprehensive evaluation framework that leverages the strengths of each approach.

Simulation may serve any of a variety of roles within the evaluation process. In some cases, it may function as a complementary method to validate and refine predictions generated by machine learning models. For example, after a neural network predicts energy production for a solar array, simulation techniques may verify these predictions under specific weather scenarios. In other instances, simulation may generate synthetic training data for machine learning models, particularly for rare events or edge cases that may not be well-represented in historical datasets. Additionally, simulation may operate as an alternative evaluation method when certain DER configurations lack sufficient historical data for effective machine learning analysis.

When conducting these simulations, the variant evaluation module 310 may take into account a wide range of factors that could influence system performance. These factors may include any one or more of the following:
Weather considerations: The module may incorporate historical weather data and climate projections to simulate how factors like solar irradiance, wind patterns, and temperature fluctuations could affect renewable energy generation and overall system efficiency. These simulations may then feed back into machine learning models to improve prediction accuracy across diverse weather conditions.
Fuel considerations: For DER variants that include fuel-based generation, the simulation may model fuel consumption rates, availability, and price volatility to assess operational costs and reliability. The results may supplement statistical analyses performed by non-machine learning techniques.
Predefined configuration rules: The module may apply industry best practices and design guidelines to ensure that simulated DER configurations adhere to established standards for safety and performance. These rule-based simulations may complement the pattern recognition capabilities of machine learning models.
Technical constraints: Simulations may account for limitations such as available space for equipment installation, existing electrical infrastructure capacity, and interconnection requirements. These constraints may be incorporated into both simulation scenarios and machine learning model parameters.
Compliance constraints: The module may incorporate relevant emissions regulations, safety standards, and grid integration requirements into the simulation parameters. The simulation outputs may then inform rule-based systems and machine learning models about compliance boundaries.
Financial constraints: Simulations may consider budget limitations, financing options, and return on investment targets specified by the customer. These financial simulations may provide inputs for the financial modeling techniques described previously.
Regulatory constraints: The module may model how different regulatory scenarios, such as changes in net metering policies or renewable energy incentives, could impact DER performance and financial viability. These regulatory simulations may generate scenarios for machine learning models to analyze.
Optimization strategies: The simulation process may employ various optimization algorithms to fine-tune system configurations for maximum efficiency, cost-effectiveness, or other specified objectives. These optimization techniques may work in tandem with machine learning approaches like reinforcement learning to iteratively improve configurations.
Emission consideration: The simulation process may employ various optimization methods to refine the emission output to meet the specified goal. These simulations may provide training examples for machine learning models focused on emission reduction.
Resiliency consideration: The simulation process may employ various microgrid control sequencing optimization methods to meet the specified goal. The results may inform both physics-based models and machine learning algorithms that predict resilience metrics.

By incorporating these diverse factors into an integrated evaluation approach that combines simulation with machine learning and non-machine learning techniques, the variant evaluation module 310 may generate more nuanced and realistic predictions of how different DER system variants 320 would perform in practice. In some embodiments, the system may employ an ensemble approach where predictions from simulations, machine learning models, and traditional analytical methods are weighted and combined to produce final performance characteristic estimates. This multi-faceted evaluation strategy may enable the method 200 and system 300 to provide more accurate and reliable DER recommendations tailored to each customer's unique circumstances and goals.

The plurality of DER system variants 320 may be evaluated using various techniques, including any one or more of the following:
The system may condition historical interval data through weather normalization algorithms and execute synthetic load-scenario generation to predict a future demand profile range. This approach may leverage techniques such as Generative Adversarial Networks (GANs), Variational Autoencoders (VAEs), time-series models like ARIMA or Prophet, or statistical sampling methods to generate realistic future demand scenarios. By applying these synthetic data generation techniques to historical data, the system may account for weather-related variations and produce a comprehensive range of possible future demand patterns for more accurate energy needs forecasting.
The system may then apply regulatory and technical constraint filters to the predicted future demand profile range to establish a code-compliant operational envelope. These filters may be obtained through a combination of methods, including retrieval from external regulatory databases containing National Electric Code (NEC) standards, automated API connections to utility company systems for interconnection limitations, integration with environmental compliance databases for emission regulations, and periodic updates from industry standard repositories. In some cases, the system may also incorporate user-provided constraint parameters that reflect specific local requirements or organizational policies. By incorporating these multi-source constraints, the system may ensure that recommended DER configurations adhere to relevant codes and regulations.
The evaluation process may apply regulatory and technical constraint filters to the predicted future demand profile range to establish a code-compliant operational envelope. These filters may include National Electric Code (NEC) standards, utility interconnection limitations, and emission regulations. By incorporating these constraints, the system may ensure that recommended DER configurations adhere to relevant codes and regulations.
The system may utilize trained machine learning models to predict essential performance characteristics for each DER variant under simulated site-specific conditions. These characteristics may include energy conversion efficiency and operational costs. By leveraging machine learning techniques, the system may generate more accurate predictions tailored to the unique conditions of each customer's site.
The evaluation process may involve simulating operational performance of individual DER variants and feasible combined configurations against the code-compliant operational envelope and cost considerations. This simulation may use the predicted performance characteristics to generate quantitative evaluation results. By simulating various configurations and combinations, the system may provide a comprehensive assessment of how different DER options might perform in real-world conditions.

These evaluation techniques may be used individually or in any combination to provide a thorough analysis of DER system variants. By employing multiple evaluation methods, the system may offer more robust and reliable recommendations for customers considering DER implementations.

In some embodiments, the method 200 and system 300 may implement microgrid simulation capabilities as part of evaluating the DER system variants 320. The variant evaluation module 310 may simulate a microgrid system comprising an integrated network of DER components, switches, and controls configured to operate in various modes, such as grid-connected mode (where the microgrid operates while connected to the main utility grid), islanded mode (where the microgrid operates independently from the main utility grid), and/or blackstart mode (where the microgrid restarts from a complete power outage without external power supply).

The simulated microgrid system may include multiple DER components such as grid supplied energy, solar photovoltaic systems, combustion turbines, combined heat and power systems, simple cycle systems, fuel cells, and energy storage devices. The simulation may also incorporate at least one load and a control apparatus programmed to manage power flow among the DER components and loads.

The variant evaluation module 310 may model the microgrid system's ability to maintain electrical stability, voltage regulation, and power quality. This may be simulated both autonomously and in coordination with external grid signals, allowing for assessment of the system's performance under different operational scenarios.

When simulating the microgrid system, the variant evaluation module 310 may evaluate its performance in response to various operating conditions. This may include assessing how the system handles transitions between grid-connected and islanded modes, which can be useful for ensuring reliable power supply during grid outages or other disruptions.

Simulation may serve any of a variety of roles within the evaluation process. In some cases, it may function as a complementary method to validate and refine predictions generated by machine learning models. For example, after a neural network predicts energy production for a solar array, simulation techniques may verify these predictions under specific weather scenarios. In other instances, simulation may generate synthetic training data for machine learning models, particularly for rare events or edge cases that may not be well-represented in historical datasets. Additionally, simulation may operate as an alternative evaluation method when certain DER configurations lack sufficient historical data for effective machine learning analysis. The machine learning models may, in turn, inform simulation parameters by providing optimized control logic or by predicting environmental conditions that serve as inputs to the simulation process.

By incorporating microgrid simulation capabilities alongside machine learning and non-machine learning techniques, the method 200 and system 300 may provide more comprehensive evaluations of DER system variants. This integrated approach may leverage the strengths of each method—the pattern recognition capabilities of machine learning, the physics-based accuracy of simulation, and the domain expertise embedded in non-machine learning techniques. In some embodiments, the system may employ an ensemble approach where predictions from simulations, machine learning models, and traditional analytical methods are weighted and combined to produce final performance characteristic estimates. This multi-faceted evaluation strategy may enable more accurate predictions of how proposed DER configurations would perform in real-world microgrid applications, taking into account complex interactions between different system components and operational modes.

In some embodiments, the variant evaluation module 310 may construct a digital twin of the customer's facility by integrating the customer-specific data 318 with a physics-based or data-driven simulation model. As used herein, a digital twin may refer to a virtual representation of the customer's physical facility and its energy systems that may be continuously or periodically updated with real-world data to reflect current operating conditions. The digital twin may incorporate the facility's physical characteristics, equipment specifications, energy consumption patterns, and environmental conditions to create a dynamic simulation environment. The variant evaluation module 310 may evaluate the plurality of DER system variants 320 against the digital twin to predict performance characteristics 322 under a plurality of operational scenarios, such as varying weather conditions, load patterns, grid outage events, or changes in utility rate structures. By leveraging a digital twin, the system 300 may provide more accurate and facility-specific predictions of how different DER configurations would perform in the customer's actual operating environment.

The configuration generation module 312 may generate a plurality of candidate DER system configurations 324 based on the predicted performance characteristics 322. The plurality of candidate DER system configurations 324 may be a ranked set. Any one or more of the following techniques, either individually or in any combination, may be used to generate the plurality of candidate DER system configurations:
Optimization algorithms: The configuration generation module 312 may employ one or more optimization techniques, such as genetic algorithms, particle swarm optimization, or multi-objective optimization to explore the solution space and identify promising DER system configurations. These algorithms may iteratively evaluate and refine potential configurations to maximize desired performance metrics while satisfying constraints. Such optimization algorithms may employ a weighted objective function derived from customer-prioritized goals to rank said candidate configurations, such as based on simulated financial, environmental, and/or resilience performance metrics.
Constraint-based generation: The configuration generation module 312 may incorporate constraints derived from the customer-specific data 318 when generating candidate configurations. These constraints may include factors such as available space for equipment installation, budget limitations, or specific performance targets set by the customer 330. By considering these constraints, the system may generate configurations that are feasible and aligned with the customer's requirements.
Identifying and assigning detailed component specifications, including manufacturer and model designation, retrieved from an integrated equipment database, for constituent DER elements within at least one highest-ranked candidate configuration.
Technology mix exploration: The configuration generation module 312 may consider different combinations and arrangements of DER technologies that are expected to meet the customer's requirements based on the performance characteristics 322. This may include exploring various mixes of solar panels, battery storage, backup generators, and other DER components. The configuration generation module 312 may assess how different technology combinations interact and complement each other to achieve desired performance outcomes.
Operational strategy variation: The configuration generation module 312 may generate configurations with different operational strategies, such as various control approaches for demand response participation or energy arbitrage. This may involve simulating different dispatch algorithms or energy management systems to optimize the performance of each configuration under various scenarios.
System sizing optimization: Configurations may be generated with different system sizes to explore how scaling impacts performance and cost-effectiveness. The configuration generation module 312 may evaluate a range of capacities for each DER component to identify the optimal sizing that balances performance, cost, and other relevant factors.
Performance-based selection: The configuration generation module 312 may use the predicted performance characteristics 322 to rank and select top-performing configurations for further refinement or presentation to the customer. This approach may help prioritize configurations that best meet the customer's specific objectives and requirements.
Scenario-based generation: Multiple configurations may be generated to address different scenarios or priorities, such as maximizing resilience, minimizing emissions, or optimizing financial returns. This may allow the system to provide a range of options that cater to different aspects of the customer's energy goals.
Iterative refinement: The configuration generation process may involve multiple iterations, with each round of generation informed by the results of previous evaluations to progressively improve the candidate configurations. This iterative approach may allow for fine-tuning of configurations based on detailed performance analysis and feedback.
Machine learning techniques: The module may leverage one or more machine learning models trained on historical data and performance predictions to suggest novel configurations that may not be immediately obvious through traditional engineering approaches. These models may identify patterns and relationships in the data that lead to high-performing configurations.
Modular composition: Configurations may be generated by combining pre-evaluated modular components in different ways, allowing for rapid exploration of a wide range of possible system architectures. This approach may enable efficient generation of diverse configurations by recombining well-understood building blocks of DER systems.

In some embodiments, the weighting parameters used in the optimization process may be obtained through any of a variety of methods, individually or in any combination. For example, the weighting parameters may be received from the customer 330 via a user interface, such as the wizard-style interface described herein, in which the customer 330 explicitly chooses and ranks priorities such as cost minimization, emissions reduction, and resilience maximization. Additionally or alternatively, the system 300 may compute the weighting parameters from facility constraints or regulatory requirements applicable to the customer's industry or location. For example, if regulatory requirements mandate a minimum percentage of emission reduction for the customer's facility, the system 300 may automatically assign a higher weighting to the emissions reduction performance metric to reflect this constraint. In some cases, the system 300 may determine the weighting parameters through a machine learning model applied to historical performance data. For example, the system 300 may train a machine learning model on historical data from previous DER implementations, including the weighting parameters used, the resulting DER configurations, and the actual performance outcomes, to predict weighting parameters that are likely to yield favorable results for a given customer profile. In some embodiments, the system 300 may apply default weighting parameters from a predefined configuration profile. For example, the system 300 may maintain a library of predefined configuration profiles associated with different customer segments, industry sectors, or geographic regions, each specifying default weighting parameters that reflect typical priorities for that segment. The system 300 may select and apply a default configuration profile based on the customer-specific data 318, and the customer 330 may subsequently adjust the default weighting parameters via the interface module 316.

By utilizing these various approaches, the configuration generation module 312 may produce a diverse set of candidate DER system configurations 324 tailored to the specific needs and objectives of each customer. This generation process may enable the method 200 and system 300 to explore a wide range of potential solutions and identify the most promising options for further evaluation and recommendation.

The configuration generation module 312 may incorporate external data sources, such as any of the external data in the customer-specific data 318, to inform the configuration generation process. This may include integrating equipment performance databases, energy market forecasts, or regulatory policy information. By considering these external factors, the configuration generation module 312 may generate configurations that are not only tailored to the customer's specific needs but also aligned with broader market trends and regulatory requirements.

In some cases, the configuration generation module 312 may allow for user input and/or preferences influence guide the configuration generation process. This user-guided generation approach may enable customers to interactively influence the configuration options based on their specific priorities or constraints. The configuration generation module 312 may provide interfaces for users to adjust parameters, set preferences, or exclude certain technologies, creating a more collaborative and customized configuration generation process.

The configuration generation module 312 may implement learning capabilities to improve its methods over time. The module may analyze feedback from implemented DER systems, user interactions, and performance data to refine its configuration generation algorithms. This ongoing learning process may enable the system 300 to adapt to evolving technologies, changing market conditions, and shifting customer preferences, potentially improving the quality and relevance of generated configurations over time.

The DER recommendation output 326 may take various forms to provide comprehensive and actionable information to the customer. In some cases, the output may include associated supporting documentation, equipment specifications, and engineering calculations. This detailed technical information may help customers and their technical teams understand the proposed DER system's capabilities and requirements.

The recommendation output 326 may include visual embodiments or renderings. These may comprise two-dimensional representations, such as automatically generated system diagrams including at least general arrangement, balance-of-plant, and single-line electrical schematics. These visual embodiments may help customers visualize how the proposed system would integrate with their existing infrastructure. In some instances, the output may feature three-dimensional views of the recommended DER system and its architecture deployed within a defined physical boundary, such as a campus, industrial park, or healthcare facility. These renderings may include a plurality of interconnected energy assets and control elements, spatially arranged to represent real-world installation zones of the DER plant.

In some embodiments, the DER recommendation output 326 may include multi-year financial proforma projections detailing costs, savings, incentives, tax implications, interest rate, and key financial metrics including Net Present Value (NPV), Internal Rate of Return (IRR), and payback period. These comprehensive financial analyses may enable customers to make informed investment decisions based on projected economic performance over the system's lifetime. The DER recommendation output 326 may include offers from third parties electronically or through other methods for customer acceptance.

In some embodiments, the DER recommendation output 326 may include multi-year third party ownership projections detailing initial energy rates, escalation rates, term of service provided through a power purchase agreement or energy services agreement or similar.

The recommendation output 326 may also include quantified emission reduction calculations detailing projected greenhouse gas emission decreases relative to a defined baseline. These calculations may help customers understand the environmental benefits of implementing the recommended DER system and may support sustainability reporting or compliance with emission reduction targets.

In some cases, the recommendation output 326 may comprise quantitative resilience performance metrics indicating capability to maintain critical loads during defined grid outage scenarios. These metrics may include outage duration coverage, percentage of critical load supported, and response time to grid disruptions, providing customers with clear insights into how the DER system would enhance their energy security.

The recommendation output 326 may include contractor recommendations based on experience and qualifications to construct the DER system. These recommendations may cover various specialties such as mechanical, electrical, design, and architectural contractors, providing customers with a curated list of qualified professionals to assist with project implementation.

In some implementations, outputting the recommendation output 326 may involve presenting the information via a user interface. This interface may be the same one used to receive the customer-provided customer-specific data, creating a seamless experience for the customer throughout the entire process from data input to recommendation review. The system 300 may further provide, via said graphical user interface, the DER recommendation output 326, including access to a downloadable, formatted electronic report containing said generated recommendations, analyses, specifications, and diagrams, to the customer 330.

By offering these diverse forms of output, the system 300 may provide customers with a rich, multi-faceted view of the recommended DER solutions, supporting informed decision-making intelligence into one seamless fabric and facilitating faster customer decisions without timely and costly complex engineering effort enabling smooth implementation of the chosen configurations.

Machine learning techniques may play a significant role in enhancing the capabilities of the distributed energy resource (DER) recommendation method 200 and system 300. Such use of machine learning may enable more accurate, efficient, and personalized DER evaluations and recommendations.

In the context of DER recommendations, machine learning algorithms may be employed to analyze vast amounts of data from various sources, including historical energy consumption patterns, weather data, equipment performance metrics, and market trends. These algorithms may identify complex relationships and patterns that may not otherwise be identifiable through traditional analysis methods.

The incorporation of machine learning into the DER recommendation process may offer several potential benefits. Machine learning models may adapt and improve over time as they are exposed to more data, potentially leading to increasingly accurate predictions and recommendations. This adaptive capability may allow the system to stay current with evolving energy technologies, market conditions, and customer needs.

Machine learning techniques may also enable more sophisticated pattern recognition and anomaly detection within energy data than is provided by other techniques. This capability may be particularly useful for identifying opportunities for energy optimization and predicting potential issues before they occur. Additionally, machine learning algorithms may facilitate the processing of unstructured data, such as text from customer feedback or equipment maintenance logs, to extract valuable insights that can inform the recommendation process.

By incorporating machine learning, the DER recommendation system 300 may provide more personalized and context-aware suggestions. The system 300 may learn from individual customer behaviors and preferences, potentially tailoring recommendations to specific use cases and energy goals. This level of customization may help improve the relevance and effectiveness of the DER recommendations provided to each customer.

### Machine Learning in Data Creation (Step 202, Data Creation Module 302)

Machine learning techniques may be employed in various aspects of the data creation process (step 202) performed by the data creation module 302. These techniques may enhance the accuracy, completeness, and relevance of the customer-specific data 318 used for subsequent DER evaluation and recommendation steps.

In some cases, the customer data input module 304 may utilize machine learning algorithms to improve the user experience and data collection process. For example, the module 304 may employ natural language processing (NLP) techniques to interpret and categorize free-form text input provided by customers. This approach may allow the system 300 to extract relevant information from customer descriptions of their energy needs and preferences, potentially identifying key factors that may influence DER recommendations.

The customer data input module 304 may incorporate one or more predictive models to suggest likely values for missing or incomplete data fields based on patterns observed in similar customer profiles. These models may be trained on historical data from previous customers, learning to recognize correlations between various input parameters. As the customer enters information, the module 304 may dynamically update its predictions, potentially reducing the time and effort required for data entry while improving data quality.

In some embodiments, the external data retrieval module 306 may leverage machine learning techniques to enhance its data gathering and integration capabilities. The module 306 may employ web scraping algorithms combined with machine learning classifiers to automatically extract relevant information from diverse online sources such as utility websites, government databases, and equipment manufacturer specifications. These algorithms may be trained to recognize and categorize different types of energy-related data, adapting to variations in format and presentation across different sources.

The external data retrieval module 306 may utilize anomaly detection algorithms to identify and flag potential errors or inconsistencies in the retrieved data. These algorithms may learn from historical patterns and expert-validated datasets to recognize unusual or implausible values, potentially improving the overall reliability of the external data incorporated into the customer-specific data 318.

The synthetic data generation module 308 may employ machine learning techniques, such as generative adversarial networks (GANs) and/or variational autoencoders (VAEs), to create artificial data that closely mimics the statistical properties and relationships found in real customer data. These generative models may be trained on anonymized historical data, learning to produce synthetic customer profiles, energy consumption patterns, and site characteristics that are statistically indistinguishable from real data.

The synthetic data generation module 308 may incorporate reinforcement learning algorithms to fine-tune the generated data based on feedback from other components of the system 300. For example, if the variant evaluation module 310 consistently produces low-confidence results for certain types of synthetic data, the reinforcement learning algorithm may adjust the generation process to produce more realistic or relevant synthetic samples in those areas.

Machine learning techniques enhance the DER system variant evaluation process (step 204) performed by the variant evaluation module 310, improving accuracy, efficiency, and comprehensiveness of evaluations.

The variant evaluation module 310 may employ supervised learning algorithms, such as random forests or gradient boosting machines, to forecast energy production, efficiency, and reliability metrics for each DER system variant. These models may be trained on historical performance data from existing DER installations, combined with contextual information including weather patterns, equipment specifications, and site characteristics.

The variant evaluation module 310 may incorporate transfer learning techniques to adapt pre-trained models to specific customer contexts, leveraging knowledge from similar customers or geographical regions to improve prediction accuracy for new scenarios with limited data.

The variant evaluation module 310 may use graph neural networks (GNNs), which model relationships and dependencies between various DER elements, such as solar panels, battery storage systems, and load management devices. These GNN models predict system-level performance based on the attributes and connections of individual components, identifying synergies or conflicts between different DER technologies that may not be apparent through traditional analysis.

The variant evaluation module 310 may use reinforcement learning algorithms to optimize control strategies for DER system variants by making sequential decisions about energy dispatch, storage management, and load balancing in simulated environments.

The variant evaluation module 310 may use conditional variational autoencoders (CVAEs) to create synthetic time series data representing possible future energy demand and production patterns. These generative models capture underlying distributions and temporal dependencies of energy variables, conditioned on factors such as weather forecasts, economic indicators, actual energy consumed, or planned facility changes to produce diverse scenarios for evaluation.

The variant evaluation module 310 may use recurrent neural networks (RNNs) or long short-term memory (LSTM) networks model temporal dynamics of DER systems, predicting future system states based on past observations and control actions.

The variant evaluation module 310 may use Monte Carlo tree search (MCTS) algorithms, probability analysis, statistical sampling, descriptive and inferential statistics, correlation and regression analysis and decision theory individually or combined to explore the decision space for DER system configuration and operation, combining tree-based search with random sampling to evaluate selection of equipment and/or operational strategies across multiple simulated scenarios.

The variant evaluation module 310 may use anomaly detection techniques using autoencoders or isolation forests identify unusual or potentially problematic scenarios during simulation, highlighting edge cases or potential risks that warrant further investigation.

Machine learning techniques may be used to enhance the candidate configuration generation process (step 206) performed by the configuration generation module 312, creating optimized and tailored DER system configurations. The configuration generation module 312 may employ various machine learning approaches to efficiently explore possible DER combinations and generate recommendations that align with customer needs and preferences:
Genetic algorithms and particle swarm optimization to efficiently explore possible DER combinations. These algorithms train on historical data from successful implementations to identify high-performing technology combinations, evaluating configurations based on multiple objectives including cost-effectiveness, energy production, and environmental impact.
Multi-objective optimization techniques like NSGA-II to balance competing goals, generating Pareto-optimal sets of configurations that represent different trade-offs between minimizing costs, maximizing renewable energy integration, and enhancing system resilience.
Reinforcement learning approaches that allow the system to iteratively improve by learning from previous recommendation outcomes, adjusting strategies to prioritize configurations with demonstrated real-world success.
Collaborative filtering algorithms that identify patterns across customer segments. These algorithms train on historical user interaction data, recognizing correlations between customer characteristics, preferences, and selected configurations, continuously updating as users provide feedback.
Neural network architectures with attention mechanisms that focus on the most relevant aspects of user input, prioritizing specific features or constraints important to individual users for more personalized recommendations.
Active learning techniques that refine user preference understanding by strategically presenting diverse configuration options to gather informative feedback, gradually converging on optimal recommendations.
Time series forecasting models like Prophet or ARIMA that predict future trends in equipment costs, energy prices, and technology performance. These models train on historical data from manufacturers, energy markets, and industry reports, identifying seasonal patterns, long-term trends, and external factors influencing the DER landscape.
Natural language processing that extracts relevant information from unstructured sources like industry news, research papers, and regulatory documents, incorporating the latest innovations and policy changes into the configuration generation process.
Anomaly detection algorithms that identify emerging technologies or market shifts that deviate from historical patterns, flagging sudden changes in equipment pricing or performance metrics for investigation and potential inclusion in generated configurations.

Machine learning techniques may enhance the recommendation output production process (step 208) performed by the output production module 314, enabling tailored, explainable, and financially sound DER recommendations. The output production module 314 may employ ensemble learning techniques, combining multiple models trained on historical customer data to generate personalized recommendations. These models may map customer characteristics and priorities to optimal DER configurations, ensuring alignment with each customer's unique requirements. In some cases, the module may incorporate transfer learning to adapt pre-trained models to new customer segments or regions, leveraging existing knowledge to improve recommendations even with limited data. Reinforcement learning algorithms may continuously refine recommendation strategies based on customer feedback and implementation outcomes.

Natural language generation (NLG) models may produce human-readable descriptions of recommended configurations and their expected benefits, including potential cost reductions. These models may transform technical specifications and performance metrics into accessible narratives, helping customers understand the rationale behind recommendations and the financial advantages of different options. Explainable AI techniques such as SHAP values or LIME may highlight key factors influencing each recommendation, including those that contribute to cost savings. In some embodiments, computer vision techniques may generate visual representations, including 3D renderings or augmented reality visualizations of proposed DER systems at the customer's site, which may also illustrate cost-effective component placement and system designs.

Probabilistic graphical models, such as Bayesian networks, may model complex interdependencies between financial and operational factors. These models may estimate probability distributions of key financial metrics under different scenarios based on historical project data and market trends. Monte Carlo simulation techniques may generate ranges of possible financial outcomes, providing customers with nuanced understanding of potential risks and rewards. Time series forecasting models may predict future energy prices, demand patterns, and equipment performance to improve long-term financial projections. In some cases, reinforcement learning algorithms may optimize financing strategies, suggesting optimal combinations of upfront investment, loans, and/or third-party ownership models presented as power purchase agreements based on each customer's financial situation and risk tolerance. This data-driven approach may enable the system to provide comprehensive, actionable information that facilitates informed decision-making regarding DER investments.

The interface module 316 may leverage machine learning techniques to enhance the user experience when interacting with the DER recommendation output 326. These techniques may improve the accessibility, relevance, and usefulness of the recommendations for customers.

In some cases, the interface module 316 may utilize collaborative filtering algorithms to personalize the user interface based on individual preferences and behavior patterns. The interface module 316 may also employ deep learning models to capture sequential patterns in user interactions, potentially predicting likely next actions or areas of interest.

The interface module 316 may incorporate natural language processing (NLP) models to generate personalized summaries of the DER recommendations, translating technical details into language appropriate for each user's level of expertise. In some embodiments, the interface module 316 may use computer vision techniques to generate dynamic visualizations of the recommended DER configurations.

The interface module 316 may incorporate optical character recognition (OCR) models translating customer data input (304) into machine readable context.

Machine learning techniques may enable the interface module 316 to provide interactive tools for exploring and refining DER recommendations. For example, the module may utilize dimensionality reduction algorithms to create navigable visualizations of the recommendation space, allowing users to explore relationships between different DER configurations and understand trade-offs between various performance metrics.

By leveraging these machine learning techniques, the interface module 316 may create a more engaging, informative, and personalized experience for users interacting with the DER recommendation output 326. This enhanced interface may potentially improve user understanding of the recommendations and facilitate more informed decision-making.

Embodiments of the present invention may incorporate continuous learning and model updating mechanisms to enhance the accuracy and relevance of DER recommendations over time. In some cases, the variant evaluation module 310 may utilize incremental learning techniques to update predictive models as new performance data for existing DER system types or as new DER system types are introduced into commercial operation and becomes available, while the configuration generation module 312 may incorporate concept drift detection algorithms to identify when underlying patterns in DER performance or user preferences have shifted significantly. The system 300 may implement federated learning approaches, allowing models to be updated using data from multiple customers while preserving privacy, and the output production module 314 may employ ensemble learning techniques that combine predictions from multiple models to balance accumulated knowledge with responsiveness to recent trends.

These adaptive learning capabilities may enable the system 300 to continuously improve without requiring complete retraining. For example, stochastic gradient descent or mini-batch learning techniques may adjust model parameters based on incoming data streams, potentially improving prediction accuracy for future evaluations. Upon detecting significant pattern shifts, the system 300 may trigger targeted retraining of specific model components or activate alternative pre-trained models that better match the current data distribution. This distributed learning paradigm may enable the system to leverage insights from a wide range of DER implementations while maintaining data privacy and security.

Embodiments of the present invention may incorporate machine learning techniques to address uncertainty in DER evaluation processes. The variant evaluation module 310 may utilize Bayesian neural networks or dropout-based uncertainty estimation to quantify prediction uncertainties, while the configuration generation module 312 may employ scenario-based planning algorithms to generate diverse candidate DER system configurations 324 that perform well across various potential scenarios. In some cases, the output production module 314 may incorporate sensitivity analysis to identify which input parameters most significantly impact recommendation outcomes, helping users understand key uncertainty drivers.

The interface module 316 may utilize interactive visualization techniques to communicate uncertainty and variability to users. For example, the module may generate probabilistic forecasts with confidence intervals or use techniques like hypothetical outcome plots to illustrate the range of possible outcomes for different DER configurations. These approaches may enable the system 300 to provide more robust and reliable outputs even when working with incomplete or noisy data, potentially helping users make more informed decisions about DER implementations.

Embodiments of the present invention may leverage machine learning techniques to enhance integration with external systems and data sources. The external data retrieval module 306 may employ natural language processing and web scraping to automatically extract information from diverse online sources, while the variant evaluation module 310 may utilize transfer learning to adapt pre-trained models for DER-specific contexts. In some cases, the configuration generation module 312 may incorporate federated learning techniques to collaborate with external systems while preserving data privacy.

The output production module 314 may employ API integration to incorporate outputs from specialized third-party tools, and the interface module 316 may utilize machine learning-based data fusion techniques to present unified views from multiple external sources. These cross-cutting machine learning applications may enable the system 300 to continuously improve performance, handle uncertainties, and leverage diverse data sources, potentially leading to more comprehensive DER recommendations. The integration of these techniques may allow for seamless incorporation of external expertise and data without duplicating existing capabilities or compromising data security.

In various embodiments, the method 200 and system 300 may employ a plurality of distinct machine learning models to perform distinct functions within the method 200 and system 300. Each model may be trained separately using specialized datasets (which may be disjoint or overlap in varying degrees) relevant to their respective domains. The method 200 and system 300 may train one or more such models using any of the data disclosed herein, including but not limited to the customer-specific data 318, performance characteristics 322, or any combination of customer-provided data, external data, and synthetic data. Alternatively, one or more such models may be pre-trained when used by the method 200 and system 300, in which case the method 200 and system 300 may utilize these pre-trained models without performing additional training. In some embodiments, the method 200 and system 300 may use a combination of pre-trained models and models trained using the data disclosed herein.

In one example embodiment, the system 300 may utilize four distinct machine learning models: a resiliency model, a decarbonization model, a financial model, and an energy conservation model. However, other embodiments may implement different combinations and numbers of distinct models, each focused on evaluating specific aspects of DER configurations. The particular set of models employed may vary based on the specific requirements, priorities, and complexity of the evaluation being performed.
The resiliency model may be trained on historical data related to power outages, system failures, system demand, system consumption, and recovery times. This model may evaluate DER configurations based on their ability to maintain critical loads during grid disruptions, predict potential failure points, and estimate the duration of autonomous operation which may include BESS, ATS, UPS, grid forming inverters, and microgrid controllers.
The decarbonization model may analyze the carbon footprint of various DER configurations. It may be trained on datasets containing emissions data from different energy sources, lifecycle analyses of DER components, and regional grid emission factors. This model may predict the potential carbon reduction for each candidate DER configuration.
The financial model may focus on the economic aspects of DER implementations. It may be trained on historical cost data, energy market trends, and financial performance metrics of existing DER projects. This model may generate projections for return on investment, payback periods, and long-term financial impacts of different DER configurations.
The energy conservation model may evaluate the efficiency and energy-saving potential of DER configurations. It may be trained on data from energy audits, consumption patterns, and performance data from energy-efficient systems. This model may predict potential energy savings and identify opportunities for load reduction and demand management.

In the method 200, these models may be integrated into step 204 (evaluating DER system variants). The variant evaluation module 310 may apply each of these models in parallel to assess the performance characteristics 322 of the DER system variants 320. The outputs from these models may be combined to provide a comprehensive evaluation of each variant across multiple dimensions.

The configuration generation module 312 may use the outputs from these models in step 206 to generate candidate DER system configurations 324 that balance resiliency, decarbonization, financial performance, and energy conservation based on the customer's priorities.

The output production module 314 may incorporate the results from each model into the DER recommendation output 326 in step 208. This may allow for detailed breakdowns of how each recommended configuration performs in terms of resiliency, carbon reduction, financial metrics, and energy conservation.

By utilizing these specialized models, the system 300 may provide more nuanced and accurate evaluations of DER options, potentially leading to recommendations that better align with the diverse goals and constraints of different customers.

The integration of machine learning techniques throughout the distributed energy resource (DER) recommendation system delivers substantial benefits in accuracy, efficiency, and adaptability by processing complex data from diverse sources to uncover insights that traditional methods might miss. These algorithms continuously improve with new data, enabling more nuanced evaluations of DER options that account for interactions between consumption patterns, equipment performance, market trends, and regulations. This machine learning-enhanced approach represents a significant advancement in energy planning, providing personalized, data-driven recommendations that help users from homeowners to industrial facilities make informed energy investment decisions, ultimately improving cost savings, environmental impact, and energy resilience while supporting the transition to more sustainable energy infrastructures.

Rebates and incentives may be incorporated into multiple steps of the method 200 illustrated in FIG. 2, enhancing the overall effectiveness and appeal of the distributed energy resource (DER) recommendation process.

In step 202, where customer-specific data 318 is created, the data creation module 302 may include information about available rebates, discounts, and incentives in the customer's location. This may involve the external data retrieval module 306 accessing databases of utility companies, government agencies, manufacturers, or third-party aggregators to gather up-to-date information on relevant rebates and incentives. The synthetic data generation module 308 may then incorporate this information into the customer-specific data 318, potentially simulating how different rebate, discount, and incentive scenarios could impact the customer's energy profile.

During step 204, when evaluating DER system variants 320, the variant evaluation module 310 may factor in the impact of applicable rebates, discounts, and incentives on the performance characteristics 322 of each variant. For instance, the module 310 may adjust the projected cost savings or return on investment based on available rebates, or how discounts might impact the equipment costs, or consider how performance-based incentives might affect the long-term financial viability of certain DER configurations. The module may also incorporate the Investment Tax Credit from the IRS, which may enable a tax credit equal to 30% of the overall costs of implementation for certain DER technologies, potentially impacting all financial views and analyses.

In step 206, the configuration generation module 312 may use rebate, discount, and incentive data as additional parameters when generating candidate DER system configurations 324. The module 312 may prioritize configurations that maximize the utilization of available rebates, discounts, and incentives, potentially leading to more cost-effective or financially attractive options for the customer.

The output production module 314, in step 208, may incorporate rebate, discount, and incentive information into the DER recommendation output 326. This may include breakdowns of how specific rebates or incentives apply to each recommended configuration, their impact on upfront costs and long-term savings, and any time-sensitive aspects of the incentives that might influence implementation timing.

Finally, when outputting the DER recommendation in step 210, the interface module 316 may present rebate and incentive information in an interactive and user-friendly manner as part of the manifested DER recommendation output 328. This could include features allowing customers to explore how different rebate and incentive scenarios might affect their DER implementation options, potentially influencing their decision-making process.

By integrating rebate and incentive considerations throughout the method 200, the system 300 may provide more comprehensive and financially optimized DER recommendations, potentially increasing the likelihood of customer adoption and satisfaction with the proposed energy solutions.

Embodiments of the present invention may include alternative or complementary methods for evaluating and recommending distributed energy resource (DER) system configurations. While the primary embodiment described herein focuses on a demand-first approach, the system 300 may also implement a supply-first methodology or a combination of both approaches.

In some cases, the variant evaluation module 310 may employ a supply-first approach to DER evaluation. This method may involve starting with the output capabilities of various DER generators and attempting to fit these production profiles into the historical load data. The variant evaluation module 310 may analyze the production profiles of different DER technologies, considering both thermal energy (measured in therms) and electrical energy (measured in kilowatt-hours) outputs.

The configuration generation module 312 may then generate candidate DER system configurations 324 based on how well the DER output profiles match the historical demand patterns contained in the customer-specific data 318. This approach may allow the system 300 to identify DER configurations that closely align with existing energy usage patterns without necessarily starting from a detailed analysis of the demand profile.

In some embodiments, the system 300 may employ both demand-first and supply-first approaches, either sequentially or in parallel, to provide a more comprehensive evaluation of potential DER configurations. The output production module 314 may synthesize the results from both approaches to generate more robust DER recommendation outputs 326.

The interface module 316 may provide options for users to select their preferred evaluation methodology or to view results from multiple analytical approaches. This flexibility may allow the system 300 to adapt to various evaluation scenarios and user preferences, potentially enhancing the relevance and effectiveness of the DER recommendations.

By incorporating these alternative evaluation methodologies, embodiments of the present invention may provide a more versatile and comprehensive approach to DER system configuration analysis and recommendation. This multi-faceted approach may enable the system 300 to identify optimal DER solutions across a wider range of scenarios and customer requirements.

In some embodiments, the system 300 may incorporate time coding techniques to enhance both demand-first and supply-first approaches. Time coding may involve tagging energy data with temporal markers at various resolutions, from seconds to seasons, allowing the system to identify patterns across different time scales. The variant evaluation module 310 may apply time coding to categorize energy usage and production patterns by time of day, day of week, season, or in response to specific events such as temperature fluctuations or occupancy changes.

This temporal classification may enable more nuanced matching between supply capabilities and demand requirements. For example, the system may identify that certain DER technologies perform optimally during specific time periods that align with peak demand patterns in the customer's facility. The configuration generation module 312 may leverage time-coded data to develop DER configurations that specifically address temporal variations in energy needs, potentially improving overall system efficiency and cost-effectiveness.

Time coding may also facilitate more accurate forecasting of future energy patterns by establishing correlations between temporal factors and energy consumption or production trends. The output production module 314 may incorporate these time-based insights into the DER recommendation output 326, providing customers with visualizations that illustrate how recommended configurations may perform across different time periods and seasonal variations.

Embodiments of the present invention may incorporate time series analysis and synthetic data generation techniques to establish highly granular demand curves for distributed energy resource (DER) evaluation. This process may be implemented as part of the method 200 illustrated in FIG. 2, particularly within step 202 (creating customer-specific data 318) and step 204 (evaluating DER system variants 320).

The synthetic data generation module 308 of system 300 may produce synthetic data points between actual 15-minute (or other interval periods) interval energy measurements. In some cases, the module 308 may generate data for every second within each 15-minute interval, or in clusters of time segments. This granular approach may allow for a more detailed analysis of energy consumption patterns than traditional methods that rely solely on 15-minute interval data.

The variant evaluation module 310 may apply various time series analysis techniques to this synthetic data. For example, the module 310 may use time series decomposition to separate the data into trend, seasonal, and residual components. This decomposition may reveal underlying patterns in energy usage that may not be apparent in the original 15-minute interval data.

In some embodiments, the variant evaluation module 310 may employ anomaly detection algorithms to identify unusual energy consumption events within the synthetic data. These anomalies may represent important factors to consider when evaluating different DER system variants 320.

The module 310 may apply moving averages and time series forecasting models to the synthetic data. These techniques may help smooth out short-term fluctuations and project future energy demand patterns, potentially improving the accuracy of performance characteristics 322 predictions for different DER configurations.

In some cases, the variant evaluation module 310 may use aggregation techniques to combine the synthetic data points into meaningful time clusters. This approach may allow for analysis at multiple time scales, from second-by-second variations to broader trends over minutes or hours.

For data with seasonal patterns, the module 310 may apply exponential smoothing techniques. This method may help capture recurring patterns in energy demand, which may be particularly relevant for evaluating DER systems with cyclical generation profiles, such as solar photovoltaic arrays.

The variant evaluation module 310 may have the flexibility to apply these analysis techniques individually, in series, in parallel, or in combination. For example, the module 310 may first decompose the time series, then apply anomaly detection to the residual component, and finally use forecasting models on the trend component. This adaptable approach may allow the system to tailor its analysis to the specific characteristics of each customer's energy profile.

By analyzing the synthetic data at this granular level, the variant evaluation module 310 may extract frequency components, detect periodicity, and uncover hidden cycles in energy consumption. For instance, the module may identify short-duration demand spikes that occur regularly within certain 15-minute intervals, which could significantly influence the sizing and control strategies for energy storage components in DER configurations. When a 10-second spike of 500 kW occurs within a 15-minute interval that otherwise averages 200 kW, the module may recommend a battery system with higher power capacity (kW) but potentially lower energy capacity (kWh) than would be suggested based solely on the 15-minute averaged data. This granular approach may allow for more precise equipment sizing, potentially reducing overall system costs while maintaining performance.

The results of this granular analysis may feed into the configuration generation module 312, potentially leading to more tailored and effective candidate DER system configurations 324. For example, if the analysis reveals frequent short-duration demand spikes, the module may prioritize DER configurations with fast-responding energy storage capabilities with high power ratings rather than larger capacity batteries with slower response times. Additionally, the control algorithms recommended for such systems may incorporate predictive elements that prepare the storage system seconds before anticipated spikes occur, based on the temporal patterns identified in the granular analysis. This may improve both technical performance and economic value by optimizing demand charge management and reducing the need for oversized equipment.

The output production module 314 may incorporate insights from this granular analysis into the DER recommendation output 326. For instance, the module 314 may generate visualizations of hidden consumption patterns discovered through the analysis, helping to explain and justify specific DER configuration recommendations to the customer 330.

The method 200 for evaluating and recommending distributed energy resource (DER) system configurations may incorporate a multi-faceted approach to time series analysis. This process may leverage various techniques across different stages of the method 200, potentially enhancing the accuracy and robustness of the DER recommendations.

In step 202 of method 200, the data creation module 302 of system 300 may employ data preparation techniques to ensure the quality and consistency of time series data. The customer data input module 304 may utilize interpolation or fill methods to address missing values in customer-provided energy consumption data. The external data retrieval module 306 may apply normalization techniques to align data from diverse sources, such as utility records and weather databases. The synthetic data generation module 308 may use outlier detection algorithms to identify and handle anomalous data points in synthetically generated time series.

During the evaluation of DER system variants in step 204, the variant evaluation module 310 may leverage data aggregation techniques to align time series data with appropriate analysis granularity. The module may dynamically adjust aggregation levels based on the specific characteristics of each DER system variant 320, potentially enabling more nuanced comparisons between different configurations.

The variant evaluation module 310 may also incorporate exploratory data analysis techniques to identify trends and patterns in the time series data relevant to each DER system variant. This may involve generating visualizations such as heatmaps or interactive dashboards to represent energy production and consumption patterns over time, potentially revealing insights that inform the prediction of performance characteristics 322.

Time series decomposition methods may be applied by the variant evaluation module 310 to isolate trend, seasonality, and residual components in the data associated with different DER system variants. The module may use techniques such as STL or exponential smoothing to identify underlying patterns that could impact the long-term performance of various DER configurations.

In step 206, the configuration generation module 312 may utilize modeling and forecasting techniques to project the performance of candidate DER system configurations 324 over time. This may involve applying machine learning approaches such as Random Forests or Neural Networks to predict future energy production and consumption patterns. The module may also generate synthetic time series data to simulate performance under various scenarios, potentially expanding the range of conditions considered in the configuration generation process.

The output production module 314, as part of step 208, may employ validation and optimization techniques to refine the time series analysis results incorporated into the DER recommendation output 326. This may include using cross-validation methods to assess the reliability of performance projections for recommended DER configurations. The module may iteratively optimize these projections based on validation results, potentially improving the accuracy of financial models and emission reduction projections included in the recommendation output.

When outputting the DER recommendation in step 210, the interface module 316 may leverage interpretation and reporting techniques to effectively communicate time series analysis insights as part of the manifested DER recommendation output 328. This may involve using natural language generation to create summaries of temporal patterns identified in the analysis, and employing advanced visualization methods to illustrate projected performance trends over time for recommended DER configurations.

The method 200 and system 300 may apply any of these time series analysis techniques either individually or in combination to provide a more accurate, comprehensive, and nuanced evaluation of DER options.

Embodiments of the present invention may include automated Letter of Authorization (LOA) management capabilities within the Digital Engagement Energy Marketplace (DEEM) platform to streamline the process of obtaining digital interval data from utilities. In some cases, the customer data input module 304 may automatically generate customized LOAs based on customer information stored in the customer-specific data 318 and utility requirements retrieved by the external data retrieval module 306. The system 300 may dynamically populate these LOAs with relevant customer details, utility account information, and specific data request parameters. The interface module 316 may provide a digital approval mechanism as part of the manifested DER recommendation output 328, allowing customers to review and electronically approve the generated LOAs. In some embodiments, the system 300 may incorporate digital signature technology to ensure authenticity and legal validity of approvals.

Upon receiving customer approval, the external data retrieval module 306 may initiate automated LOA submission to relevant utility companies through digital channels such as email APIs, utility company API integration, or dedicated utility portal uploads. The external data retrieval module 306 may implement automated follow-up procedures, including sending reminders to utilities if responses are not received within specified timeframes. Machine learning algorithms may optimize the timing and content of these follow-up communications based on historical response patterns. When utilities respond, the external data retrieval module 306 may employ automated receipt and processing capabilities, including email parsing algorithms to extract relevant information, data validation checks, and automated integration of received data into the customer-specific data 318. The interface module 316 may provide real-time status tracking functionality, allowing customers to monitor the progress of their LOA submission and data retrieval process through automatically generated updates based on system events such as LOA submission, utility acknowledgment, and data receipt.

In some embodiments, the system 300 may employ hybrid approaches combining automated and manual steps, enabling adaptation to varying utility company requirements and customer preferences while maintaining process efficiency. By incorporating these automated LOA management capabilities, embodiments of the present invention may enhance data collection efficiency, potentially contributing to more timely and accurate DER evaluations and recommendations.

Embodiments of the present invention may include capabilities for evaluating Energy Conservation Measures (ECMs), which are actions or modifications that reduce energy consumption in a facility. The system may allow customers to load their usage data for existing systems, and the invention may evaluate whether these systems, in whole or in part, could be replaced to increase energy efficiency. Examples of ECMs may include lighting upgrades, HVAC improvements, building envelope enhancements, or equipment optimization. The method 200 and system 300 may evaluate these ECMs either in conjunction with Distributed Energy Resources (DERs) or as standalone options, potentially providing a wider range of energy optimization recommendations.

In some cases, the variant evaluation module 310 may assess ECMs alongside DER system variants 320, analyzing how various ECMs might complement or affect the performance of proposed DER configurations. After the customer loads their usage data for existing systems, the module may identify which systems could benefit from replacement or modification to improve efficiency. This integrated evaluation approach may identify synergies between ECMs and DERs, potentially leading to more comprehensive energy management strategies.

The variant evaluation module 310 may also evaluate ECMs independently of DERs, which may be particularly valuable in scenarios where DER implementations are not feasible or when customers prioritize demand-side energy management. Using the customer's loaded usage data for existing systems, the module 310 may analyze the potential impact of replacing or modifying these systems on energy consumption patterns, costs, and emissions using similar performance prediction techniques as those applied to DER evaluations.

The configuration generation module 312 may generate candidate configurations 324 that include both DERs and ECMs. These hybrid configurations may address both supply and demand aspects of energy management. Based on the customer's loaded usage data for existing systems, the module 312 may employ optimization algorithms to determine which systems could be replaced or modified for improved efficiency, and how these changes could be effectively combined with DERs based on the customer-specific data 318 and defined objectives.

The output production module 314 may incorporate ECM-related information into the DER recommendation output 326, including analyses of proposed system replacements or modifications, their expected efficiency improvements, and interactions with recommended DER configurations. The module 314 may generate comparative analyses showing the benefits of implementing system replacements alone, DERs alone, or combined solutions.

The interface module 316 may provide options to prioritize or exclude specific system replacements in the evaluation process as part of the manifested DER recommendation output 328, allowing customers to explore various energy management strategies and understand trade-offs between different approaches to improving the efficiency of their existing systems.

By incorporating ECM evaluation capabilities that analyze the customer's loaded usage data for existing systems, embodiments of the present invention may offer adaptable energy optimization solutions addressing a wider range of customer needs, from pure DER implementations to strategies focused on replacing or modifying existing systems for improved efficiency, or combinations thereof.

Embodiments of the present invention may include a Digital Engagement Energy Marketplace (DEEM) platform that facilitates the evaluation, recommendation, and implementation of distributed energy resource (DER) solutions. The DEEM platform may serve as a centralized hub connecting various stakeholders in the DER ecosystem, streamlining the process of assessing, selecting, and deploying energy solutions tailored to specific user needs.

In some cases, the DEEM platform may provide a suite of tools and services designed to address the complex challenges associated with DER implementation. The platform may offer functionalities such as energy usage analysis, DER system configuration recommendations, financial modeling, and project management support. By leveraging advanced data analytics and machine learning techniques, the DEEM platform may generate insights and recommendations that are tailored to each user's unique energy profile and objectives.

The DEEM platform may comprise several key components that work in concert to deliver its functionality. These components may include, for example, any one or more of the following: a user interface module that allows customers to input data, set preferences, and interact with the platform's features; a data processing engine that collects, validates, and analyzes energy usage data and other relevant information; a recommendation engine that generates DER system configurations based on user inputs and analyzed data; a marketplace module that connects users with service providers, equipment suppliers, and financing options; a project management tool that facilitates the implementation and monitoring of DER projects.

Embodiments of the DEEM platform may involve various stakeholders, each playing a crucial role in the DER ecosystem, including end-users (e.g., individuals, businesses, or organizations seeking to evaluate and implement DER solutions); equipment manufacturers (e.g., providers of DER hardware such as solar panels, batteries, and control systems); service providers (e.g., installers, maintenance technicians, and other professionals involved in DER implementation); financial institutions (e.g., banks, leasing companies, asset owners, and other entities offering financing options for DER projects); utilities (e.g., energy companies that may interact with DER systems and provide grid integration services); energy services company (e.g., sale of electricity, sale of natural gas, sale of other fuels) and regulators (e.g., government agencies and other bodies that oversee energy-related policies and standards).

In some aspects, the DEEM platform may act as an intermediary, facilitating interactions between these stakeholders. For example, the platform may match end-users with suitable service providers based on project requirements, geographical location, and other relevant factors. Similarly, the platform may connect users with financial institutions to explore funding options for their DER projects.

The DEEM platform may incorporate features to ensure data privacy and security. For instance, the system may employ encryption techniques to protect sensitive user information and implement access controls to manage data sharing between different stakeholders.

By providing a comprehensive, user-friendly interface for DER evaluation and implementation, embodiments of the DEEM platform may simplify the process of adopting distributed energy solutions. The platform may enable users to make more informed decisions about their energy investments, potentially leading to more efficient and cost-effective DER deployments.

Embodiments of the present invention may include a Digital Engagement Energy Marketplace (DEEM) platform with a modular system architecture designed to facilitate efficient processing, analysis, and management of distributed energy resource (DER) solutions. The overall structure of the DEEM platform may comprise several interconnected modules, each responsible for specific functionalities within the system.

The system architecture of the DEEM platform may comprise the following interconnected modules, each serving specific functions within the overall data flow:
User Interface Module: Provides the front-end interface for users to interact with the platform, including user registration, profile management, data input, and result visualization. This module initiates the data flow by collecting user data and preferences, and ultimately presents the final results back to users.
Data Ingestion and Preprocessing Module: Collects and preprocesses data from various sources, including user inputs, external databases, and real-time sensors. This module receives raw data from the User Interface Module and other sources, standardizes it, and passes the cleaned data to the Data Storage and Management Module.
Data Storage and Management Module: Handles the storage, retrieval, and management of all data within the system using a combination of relational databases and distributed storage systems. This module serves as the central repository that provides structured data to the Analytics and Machine Learning Module and other components as needed.
Analytics and Machine Learning Module: Performs advanced data analysis and applies machine learning algorithms to generate insights and recommendations. This module accesses data from the storage module, processes it to identify patterns and opportunities, and feeds its outputs to the DER Configuration Generator.
DER Configuration Generator: Creates and evaluates potential DER system configurations based on user requirements and analyzed data. This module utilizes the insights from the Analytics and Machine Learning Module to generate configurations that are then passed to the Financial Modeling Module for economic assessment.
Financial Modeling Module: Performs financial calculations and generates projections for different DER configurations and financing options. This module evaluates the configurations from the DER Configuration Generator and produces financial analyses that are incorporated into the final recommendations presented to users.
Marketplace Integration Module: Facilitates connections between users and service providers, equipment suppliers, and financial institutions. Once users decide to proceed with a project, this module enables the transition from planning to implementation by connecting users with relevant external parties.
Project Management Module: Provides tools for tracking and managing DER implementation projects. This module becomes active after users select a configuration and engage with service providers, tracking project progress throughout the implementation phase.
Security and Access Control Module: Manages user authentication, data encryption, and access permissions across the platform. This module operates continuously throughout all processes, ensuring that data is protected and accessed only by authorized parties at each stage of the workflow.
API and Integration Module: Enables integration with external systems and third-party services. This module facilitates data exchange with external systems at various points in the workflow, allowing for seamless connectivity with utility databases, weather services, equipment manufacturers, and other relevant external platforms.

These modules may be orchestrated by a central control system or distributed across a microservices architecture, working together to deliver a comprehensive platform for evaluating, recommending, and implementing distributed energy resource solutions.

Embodiments of the present invention may include a user interface designed to facilitate interaction with the Digital Engagement Energy Marketplace (DEEM) platform. The interface module 316 may provide multiple access options, including web-based portals, mobile applications, and desktop applications. In some cases, the interface may dynamically adapt based on the user's device, screen size, and preferences to optimize the viewing and interaction experience.

The interface module 316 may implement user registration through intuitive steps and forms, including basic information collection, verification, and guided onboarding. The profile management functionality may allow users to update personal and organizational information, manage communication preferences, set energy goals, upload energy consumption data, and manage saved projects and recommendations.

The DEEM platform may incorporate search and filtering capabilities including keyword-based search, faceted filtering, customizable result sorting, saved searches, and intelligent search suggestions. In some embodiments, the search functionality may leverage machine learning algorithms to improve result relevance based on user interactions and feedback over time.

The interface module 316 may guide users through project workflows including: project initiation with guided questionnaires and automated data collection; project evaluation with interactive visualization of DER configurations and comparison tools; service provider selection using matching algorithms and secure messaging; financial planning with modeling tools and financing offer comparisons; implementation tracking with timeline visualization and document repositories; and post-implementation management with performance monitoring dashboards and energy analytics.

The interface module 316 may provide contextual help, tooltips, and guided tutorials throughout these workflows. The system 300 may incorporate feedback mechanisms for users to rate experiences and suggest improvements. In some cases, the interface module 316 may support collaborative features with role-based access controls, shared workspaces, and collaborative decision-making tools, enabling multiple stakeholders within an organization to participate in the project evaluation and management process.

Embodiments of the present invention may include backend workflows within the Digital Engagement Energy Marketplace (DEEM) platform to process user requests and facilitate connections between stakeholders. The DEEM platform may implement a multi-stage workflow for processing user requests, including request intake, data validation, request routing, and response generation. When a user submits a request through the user interface module 316, the system may automatically categorize and prioritize the request based on type and urgency, while validating the completeness and accuracy of submitted information.

The DEEM platform may utilize matching algorithms to connect users with suitable service providers through profile analysis, capability assessment, and compatibility scoring. The system may analyze user profiles and project requirements to identify key attributes for matching, while evaluating service provider profiles based on factors such as expertise, capacity, location, and past performance. A compatibility score may be calculated for each potential user-provider match using machine learning models trained on historical data, and the system may rank potential matches and present recommendations to users.

To ensure quality and reliability, the DEEM platform may implement automated vetting and qualification processes including initial screening, background verification, and performance tracking. Automated checks may be performed on submitted documentation, licenses, and certifications, while the system may interface with external databases to verify business registrations and financial standings. Machine learning algorithms may be used to dynamically adjust qualification thresholds based on market conditions and platform performance data.

The DEEM platform may incorporate transaction processing capabilities including secure payment processing, escrow services, and automated invoicing. The platform may integrate with payment gateways to facilitate financial transactions between users and service providers, implement escrow mechanisms to hold funds until project milestones are verified, and generate invoices based on project progress. A structured process for handling disputes may be included, while machine learning algorithms may be used to detect anomalies through continuous monitoring of transactions.

In some embodiments, these backend workflows may be implemented using a microservices architecture and event-driven processing, allowing for scalability in handling varying workloads. The DEEM platform may also incorporate feedback loops within these workflows, continuously collecting data on process performance and user satisfaction. By implementing these backend workflows, embodiments of the present invention may provide an efficient marketplace for DER solutions, potentially improving interactions between users and service providers while maintaining standards of security and reliability.

Embodiments of the present invention may incorporate data handling and management techniques within the Digital Engagement Energy Marketplace (DEEM) platform to facilitate efficient data processing from various sources.

In some cases, the external data retrieval module 306 may collect interval data from Programmable Logic Controls (PLCs) associated with breakers or switches used to transfer power from the grid to the customer's load. These PLCs may record detailed information about power transfer events, providing granular information about energy consumption patterns without relying solely on utility-provided data or requiring additional metering equipment. The external data retrieval module 306 may interface with various types of PLCs using standardized communication protocols to extract this interval data, which may then be integrated with other sources of customer-specific data 318. This data may support both DER evaluations and energy conservation measures (ECMs) such as lighting retrofits, HVAC improvements, energy management controls, water conservation, and building envelope enhancements.

For data storage, the DEEM platform may implement an architecture combining relational and NoSQL databases with security measures including encryption, role-based access control, data anonymization, and audit trails. The platform may utilize data partitioning and sharding across multiple servers to improve performance and scalability, while maintaining regular backups and geographically distributed redundancy. This architecture may be designed to accommodate both DER and ECM data, allowing the system to analyze and recommend energy conservation opportunities prior to or alongside DER investments.

The DEEM platform may employ data processing techniques including automated cleaning and normalization, feature extraction using machine learning algorithms, time series analysis for temporal patterns, predictive modeling, natural language processing for unstructured text data, and ensemble methods combining multiple models. These techniques may be applied to identify patterns in energy usage that could indicate opportunities for energy conservation through equipment retrofits or replacements before investing in DER solutions, potentially offering customers a comprehensive approach to energy optimization.

For external integration, the platform may connect with utility company databases, weather data services, equipment manufacturer databases, financial institution APIs, regulatory databases, energy market data feeds, and geospatial databases. In some embodiments, the DEEM platform may implement a standardized API gateway to manage these integrations, ensuring consistent data handling and security across all external connections, while employing data caching strategies to optimize performance. These integrations may enable the platform to access equipment specifications, performance data, and pricing information necessary for evaluating both energy conservation measures and distributed energy resources, allowing the system to evolve over time to meet changing customer needs and market conditions.

Embodiments of the present invention may incorporate machine learning and analytics capabilities within the Digital Engagement Energy Marketplace (DEEM) platform to enhance the evaluation and recommendation of distributed energy resource (DER) solutions.

In some cases, the DEEM platform may utilize various machine learning models to evaluate DER projects and generate recommendations. For example, the variant evaluation module 310 may employ supervised learning algorithms such as random forests or neural networks to predict performance characteristics 322 of different DER system variants 320. The configuration generation module 312 may then use these predictions to create candidate DER system configurations 324 tailored to each customer's specific needs. Any of the machine learning techniques disclosed elsewhere herein may be employed by the DEEM platform.

The DEEM platform may incorporate data analysis techniques to identify market trends and optimize pricing strategies. For example, time series analysis may be applied to forecast energy prices and demand patterns, while anomaly detection algorithms may identify unusual patterns in market data. These analysis techniques may inform the output production module 314 in generating DER recommendation outputs 326 that reflect current market conditions.

For risk assessment, the DEEM platform may implement predictive modeling techniques such as Bayesian networks or Monte Carlo simulations to forecast project outcomes under various scenarios. In some embodiments, the output production module 314 may incorporate these predictive models into the DER recommendation output 326, providing customers with detailed risk assessments for different DER configurations.

The DEEM platform may implement continuous learning mechanisms where models are updated incrementally as new data becomes available. This approach may enable the system to adapt to evolving market conditions and technological advancements, potentially improving the accuracy and relevance of DER recommendations over time.

Embodiments of the present invention may incorporate financial integration capabilities within the Digital Engagement Energy Marketplace (DEEM) platform to facilitate financing, payment processing, and financial management for distributed energy resource (DER) projects.

The DEEM platform may integrate with financial institutions and lenders through standard methods such as API integration, secure data transfer protocols, OAuth authentication, and regulatory compliance frameworks. In some embodiments, the DEEM platform may establish partnerships with multiple financial institutions to offer users a range of financing options.

For generating financing offers, the DEEM platform may employ credit scoring algorithms, dynamic term generation, multi-offer comparison capabilities, and automated documentation generation. In some cases, the output production module 314 may incorporate these financing offers into the DER recommendation output 326, providing users with both technical and financial aspects of potential DER implementations. The platform may also include information about the Investment Tax Credit from the IRS, which may enable a tax credit equal to 30% of the overall costs of implementation for certain DER technologies, potentially impacting all financial views and analyses presented to users.

The DEEM platform may implement payment processing and escrow services using industry-standard security measures such as tokenization, multi-factor authentication, and fraud detection algorithms. For large projects, the platform may offer direct or third-party escrow services to hold and disburse funds based on predefined milestones.

In some embodiments, the DEEM platform may implement a distributed ledger system to maintain a transparent record of financial transactions, potentially enhancing trust and providing an audit trail for multi-party transactions involved in DER projects. The platform may also offer features for ongoing financial management of implemented DER projects, such as automated billing for energy production and management of power purchase agreements.

By integrating these financial capabilities, embodiments of the present invention may streamline the financing and payment aspects of DER implementations, potentially accelerating the adoption of distributed energy resources.

Embodiments of the present invention may include contractor, service provider, and equipment manufacturer management capabilities within the Digital Engagement Energy Marketplace (DEEM) platform to facilitate effective project matching and service delivery.

The DEEM platform may implement automated verification processes for service providers and equipment manufacturers, including credential verification, background checks, insurance capacity, bonding limitations, EMR ratings, apprenticeship programs, and compliance verification. For manufacturers of prime movers, ancillary equipment, and balance of plant equipment, the system may verify product certifications, warranty terms, and performance specifications. The system may employ machine learning models to assess financial stability and technical capabilities of providers and manufacturers.

For quality assurance, the platform may incorporate multi-dimensional rating systems with weighted review aggregation. Natural language processing may be applied to analyze textual reviews, while objective performance metrics from completed projects and installed equipment may be integrated into provider and manufacturer ratings.

The DEEM platform may utilize matching algorithms that analyze multiple factors to connect providers, manufacturers, and their products with appropriate projects. These algorithms may incorporate collaborative filtering techniques and predictive performance modeling to suggest providers and equipment based on patterns observed in successful past matches. The system may consider providers' current workload and capacity, as well as manufacturers' production schedules and inventory availability when making recommendations, and employ reinforcement learning techniques to dynamically adjust matching criteria when initial matches prove unsuitable.

By implementing these contractor, service provider, and equipment manufacturer management features, embodiments of the present invention may enhance the quality and reliability of DER implementations through appropriate selection of prime movers, ancillary equipment, and balance of plant equipment alongside qualified service providers.

Embodiments of the present invention may incorporate project management tools within the Digital Engagement Energy Marketplace (DEEM) platform to facilitate planning, execution, and monitoring of distributed energy resource (DER) projects.

The DEEM platform may offer project tracking capabilities including interactive or static Gantt charts, customizable dashboards, and automated milestone tracking. The platform may implement resource allocation tools for managing personnel, equipment, and materials across project phases. In some cases, the system may generate automated progress reports and send alerts for approaching deadlines or potential delays.

For stakeholder communication, the DEEM platform may include a centralized messaging system, discussion forums, and video conferencing integration. The platform may enable task-specific commenting and distribute automated status updates based on predefined rules or user preferences.

Document management features may include a centralized repository with version control, access permissions, and document tagging. The system may support collaborative editing and implement automated document workflows for reviews and approvals. In some embodiments, users may set document retention periods to ensure regulatory compliance.

The project management tools may integrate with other DEEM platform components, such as financial modeling and contractor management systems, allowing for seamless data flow between different aspects of project planning and execution. In some cases, the platform may employ machine learning algorithms to analyze project data and provide insights for improving performance, such as identifying potential bottlenecks or suggesting optimizations based on patterns observed in similar projects.

By offering these project management tools, embodiments of the present invention may enable efficient execution of DER projects through improved collaboration, resource management, and documentation throughout the project lifecycle.

Embodiments of the present invention may incorporate regulatory compliance and reporting capabilities within the Digital Engagement Energy Marketplace (DEEM) platform to facilitate adherence to relevant regulations for distributed energy resource (DER) projects.

The DEEM platform may employ various methods to help maintain regulatory compliance, including integration with regulatory databases, automated compliance checks, and geospatial compliance mapping. In some cases, the platform may utilize machine learning models to continuously monitor regulatory changes and assess their potential impact on projects.

For document generation, the DEEM platform may offer automated capabilities such as template-based document creation and dynamic form filling. The platform may employ natural language processing techniques to extract relevant information from project data and generate human-readable reports and filings. In some embodiments, the system may schedule and generate recurring compliance reports as required by regulatory bodies.

The DEEM platform may integrate with regulatory databases and reporting systems through API connections and electronic filing systems. The platform may implement automated processes to synchronize its internal regulatory database with official government sources, ensuring up-to-date compliance information. In some cases, the system may support standardized data formats required by different regulatory agencies for seamless information exchange.

In some embodiments, the DEEM platform may employ machine learning algorithms to analyze historical compliance data and predict potential regulatory challenges for new projects. This predictive capability may help users address compliance issues proactively during planning and design phases. The system may also offer features for managing multiple regulatory jurisdictions, allowing users to switch between different sets of compliance requirements based on project location or scope.

By incorporating these regulatory compliance and reporting features, embodiments of the present invention may reduce the administrative burden associated with DER project implementation. The automated compliance checks, document generation, and regulatory integration capabilities may help users navigate complex regulatory landscapes more efficiently.

Embodiments of the present invention may incorporate energy trading and grid integration capabilities within the Digital Engagement Energy Marketplace (DEEM) platform to facilitate energy exchange between users, suppliers, and integration with grid infrastructure.

The DEEM platform may implement various mechanisms to support peer-to-peer and/or business to business, and/or business to customer energy trading, energy purchases, natural gas purchases; renewable energy credit purchases, renewable energy credit sales, including any one or more of the following:
Virtual power plant (VPP) functionality that aggregates distributed energy resources from multiple users for coordinated energy trading and grid services.
Blockchain-based trading platform for secure, transparent, and automated energy transactions between users.
Dynamic pricing algorithms using machine learning to determine optimal pricing based on real-time supply and demand conditions.
Smart contract execution to automate energy or renewable energy credit trades, sales, purchases with conditional pricing and delivery terms.

For grid management integration, the DEEM platform may offer any one or more of the following:
SCADA system integration for real-time monitoring and control of DER assets.
Distribution management system connectivity to support grid stability through coordinated DER operation.
Demand response participation enabling automatic DER output adjustment based on grid signals.
Ancillary services provision through aggregated DER capabilities for frequency regulation or voltage support.
Microgrid integration supporting seamless transitions between grid-connected and islanded operation modes.
Emission comparison analysis to quantify reductions achieved by DER implementation relative to the established baseline, supporting environmental impact assessments and regulatory compliance reporting.

For real-time monitoring and control, the DEEM platform may provide any one or more of the following:
IoT device integration for collecting real-time data on DER performance and energy flows.
Predictive maintenance using machine learning to forecast equipment failures and schedule maintenance.
Adaptive control algorithms optimizing DER performance based on environmental conditions and demand patterns.
Remote asset management through web and mobile interfaces for monitoring and controlling DER systems.
Performance analytics providing metrics on energy production, efficiency, and financial returns.

In some embodiments, the DEEM platform may implement a hierarchical control architecture to manage interactions between individual DER systems, local microgrids, and the broader power grid. This approach may enable coordinated operation across multiple scales, potentially improving system efficiency.

The DEEM platform may also qualify service providers and rank them for the customer's consideration to streamline finding qualified and experienced service providers. This qualification process may include verification of certifications, review of past project performance, assessment of technical capabilities, and evaluation of customer satisfaction ratings. The platform may apply weighted ranking algorithms that consider factors such as geographic proximity, specialization in relevant DER technologies, project scale experience, and cost competitiveness to present customers with tailored service provider recommendations.

As projects develop and go into operation, the DEEM platform may showcase successful implementations through various media formats including video, website features, social media platforms such as TikTok, and other digital channels. These showcases may highlight projects using specific manufacturers or contractors and leverage the projects' success to enhance awareness of DER for new customers. By presenting real-world examples of successful implementations, the platform may help reduce the anxiety potential customers might experience when considering pursuing DER solutions. The showcases may include testimonials, performance metrics, visual documentation of installations, and narratives describing the implementation process and resulting benefits.

Embodiments of the present invention may incorporate security and privacy measures within the Digital Engagement Energy Marketplace (DEEM) platform to protect user data and maintain system integrity. The DEEM platform may implement various encryption and data protection methods, including any one or more of the following:
End-to-end encryption for data transmissions using protocols such as TLS (Transport Layer Security).
Data-at-rest encryption using algorithms such as AES (Advanced Encryption Standard) with 256-bit keys.
Homomorphic encryption techniques to perform computations on encrypted data without decryption.
Data anonymization or pseudonymization to protect user privacy while enabling aggregate analysis.

For user authentication and access control, the DEEM platform may employ any one or more of the following:
Multi-factor authentication (MFA) requiring multiple forms of identification.
Role-based access control (RBAC) with granular permissions based on user roles.
Adaptive authentication using machine learning to analyze user behavior patterns and trigger additional verification when unusual activity is detected.

The DEEM platform may maintain audit trails and logging systems that may include any one or more of the following:
Centralized logging of system events and user actions.
Tamper-evident logs using cryptographic techniques to ensure log integrity.
Real-time monitoring with advanced analytics to detect potential security threats.

In some embodiments, the DEEM platform may incorporate a security information and event management (SIEM) system providing a holistic view of the platform's security posture. The platform may conduct regular security audits and penetration testing to identify and address potential vulnerabilities.

Embodiments of the present invention may be applied to generate Energy Conservation Measure (ECM) system configurations in a manner analogous to the generation of Distributed Energy Resource (DER) system configurations. The system 300 shown in FIG. 3 includes components specifically designed for ECM evaluation and recommendation, which may operate in parallel with or independently from the DER-focused components.

The ECM system variant evaluation module 340 may evaluate a plurality of ECM system variants 350 using the customer-specific data 318. This evaluation process may involve analyzing various energy conservation technologies and strategies as contemplated and identified by the Department of Energy Technical Categories, such as lighting upgrades, HVAC improvements, building envelope enhancements, or equipment optimization. The module may employ similar techniques used in DER evaluation, including machine learning models, simulation tools, and data analytics, to predict performance characteristics 352 for each ECM variant.

Based on the predicted performance characteristics 352, the candidate ECM configuration generation module 342 may generate a plurality of candidate ECM configurations 354. This module may utilize optimization algorithms to identify ECM combinations that maximize energy savings while meeting customer-specific constraints and objectives. The generation process may consider factors such as implementation costs, energy savings potential, payback periods, and compatibility with existing building systems.

The ECM recommendation output production module 344 may produce an ECM recommendation output 356 based on the candidate ECM configurations 354. This output may include detailed specifications for recommended ECM implementations, projected energy savings, cost-benefit analyses, and implementation timelines. The module may generate comparative analyses between different ECM options, allowing customers to understand trade-offs between various energy conservation strategies.

The output interface module 346 may present the ECM recommendation output 356 to the customer in the form of manifested ECM recommendation output 358. This may involve creating interactive dashboards, detailed reports, or visual representations of proposed ECM implementations within the customer's facility.

In some cases, the system 300 may integrate the ECM and DER evaluation processes, allowing for comprehensive energy management recommendations that combine energy conservation measures with distributed energy resources. This integrated approach may enable the system to identify synergies between ECMs and DERs, potentially leading to more holistic and effective energy solutions for customers.

The ECM-focused components of system 300 may leverage similar data sources and analytical techniques as their DER counterparts. For example, the customer-specific data 318 used for ECM evaluation may include detailed information about the customer's energy consumption patterns, building characteristics, and equipment inventories. The system 300 may also incorporate external data sources, such as energy efficiency benchmarks, equipment performance databases, and utility rate structures, to enhance the accuracy of ECM recommendations.

By applying the methods and systems of the present invention to ECM configuration generation, embodiments may provide customers with energy optimization solutions that address both supply-side (DER) and demand-side (ECM) aspects of energy management. This approach may enable more effective reduction of energy consumption, costs, and environmental impact across various customer segments and facility types.

In some embodiments, the system 300 may include emissions monitoring and compliance capabilities that enable the customer 330 to track, quantify, and report greenhouse gas (GHG) emissions associated with the customer's facility. These capabilities may operate in conjunction with or independently from the DER recommendation features described herein.

In some embodiments, the system 300 may ingest energy consumption measurements from a plurality of source-specific adapters that converge on a single canonical activity-record schema. The plurality of adapters may include, for example, any one or more of: a Letter-of-Authorization-driven utility data feed, in which the customer 330 authorizes the system 300 to retrieve interval, monthly, and tariff data directly from the utility on a recurring schedule; a building management system (BMS) adapter supporting protocols such as BACnet, Modbus, and OPC UA for HVAC, lighting, plug-load, and submetering telemetry; an IoT message broker adapter supporting transports such as MQTT and Kafka; a file-upload adapter accepting PDF, Excel, and CSV files with automated extraction logic; a manual-entry adapter providing form-based input for fuel receipts, refrigerant logs, and other activity data; and a programmable logic controller (PLC) collection adapter for breakers and transfer switches.

The system 300 may normalize ingested data into a unified activity-record format. Each activity record may comprise, for example, a tenant identifier, a facility identifier, a reporting-period identifier, a source-type indicator, a quantity value, a unit-of-measure indicator, and a scope-candidate indicator. The system 300 may apply unit harmonization to convert heterogeneous inbound units (such as kWh, therms, gallons, or cubic feet) into a canonical unit appropriate for each energy type. In some cases, the system 300 may perform deduplication to suppress redundant records when the same consumption appears in multiple feeds, and may perform sub-meter reconciliation to allocate master-meter totals across downstream sub-meters without double-counting.

In some embodiments, the system 300 may distinguish among Scope 1, Scope 2, and Scope 3 emissions through a deterministic source-type-to-scope mapping applied at activity-record insertion time. For example, source types such as stationary combustion, mobile combustion, fugitive emissions, and process emissions may be mapped to Scope 1; source types such as purchased electricity and purchased steam may be mapped to Scope 2; and remaining source types may be mapped to Scope 3 with category routing according to the GHG Protocol.

The system 300 may select an emission factor for each activity record through a multi-tier priority traversal over a factor library. For example, the system 300 may implement a four-tier priority traversal comprising: Tier 1 supplier-specific factors scoped to the tenant and matched by geography; Tier 2 contractual instrument factors derived from renewable energy certificates (RECs) or power purchase agreements (PPAs) with bundled attributes; Tier 3 published geography-matched factors from authoritative sources such as EPA eGRID or DEFRA; and Tier 4 published default factors for global fallback. The system 300 may apply first-match termination, selecting the highest-priority factor that matches the activity record's characteristics.

In some cases, the system 300 may calculate emissions by multiplying the activity quantity by the selected emission factor and storing the result as a calculation record associated with the activity record. The system 300 may support multiple calculation results per activity record to accommodate factor updates, methodology changes, or scenario analysis.

In some embodiments, the system 300 may maintain a versioned registry of regulatory thresholds and penalty schedules applicable to GHG emissions. The registry may comprise, for example, a jurisdiction identifier, a program name, a penalty structure, a penalty rate, threshold values, and effective dates. The system 300 may implement a currency mechanism comprising periodic retrieval from authorized publication channels, change-detection by content difference, and a candidate-amendment review queue with human approval before registry updates take effect.

The system 300 may include an applicability evaluator that determines which regulatory thresholds apply to a given customer based on customer profile attributes. The applicability evaluator may consider factors such as customer revenue, listing status, employee count, operating jurisdictions, NAICS sector codes, and per-site building square footage. In some cases, the applicability evaluator may produce both a boolean determination and a human-readable reasoning string for audit purposes.

In some embodiments, the system 300 may generate an emissions accuracy score that quantifies the confidence level of calculated emission quantities for a defined reporting period. The emissions accuracy score may be computed as a weighted combination of a plurality of component metrics. For example, the component metrics may include: an evidence completeness metric representing the proportion of activity records that have attached supporting evidence; a data quality metric representing the proportion of calculation results that have been approved through a review workflow; and a field completeness metric representing the proportion of activity records that have all required fields populated.

The system 300 may apply configurable weights to each component metric and aggregate the weighted components to produce a composite accuracy score. For example, the system 300 may apply weights of 0.4 to evidence completeness, 0.4 to data quality, and 0.2 to field completeness, and compute the composite score as the weighted sum of the three components. The composite accuracy score may be expressed as a value between 0 and 1, or as a percentage, and may be presented to the customer 330 via the interface module 316 as part of an emissions disclosure output.

In some cases, the system 300 may compute the emissions accuracy score over an activity-record set selected by a configurable score context, such as company-wide, disclosure-scoped, or temporal-period-scoped. The system 300 may store historical accuracy scores to enable trend analysis and may present accuracy score trends via the interface module 316.

In some embodiments, the system 300 may prioritize remediation of activity records to maximize the emissions accuracy score. The system 300 may compute a current accuracy score over an activity-record set selected by a configurable score context. For each candidate activity record and each remediation operation type (such as attaching evidence, completing required fields, or approving a pending record), the system 300 may simulate the operation and compute a marginal impact on the accuracy score.

For example, the marginal impact of attaching evidence to a record that currently lacks evidence may be computed as the evidence weight multiplied by the reciprocal of the total activity count. The marginal impact of approving a pending record may be computed using a closed-form expression that accounts for the change in the ratio of approved to non-superseded calculation results.

The system 300 may rank candidate records by descending total marginal impact, group them by dominant remediation operation type, and present per-group cumulative impact projections. The system 300 may also compute a counterfactual projected accuracy score conditional on the user selecting a batch of remediation actions, enabling the customer 330 to understand the expected improvement before committing to the actions. Upon user selection, the system 300 may execute the remediation actions as an atomic batch with separation-of-duties enforcement (such as rejecting an approval when the approver is the same as the record creator) and partial-success accounting.

In some embodiments, the method 200 and system 300 may perform various steps automatically, without requiring further human intervention after the initial input of customer-provided customer-specific data. This automated process may enhance efficiency, reduce human error, and provide rapid, data-driven DER recommendations.

The data creation module 302 may automatically retrieve external customer-specific data through the external data retrieval module 306. This module may connect to various databases, APIs, and other data sources to gather relevant information such as utility rates, weather data, equipment specifications, and regulatory information. The synthetic data generation module 308 may then automatically generate synthetic customer-specific data to supplement the available information.

The variant evaluation module 310 may automatically evaluate a plurality of DER system variants 320 using the compiled customer-specific data 318. This evaluation process may involve running simulations, applying machine learning models, and performing complex calculations to predict the performance characteristics 322 of each variant.

Based on the evaluation results, the configuration generation module 312 may automatically generate a plurality of candidate DER system configurations 324. This process may involve optimizing various parameters, exploring different technology combinations, and applying constraints derived from the customer-specific data.

The output production module 314 may automatically produce the DER recommendation output 326 by selecting one or more configurations from the candidates and generating associated analytical data. This may include automatically creating financial models, emission reduction projections, and resilience performance metrics for each selected configuration.

The interface module 316 may automatically format and present the manifested DER recommendation output 328 to the customer 330 through a user interface, potentially including interactive elements for exploring the recommendations.

The system 300 may also automatically update its recommendations as new data becomes available. For example, it may periodically re-evaluate DER configurations based on updated market prices, technology advancements, or changes in regulatory environments.

The system 300 may automatically initiate and manage communication with third-party service providers, such as equipment manufacturers or installers, to gather additional information or refine recommendations.

The machine learning components of the system 300 may automatically train and update their models based on new data and feedback, continuously improving the accuracy and relevance of the DER recommendations.

In some cases, the system 300 may automatically generate and submit required documentation for permits, interconnection agreements, or incentive applications based on the recommended DER configurations.

The system 300 may automatically monitor the performance of implemented DER systems, comparing actual results to predictions and using this information to refine future recommendations.

By automating these various steps, the method 200 and system 300 may provide a comprehensive, efficient, and adaptive approach to DER evaluation and recommendation, potentially reducing the time and resources required to identify optimal energy solutions for customers.

Embodiments of the present invention may implement the method 200 and system 300 in a networked environment, enabling distributed access and functionality across multiple devices and systems. In some aspects, the customer 330 may access the DEEM platform through one or more user devices. These devices may include desktop computers, laptops, tablets, smartphones, or other internet-connected devices capable of running web browsers or dedicated end-user applications. The user devices may execute web clients that render web-based interfaces for interacting with the DEEM platform, or they may run specialized end-user applications designed specifically for accessing the platform's features.

The method 200 and system 300 may be primarily implemented on a server system that communicates with the user devices over a network. This network may be the internet, a wide area network (WAN), a local area network (LAN), or any combination thereof. The server system may comprise one or more physical or virtual servers, potentially distributed across multiple data centers for redundancy and load balancing. In some embodiments, the server system may include an API gateway server that manages incoming requests from user devices and third-party applications. This gateway may handle authentication, request routing, and load balancing to ensure efficient processing of user interactions and data queries. The server system may also include a web server component that serves web-based interfaces to users accessing the platform through web browsers. This web server may generate dynamic content based on user interactions and data retrieved from the DEEM platform's backend systems.

The core functionality of the method 200 and system 300, including the data creation module 302, variant evaluation module 310, configuration generation module 312, and output production module 314, may be implemented as server-side applications or services running on the server system. These components may interact with a database system that stores customer-specific data 318, DER system variants 320, and other relevant information. In some cases, the external data retrieval module 306 may communicate over the network with one or more third-party servers and applications to gather additional data for analysis. This may include accessing utility company databases for energy consumption records, weather service APIs for climate data, or financial institution systems for credit information. The synthetic data generation module 308 and various machine learning components may be implemented as specialized services within the server system, potentially leveraging distributed computing resources for intensive calculations and data processing tasks.

The interface module 316 may be responsible for preparing and formatting the manifested DER recommendation output 328 for transmission to user devices over the network. This may involve generating responsive web content, API responses, or data packages for consumption by end-user applications. In some embodiments, the system may implement websocket connections or other real-time communication protocols to provide live updates and interactive features to users as they navigate through the DER evaluation and recommendation process.

The networked implementation may also support multi-tenant architecture, allowing the DEEM platform to serve multiple customers simultaneously while maintaining data isolation and security. This approach may enable efficient resource utilization and scalability as the user base grows. By leveraging a networked architecture, embodiments of the present invention may provide flexible access to the DEEM platform's capabilities, enabling users to interact with the system from various locations and devices while maintaining centralized processing and data management on the server side.

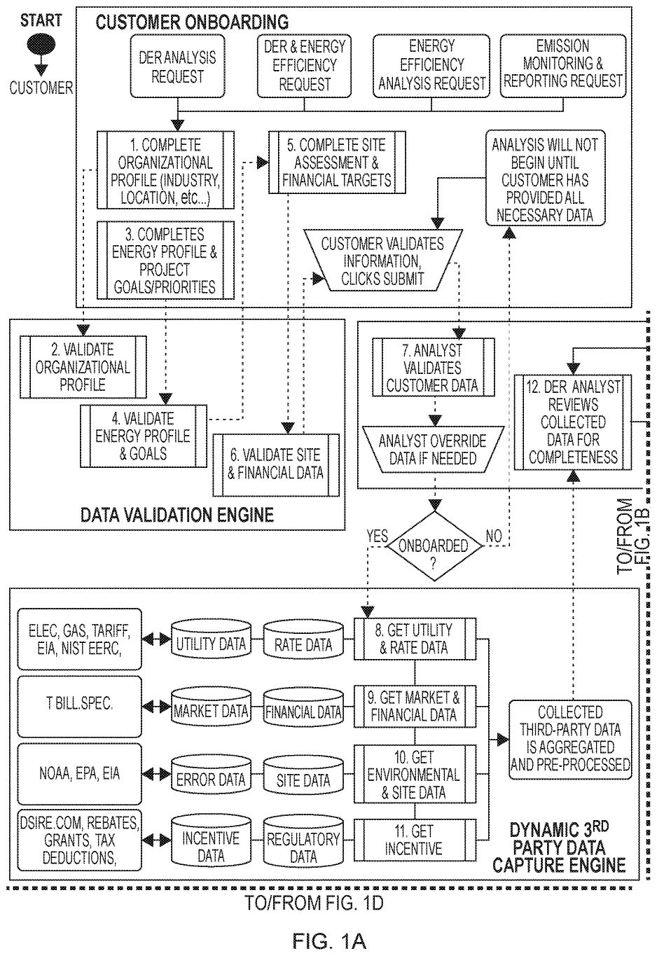

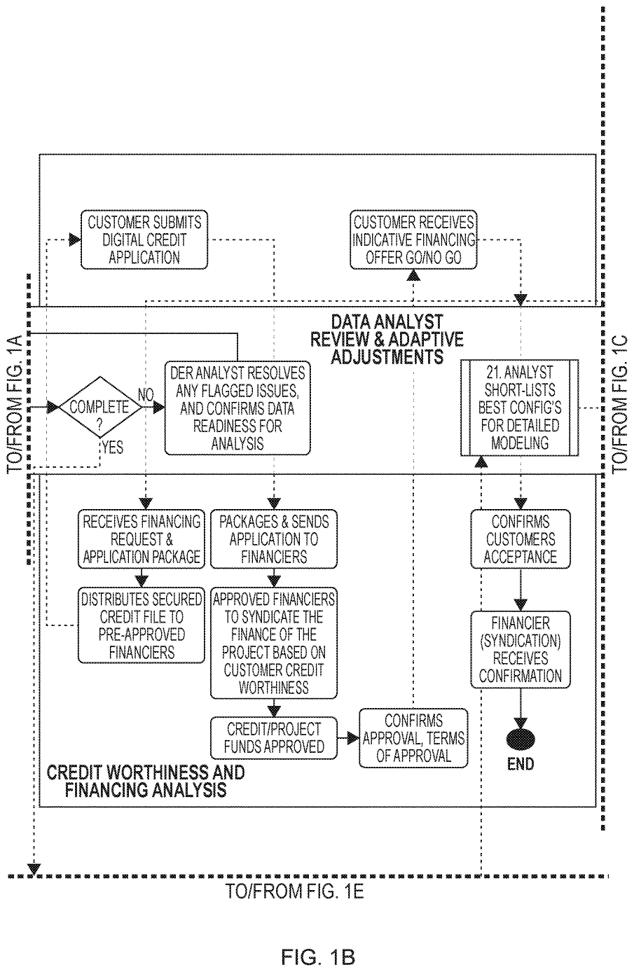

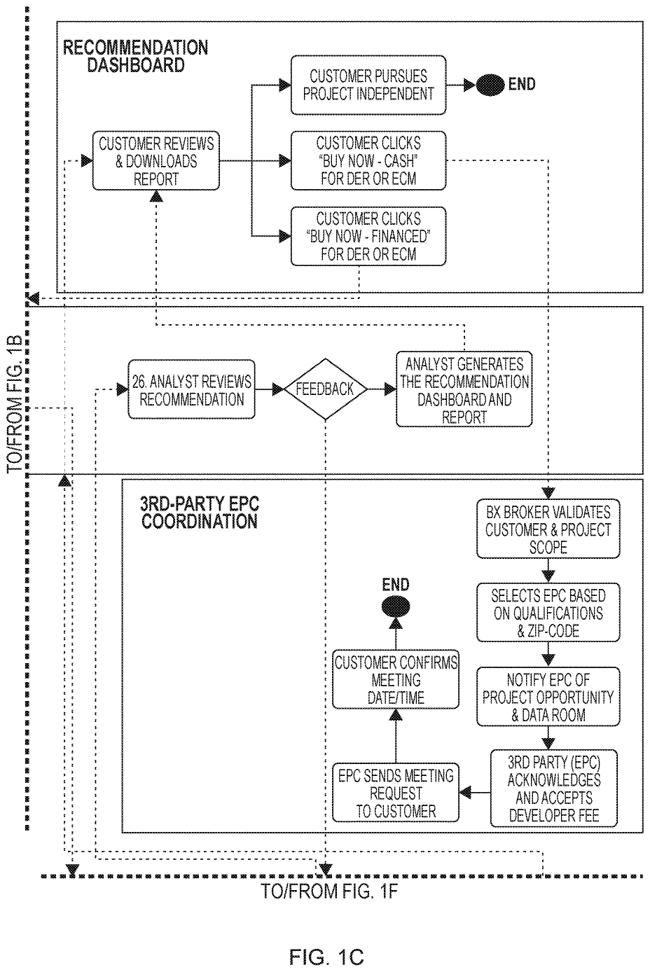

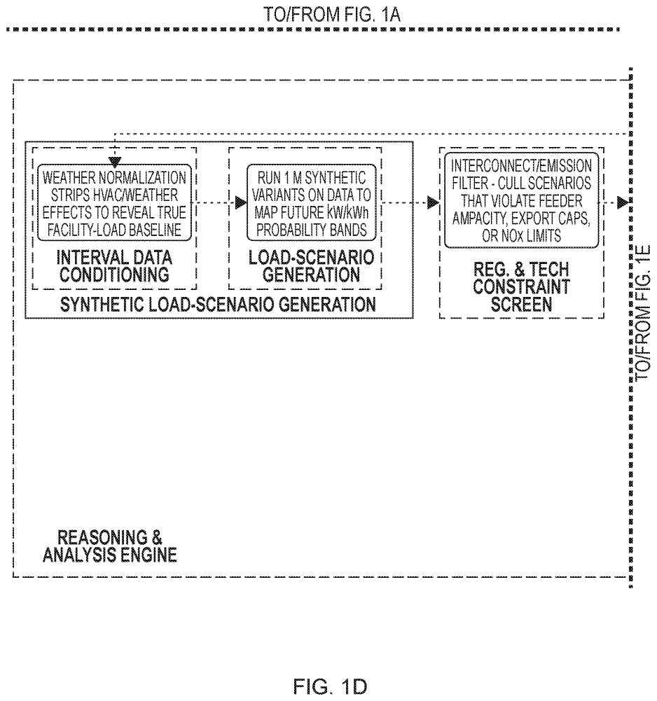

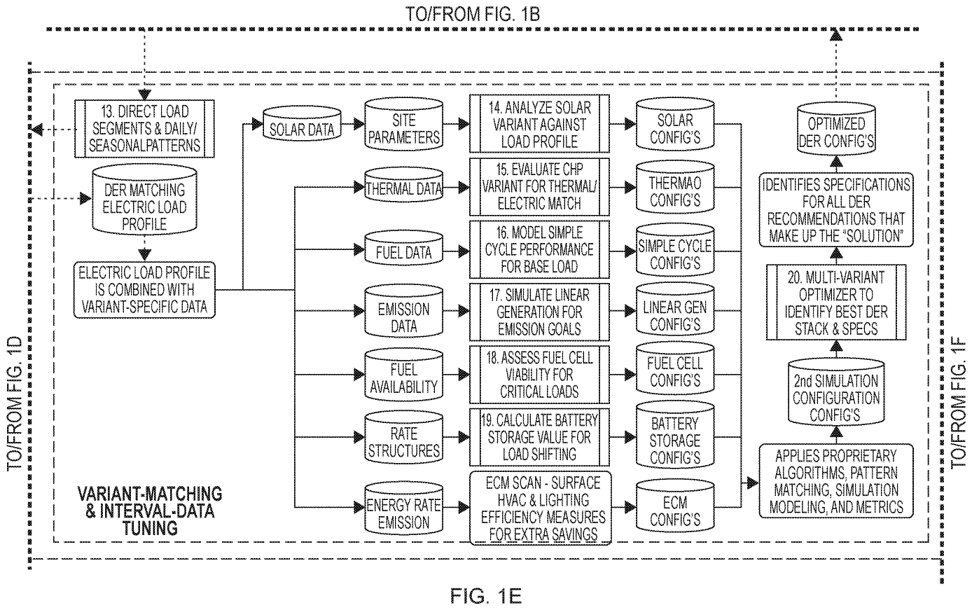

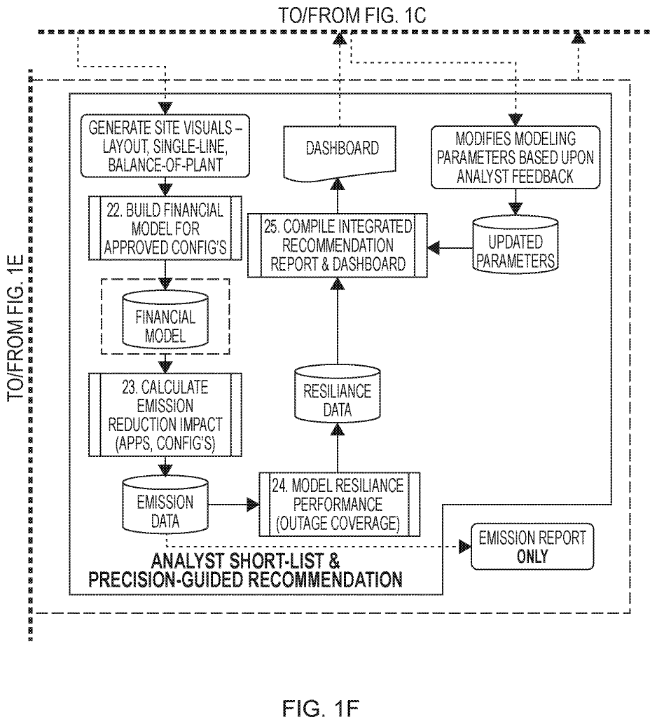

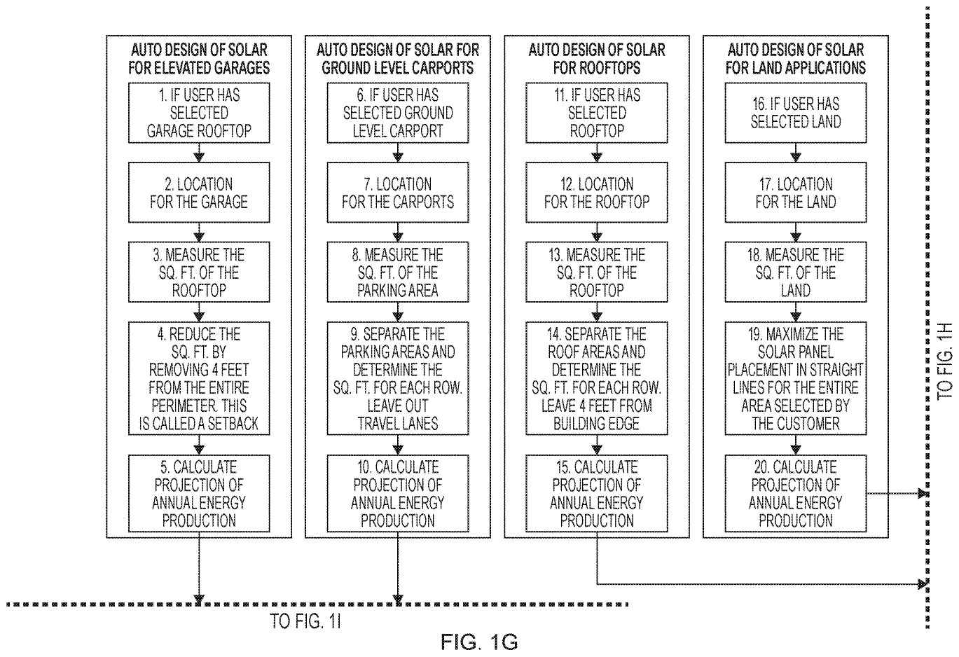

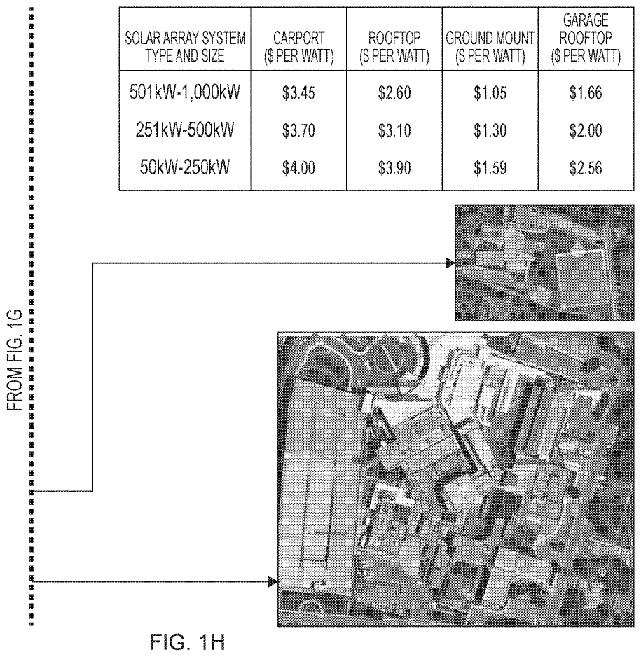

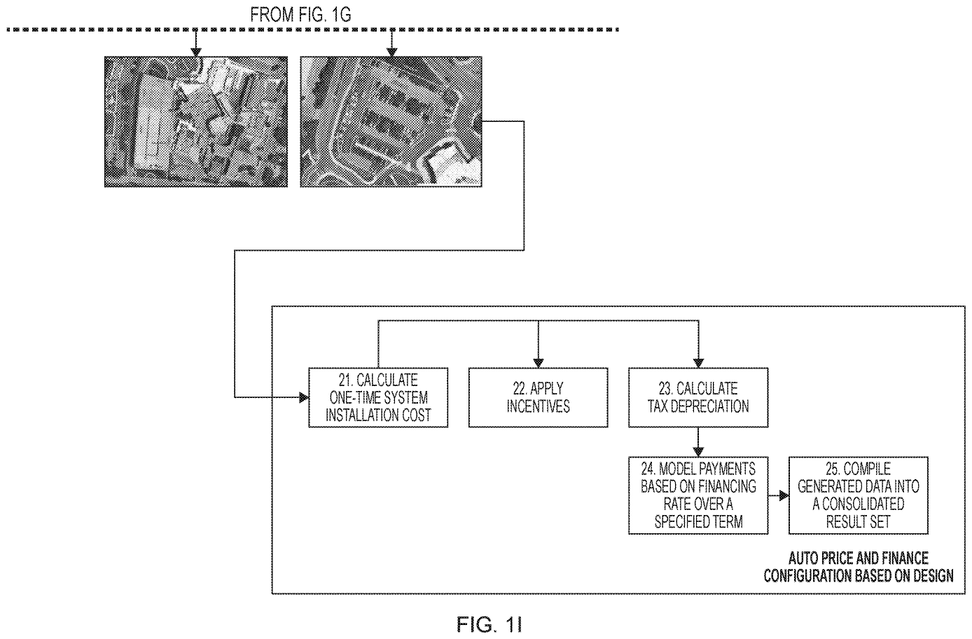

FIGS. 1A-1F are swim lane business process flow charts for evaluating and implementing distributed energy resource solutions according to one embodiment of the present invention.

The process of FIGS. 1A-1F includes a Customer Onboarding module that collects and structures customer information needed for the DER recommendation workflow, transforming unstructured inputs into a standardized customer profile (customer-specific data 318) for downstream processing.

The Complete Organizational Profile element processes one of the customer's analysis requests (DER Analysis, DER & Energy Efficiency, Energy Efficiency Analysis, or Emission Monitoring & Reporting), extracting key metadata including industry classification, facility location, organizational metrics, and performance goals. It standardizes this information and creates a structured organizational profile object for downstream modules.

The Validate Organizational Profile module performs schema and data-quality checks on the organizational profile, ensuring all required fields are present and correctly formatted. It enriches missing or inconsistent entries using internal taxonomies and external APIs. Validated profiles are marked as ready and passed to the Complete Energy Profile & Project Goals/Priorities block.

The Complete Energy Profile & Project Goals/Priorities module prompts customers to provide historical energy usage data and project objectives. It standardizes consumption data into a normalized time-series energy profile and encodes objectives into a structured schema, producing a combined energy profile and goals object for downstream validation.

The Validate Energy Profile & Goals module performs data-quality and consistency checks on the energy profile and goals object. It verifies the historical usage time series integrity, confirms project goals are properly specified, and flags or corrects issues. The module outputs a validated energy profile and goals object for downstream processing.

The Complete Site Assessment & Financial Targets module aggregates data from the validated profiles and third-party sources including utility rates, market pricing, environmental conditions, and incentive programs. It calculates key financial targets such as system size, production estimates, costs, and expected returns based on customer goals. The module produces a comprehensive site assessment and financial targets package for subsequent validation and DER-variant matching.

The Validate Site & Financial Data module performs integrity, and consistency checks on all integrated third-party inputs. It verifies utility rate schedules, incentive programs, site constraints, and financial targets. Missing or inconsistent data is flagged for review, with gaps filled using default assumptions or interpolated values. The module outputs a validated site and financial data package for subsequent processing.

The Customer Validates Information module displays the validated data package in the user interface for customer review. It shows facility information, energy usage, rate schedules, incentives, and financial targets. The customer can correct entries or confirm accuracy. Upon submission, the system proceeds with live third-party data capture and DER variant matching.

The Analyst Validates Customer Data module enables expert review of the confirmed data package. The analyst verifies rate schedules, energy usage profiles, and incentive assumptions, making corrections as needed using the system's knowledge base and reference data. The module outputs a finalized customer data package for subsequent processing.

The Onboarded decision block checks whether all customer and site information has passed both customer review and analyst validation. If complete, the workflow advances to live third-party data capture. If data still needs correction, it routes back to the appropriate customer or analyst step before continuing.

The Dynamic 3rd Party Data Capture Engine functions as the system's data gateway, automatically retrieving external datasets essential for DER analysis and financial modeling. After onboarding and validation, the engine uses validated site and load profiles to initiate API calls and database queries for utility rates, market benchmarks, environmental conditions, and regulatory program rules. It aggregates these diverse data sources, normalizes formats, applies necessary preprocessing, and caches results. This centralization ensures downstream processes operate with current, reliable data.

The engine employs four parallel retrieval modules that activate once customer and site data are validated. The first module obtains utility tariff schedules via provider APIs or published rate books. The second retrieves financial benchmarks including Treasury bill rates, SREC prices, and commodity indices through financial data services. The third gathers environmental parameters such as weather data, solar irradiance, and topography analyses. The fourth captures incentive and rebate program details from sources like DSIRE and state energy offices. Each module deposits its data into a staging area, where the engine merges all streams, aligns formats, filters duplicates, and outputs a consolidated data package.

A DER analyst reviews the aggregated data package for completeness, examining utility rates, market benchmarks, environmental parameters, and incentive programs. The analyst flags any missing or out-of-range values and can manually supplement or correct data using knowledge-base lookups or direct uploads. Once confirmed complete and accurate, the analyst marks the dataset as analysis-ready for load-segment detection and variant matching.

If the analyst identifies incomplete data, they flag specific missing elements and trigger a targeted re-run of the relevant data-capture modules. For example, missing rate periods or incentive programs prompt the system to re-invoke specific data retrieval processes. The newly retrieved data flows through aggregation and preprocessing, and the analyst reviews the updated package until all required elements are present and accurate.

The Variant-Matching & Interval-Data Tuning block evaluates cleansed inputs including load segments, interval consumption data, tariffs, incentives and DER variant logic. The system applies pattern-matching and simulation algorithms to test candidate DER configurations against facility load profiles, fine-tuning parameters like panel orientation and battery dispatch rules. This produces optimized DER stacks with detailed sizing, scheduling and cost modeling that feed into analyst review.

The Detect Load Segments module analyzes validated energy usage data to identify distinct load categories and patterns. It uses clustering algorithms to segment consumption into base, intermediate and peak loads, analyzing daily profiles and seasonal trends. The output includes load segment definitions and usage curves used for DER optimization.

The Synthetic Load-Scenario Generation module combines conditioned interval data, load segments, and usage patterns with weather normalization and demand variations to generate potential future demand profiles covering diverse operating conditions.

The Regulatory & Technical Constraint Screen evaluates synthetic scenarios and DER configurations against interconnection requirements/standards, emission limits and equipment constraints, filtering out non-compliant combinations.

The DER matching module overlays each variant's generation or load-shifting patterns onto baseline usage to produce net electric load curves, creating variant-specific profiles for equipment sizing and performance projections.

The system aligns load profiles with variant performance templates, matching generation patterns to facility demands. This produces configuration objects for solar, thermal generation, simple-cycle, linear generation, fuel cells and battery storage, each with detailed specifications based on actual and synthetic scenarios.

The Variant-Matching module integrates all data streams including resource profiles, site parameters, performance metrics, and rate structures to drive simulations. Specifically:
Solar analysis combines irradiance data with site parameters to simulate photovoltaic output and specify array configurations
CHP evaluation matches thermal-electric output to load requirements
Simple cycle modeling applies turbine performance to base loads
Linear generation simulation focuses on emission reduction targets
Fuel cell assessment evaluates critical load coverage capabilities
Battery (electrical and/or thermal and/or compression and/or gravity) storage analysis optimizes load shifting economics
ECM evaluation identifies efficiency upgrade opportunities with projected savings

The module applies algorithms to these DER configuration objects, running simulations and pattern-matching to optimize sizing and dispatch parameters. Performance metrics are calculated for each configuration, producing refined configurations ready for financial modeling.

The Multi-Variant Optimizer uses optimization algorithms to balance cost, reliability, emissions, and technical constraints against customer goals. It produces a ranked shortlist of recommended DER solutions with detailed specifications.

The specifications module converts each approved DER stack into detailed equipment and design specifications, including sizing, layout rules, balance-of-plant requirements, and control settings. This comprehensive specification package feeds into financial modeling and recommendation reports.

The Analyst Short-lists Best Configs for Detailed Modeling module reviews the specification package and performance metrics for each approved DER stack. The analyst evaluates configurations based on cost, IRR, payback period, emissions impact, reliability, and site constraints, then selects the top three to five designs for deeper analysis. The output is a shortlisted set of DER configuration objects with analyst refinements, which proceed to financial modeling and impact calculations.

The Analyst Short-List & Precision-Guided Recommendation module combines top DER configurations with financial models, emission-reduction metrics, resilience data, and optimization guidance in an interactive workspace. Analysts can compare performance trade-offs, adjust parameters, and immediately view updated outcomes. The final output may produce a precision-guided recommendation package with ranked DER stacks, specifications, performance guarantees, and a dynamic dashboard for customer review.

The Generate Site Visuals module uses shortlisted DER configurations, specifications, geocoordinates, and equipment libraries to create layout designs. It automatically places equipment according to specified clearances and orientations, generates single-line electrical diagrams showing interconnections, and produces balance-of-plant schematics detailing auxiliary systems. The output may include professional drawing files (PDF/DWG/CAD) for engineering and permitting purposes.

The Build Financial Model module processes shortlisted DER configurations with relevant cost inputs including equipment costs, incentives, O&M assumptions, financing terms, tariff data, and tax rules. It creates multi-year cash-flow projections, applies discounting, and calculates key metrics such as but not limited to NPV, IRR, payback period, LCOE, and debt service coverage. The output is a comprehensive Financial Model package with cash-flow tables, metric dashboards, and scenario comparisons for the final recommendation.

The Calculate Emission Reduction Impact module combines the Financial Model package with standardized emission factors for CO₂, NOₓ SOₓ and other pollutants. It multiplies each configuration's projected energy production or load offset by relevant emission factors to quantify avoided emissions annually and over the system lifetime. The output is an Emission Data object detailing total and per-pollutant reductions for each DER configuration.

The resilience-performance modeling module analyzes the Emission Data object, approved DER configurations, facility critical-load definitions, and resilience goals from the project profile.

The module maps each DER stack's generation and storage profiles against various outage scenarios using high-resolution interval data. It calculates how long each configuration can supply critical loads under worst-case conditions, then applies reliability algorithms to convert these durations into standard metrics such as outage coverage hours, critical load percentage, and reliability indices.

The output is a Resilience Data object quantifying each configuration's power maintenance capability during outages, including time-based coverage metrics and normalized indices for the recommendation report.

The Compile Integrated Recommendation Report & Dashboard module integrates all finalized data streams and analyst-updated parameters into a cohesive report structure. It renders an interactive dashboard comparing each DER configuration's financial metrics, emissions impact, and resilience performance alongside equipment specifications. The output is a comprehensive web-enabled dashboard and report package for stakeholder review and approval and download of PDF.

The Analyst Reviews Recommendations module presents the interactive dashboard for analyst examination. If adjustments are needed to parameters such as dispatch rules, incentives, or resilience targets, the analyst provides feedback that triggers automatic regeneration of the dashboard with updated assumptions. This review cycle continues until the analyst approves the final recommendation package for customer delivery.

The Recommendation Dashboard module transforms the compiled report package into an interactive web interface. It receives the integrated recommendation report with DER configurations, financial models, emission data, and resilience metrics, then renders visualizations including KPI cards, comparison charts, equipment layouts, and technical diagrams. Users can filter by goals, adjust parameters, and may export PDFs, DWG, or CAD drawings. The output is an interactive dashboard and downloadable report bundle for stakeholder evaluation and approval.

After dashboard finalization, the customer reviews it and may choose from multiple implementation pathways. These pathways may include, for example: declining to proceed further with the recommendations (thereby ending the workflow), selecting a direct purchase option (such as a “Buy Now-Cash” button, which may proceed to contractor coordination for engineering, procurement and construction services), or selecting a financing option (such as a “Buy Now Financed” button, which may advance to credit evaluation and financing analysis for various funding arrangements such as loans, leases, or power purchase agreements). The system may provide these or other implementation options through various user interface elements, allowing customers flexibility in how they proceed with the recommended DER configurations.

In some embodiments, the system 300 may include a procurement integration module that enables the customer 330 to initiate procurement of a DER system directly from a generated DER system configuration without manually re-entering component specifications. Upon generation of a candidate DER system configuration by the optimization process described herein, the system 300 may store the configuration as a configuration record in a persistent data store. The configuration record may be associated with a unique configuration identifier and may preserve the component specification, financial model, and performance projection generated by the optimization process at the time of storage.

The interface module 316 may present one or more selectable procurement actions associated with the stored configuration record. For example, the interface module 316 may present a “Buy Now” button or similar user interface element that enables the customer 330 to initiate procurement of the DER system defined by the component specification. Selection of a procurement action may cause the system 300 to generate a procurement order that is parameterized by the stored configuration record, eliminating the need for manual re-entry of technical specifications. The procurement order may comprise the unique configuration identifier, the component specification, and at least a subset of the financial model and performance projection. In some cases, the system 300 may preserve the association between the procurement order and the configuration record from which it was generated, maintaining an analytical chain of custody between the optimization output and the procurement event.

The procurement order may be transmitted to one or more recipient systems, which may include supplier fulfillment interfaces, system integrator platforms, or project development management systems. For example, the system 300 may transmit the procurement order to an engineering-procurement-construction (EPC) partner, an equipment supplier, or a financing institution.

In some embodiments, the system 300 may query a supplier database prior to presenting the selectable procurement action to identify one or more available suppliers capable of fulfilling the component specification. The interface module 316 may present a ranked list of available suppliers associated with the selectable procurement action. Ranking criteria may include equipment availability, lead time, geographic proximity to the facility, pricing, or any combination thereof. The customer 330 may select a supplier from the ranked list, and the selected supplier may be associated with the procurement order prior to transmission.

In some cases, upon selection of the selectable procurement action, the system 300 may create an immutable procurement record that preserves the configuration state at the time of procurement. The immutable procurement record may comprise the unique configuration identifier, a timestamp of the procurement action, a user identifier associated with the procurement action, the component specification as it existed at the time of procurement, and the financial model and performance projection as they existed at the time of procurement. The immutable procurement record may be stored separately from any subsequently modified version of the configuration record, preserving the configuration state that formed the basis for the procurement order. This approach may support regulatory and contractual defensibility by providing evidence that what was ordered matches what was designed.

In some embodiments, the interface module 316 may present one or more financing options in conjunction with the selectable procurement action. The financing options may be calculated based at least in part on the financial model associated with the configuration record. In response to selection of a financing option by the customer 330, the system 300 may incorporate the selected financing terms into the procurement order prior to transmission.

In some cases, the interface module 316 may present a comparison interface prior to selection of the selectable procurement action, enabling the customer 330 to compare the configuration record against one or more alternative configuration records generated from the same site-specific data under different weighting parameters. Each configuration record in the comparison interface may be independently associated with a selectable procurement action, enabling the customer 330 to initiate procurement of any compared configuration without navigating away from the comparison interface.

In some embodiments, after transmission of the procurement order, the system 300 may receive status updates from the recipient of the procurement order at defined stages of fulfillment. The system 300 may update the configuration record with received status updates and present, via the interface module 316, a fulfillment status associated with the procurement order. The fulfillment status may include any one or more of order confirmation, equipment procurement status, installation scheduling, or commissioning completion.

The 3rd-Party EPC Coordination module kicks in when the customer commits to a cash or financed purchase of DER or ECM. It receives the final Recommendation Dashboard output (e.g., the approved DER or ECM specifications, project scope, and customer contact details) and uses the system's broker network and qualification rules to identify and engage an appropriate engineering-procurement-construction (EPC) partner. The module validates broker credentials against project requirements, notifies shortlisted EPC firms of the opportunity and provides secure access to the project data room, and then tracks each EPC's acknowledgment and developer-fee acceptance. Finally, it automates meeting invitations to the customer and confirms the kickoff appointment, producing a fully signed EPC engagement package and confirmed schedule for detailed design and implementation.

Within the 3rd-Party EPC Coordination module, the system first has the broker validate the customer's identity and project scope against pre-defined criteria to ensure the opportunity is viable. Next, it selects one or more EPC firms whose qualifications and service areas (e.g., determined by zip code) match the project's technical and geographic requirements. The module then notifies the chosen EPC(s) of the project opportunity and grants them secure access to the project data room. Upon receiving the invitation, each EPC formally acknowledges the opportunity and accepts the developer fee. After acceptance, the EPC sends a meeting request back to the customer proposing dates and times. Finally, the customer reviews the proposal and confirms the meeting date and time, completing the coordination loop and setting the stage for detailed engineering and site planning.

If the customer selects a direct purchasing option (e.g., by clicking “Buy Now—Cash”) for DER or ECM, the system moves into the 3rd-Party EPC Coordination module to arrange engineering, procurement and construction. That module begins when the system receives a financing request and application package from the customer. It then distributes the secured credit file to a set of pre-approved financiers. The customer submits a digital credit application and the system packages and forwards that application to the financiers. Once financiers approve and syndicate the project financing based on the customer's creditworthiness, the system confirms that credit and project funds may be or are approved (through an indicative offer or firm offer) and communicates the terms of approval. The customer then receives an indicative financing offer (Go/No Go), and when the customer indicates acceptance, the system logs the customer's acceptance and notifies the financier syndication network that the deal is closed. At that point the EPC coordination process is fully engaged and the workflow ends.

FIGS. 1G-1I are swim-lane flow charts illustrating the specific workflow executed when a customer selects emission reduction as the primary design objective. It corresponds to the solar-variant branch of the comprehensive “To-Be” Swim-Lane Business Process Flow Chart shown in FIGS. 1A-1F and encapsulates the tailored steps for automatic solar array configuration, sizing, costing and incentive modeling under an emission-focused scenario.

In the broader Swim-Lane flow of FIGS. 1A-1F, the system proceeds through customer onboarding and validation, dynamic third-party data capture, multi-variant evaluation, and recommendation generation. FIGS. 1G-1I refine the “Analyze Solar Variant Against Load Profile” and “Build Financial Model for Approved Configurations” stages by detailing high-level operations such as site-type selection, map-based area measurement with perimeter setbacks, irradiance-based kW sizing, tiered cost computation, application of incentives and depreciation, and optional financing scenarios. The outputs produced by FIGS. 1G-1I feed directly into the financial-modeling and recommendation-dashboard modules of the Swim-Lane flow, enabling delivery of an emission-optimized solar solution to the customer.

In the system of FIGS. 1G-1I, the system implements an “Auto design of solar for elevated garages” module that branches from the generic solar-variant path of the flow of FIGS. 1A-1F. This module automates site selection, area measurement with setbacks, and preliminary array sizing and energy-yield estimation for a garage rooftop installation, thereby generating the core inputs needed for downstream cost and financial modeling. Within this module, blocks 1-5 of FIGS. 1G-1I execute as follows:
Site Selection (Block 1): The system recognizes that the customer has specified a garage rooftop as the target installation surface.
Address & Area Highlight (Block 2): The system retrieves the site address, presents an interactive aerial or map view, and allows the customer to highlight the garage rooftop footprint.
Raw Area Measurement (Block 3): The system computes the total square footage of the highlighted rooftop region.
Setback Application (Block 4): The system subtracts a uniform four-foot perimeter margin from the highlighted area as well as a four-foot setback from major equipment (if any) to ensure compliance with clearance and structural constraints, yielding a net usable area.
Capacity & Yield Calculation (Block 5): The system multiplies the net usable area by an irradiance factor (7.81 W/ft²) to determine array capacity in kilowatts, then projects annual energy production by applying 8,760 hours/year and a regional performance multiplier (e.g., 0.17 for the Mid-Atlantic).

Upon completion of blocks 1-5, the system produces a preliminary solar array specification—comprising the array's rated capacity (kW) and estimated annual generation (kWh)—which is forwarded to the cost, incentives, depreciation and financing modules for full financial modeling.

Referring to FIGS. 1G-1I, the system implements an “Auto design of solar for ground-level carports” module that branches from the generic solar-variant path of the Swim-Lane flow of FIGS. 1A-1F. This module automates selection of the carport surface, area delineation with row-level precision, and preliminary array sizing and energy-yield estimation for a ground-level carport installation, thereby producing the core inputs needed for downstream cost and financial modeling. Within this module, blocks 6-10 of FIGS. 1G-1I execute as follows:
Site Selection (Block 6): The system recognizes that the customer has specified a ground-level carport as the installation surface.
Address & Area Highlight (Block 7): The system retrieves the site address, displays an interactive aerial or map view, and allows the customer to highlight the carport coverage area.
Raw Area Measurement (Block 8): The system computes the total square footage of the highlighted parking area.
Segment Separation (Block 9): The system divides the highlighted area into individual parking rows—excluding travel lanes—to determine precise row-by-row square footage.
Capacity & Yield Calculation (Block 10): The system multiplies the aggregated row footage by an irradiance factor (7.81 W/ft²) to calculate array capacity in kilowatts, then projects annual energy production by applying 8,760 hours/year and a regional multiplier (e.g., 0.17 for the Mid-Atlantic).

Upon completion of blocks 6-10, the system generates a preliminary solar array specification (comprising the array's rated capacity (kW) and estimated annual generation (kWh)), which is forwarded to the cost, incentives, depreciation, and financing modules for full financial modeling.

Referring to FIGS. 1G-1I, the system implements an “Auto design of solar for rooftops” module that branches from the generic solar-variant path of the Swim-Lane flow of FIGS. 1A-1F. This module automates rooftop area delineation with perimeter setbacks and preliminary array sizing and energy-yield estimation for flat or sloped roof installations, thereby generating the core inputs for downstream cost and financial modeling. Within this module, blocks 11-15 of FIGS. 1G-1I execute as follows:
Site Selection (Block 11): The system recognizes that the customer has specified a conventional building rooftop as the installation surface.
Block 12 (Address & Area Highlight): In addition to loading the customer's address and displaying an interactive aerial view, the system georeferences the imagery to cardinal directions and applies computer-vision methods to automatically identify and mask rooftop obstructions, presenting only unobstructed roof zones for selection.
Block 13 (Raw Area Measurement): Instead of measuring the entire highlighted region, the system now computes square footage only of the unobstructed, georeferenced zones.
Block 14 (Segmentation & Setback): The system partitions those unobstructed zones into rows or zones—respecting a four-foot perimeter margin from all edges and obstructions—to yield the final net usable area.
Capacity & Yield Calculation (Block 15): The system multiplies the net usable area by the standard irradiance factor (7.81 W/ft²) to determine array capacity in kilowatts, then projects annual energy output by applying 8,760 hours/year and a site-specific performance multiplier (e.g., 0.17 for the Mid-Atlantic).

Upon completion of blocks 11-15, the system outputs a preliminary solar array specification—comprising the array's rated capacity (kW) and estimated annual generation (kWh)—which is forwarded to the cost, incentives, depreciation, and financing modules for comprehensive financial modeling.

Referring to FIGS. 1G-1I, the system implements an “Auto design of solar for land applications” module that branches from the generic solar-variant path of the Swim-Lane flow of FIGS. 1A-1F. This module automates site-type recognition, land-area delineation, panel alignment strategies, and preliminary array sizing and energy-yield estimation for groundmount-installations, thereby generating the core inputs for downstream cost and financial modeling. Within this module, blocks 16-20 of FIGS. 1G-1I execute as follows:
Site Selection (Block 16): The system recognizes that the customer has specified a raw land parcel as the installation surface.
Block 17 (Address & Area Highlight): In addition to retrieving the site address and loading the interactive map, the system georeferences the imagery to cardinal directions and uses computer-vision to auto-delineate the selected land parcel, presenting only usable terrain for highlighting.
Block 18 (Raw Area Measurement): The system computes square footage solely of the georeferenced, unobstructed land area highlighted by the user.
Block 19 (Panel Alignment Optimization): Building on the georeferenced parcel, the system arranges panel rows in straight, cardinal-aligned lines across unobstructed terrain to maximize irradiance capture.
Capacity & Yield Calculation (Block 20): The system multiplies the usable land area by the irradiance factor (7.81 W/ft²) to determine array capacity in kilowatts, then projects annual generation by applying 8,760 hours/year and a regional performance multiplier (e.g., 0.17 for the Mid-Atlantic).

Upon completion of blocks 16-20, the system produces a preliminary ground-mount solar array specification—comprising the array's rated capacity (kW) and estimated annual generation (kWh)—which is forwarded to the cost, incentives, depreciation, and financing modules for comprehensive financial modeling.

Referring to FIGS. 1G-1I, once the system has produced a preliminary solar array specification via one of the four “Auto design” branches (blocks 1-5, 6-10, 11-15 or 16-20), it transitions into a common downstream module comprising blocks 21-25. This module standardizes the cost and financial-modeling workflow irrespective of the installation surface, ensuring that all emission-priority designs undergo identical economic analysis.
Block 21: First Cost and Annual Cost Computation
The system calculates the one-time system installation cost by multiplying the array's rated capacity (in watts) by a tiered cost-per-watt factor based on system size. Concurrently, it determines:
   Annual Operations & Maintenance (O&M) Cost: kWh/year x $0.005/kWh
   Annual Soft Costs: a fixed allowance (e.g., $2 K insurance+$1 K legal).
Block 22: Incentive Application
The system applies applicable incentives to adjust net project economics, including:
   Solar Renewable Energy Certificates (SREC) at $50/MWh;
   Production Tax Credit (PTC) at $0.02/kWh;
   One-time rebates and Investment Tax Credit (ITC) at 24% of system cost;
   Other region-specific credits or grants.
Block 23: Depreciation Modeling
Based on user selection, the system computes tax depreciation using either:
   Modified Accelerated Cost Recovery System (MACRS) schedules (e.g., 3-, 5- or 7-year); or
   Straight-line depreciation over a chosen term.
Block 24: Financing Scenario Analysis
If the customer elects financing, the system models loan or lease payments by applying a financing rate equal to a reference Treasury-bill rate plus a credit-spread margin (e.g., 120 bps for BBB+), over a specified term (e.g., 20 years). It computes payments both:
   Pre-ITC (on total system cost); and
   Post-ITC (on net cost after tax credit).
Block 25: Aggregate Outputs
The system compiles all generated data into a consolidated result set, including:
   Total installed cost;
   Annual O&M and soft costs;
   Net depreciable basis;
   Incentive and credit values;
   Financing payment schedules;
   Key performance metrics (simple payback, IRR, ROI); and
   Levelized cost of energy ($/kWh) before and after incentives.

These outputs are then relayed to the recommendation-dashboard module of the Swim-Lane flow (FIGS. 1A-1F) for final presentation to the customer.

Embodiments of the present invention include various features which are inherently technical in nature. For example, various features of embodiments of the present invention are necessarily rooted in computer technology and cannot practically be performed in the human mind.

For example, the use of machine learning models to evaluate DER system variants and predict performance characteristics involve computational processes that are inherently technical and rooted in computer technology. The variant evaluation module 310 may employ complex machine learning algorithms, such as neural networks, random forests, or support vector machines to process large volumes of data and generate accurate predictions. These algorithms may operate on high-dimensional feature spaces, potentially incorporating hundreds or thousands of variables that describe DER system characteristics, environmental conditions, and historical performance data.

For example, a neural network used in the variant evaluation module 310 may consist of multiple layers with numerous interconnected nodes, each performing non-linear transformations on input data. The training process for such a network may involve iterative optimization of millions of parameters through techniques like backpropagation, which may require substantial computational resources and may be infeasible to perform manually. Similarly, random forest algorithms and support vector machines used in the evaluation process involve computationally intensive operations—such as generating and analyzing thousands of decision trees or finding optimal hyperplanes in high-dimensional spaces—that exceed human cognitive capabilities and cannot be practically performed without computer assistance.

The variant evaluation module 310 may process and analyze data volumes on the order of gigabytes or terabytes, potentially including time-series data with high temporal resolution, geospatial information, and multidimensional performance metrics. The speed and accuracy with which machine learning models can process this data and generate predictions may far exceed human analytical capabilities.

Furthermore, these machine learning models may adapt and improve their performance over time as they are exposed to new data. This continuous learning process may involve complex statistical operations and model updates that may be impractical to perform manually. The ability to automatically refine predictions based on accumulating data may enable the system to maintain accuracy and relevance in dynamic energy environments.

Embodiments of the invention may simultaneously employ multiple distinct machine learning models, each trained on specialized datasets to perform different functions within the method 200 and system 300. For example, the system may utilize separate models for resiliency evaluation, decarbonization analysis, financial forecasting, and energy conservation optimization, with each model containing millions of parameters optimized for its specific domain. These models may operate in parallel, processing different aspects of the same input data to generate comprehensive, multi-dimensional analyses that would be impossible for humans to compute manually. The coordination and integration of outputs from these diverse models represents a technical approach that is necessarily rooted in computer technology and fundamentally exceeds human cognitive capabilities in both scale and complexity.

Embodiments of the present invention address the technical problem of accurately evaluating complex distributed energy resource configurations in environments characterized by high dimensionality, temporal variability, and intricate interdependencies between components. Traditional analytical methods are incapable of processing the vast amounts of heterogeneous data required for optimal DER configuration, resulting in suboptimal energy systems that fail to maximize efficiency, resilience, and cost-effectiveness. The technical solution provided by embodiments of the present invention's machine learning features includes specialized neural network architectures with both hard and soft layers that efficiently process multi-modal energy data, adaptive algorithms that continuously refine predictions based on real-time performance feedback, and parallel processing of domain-specific models that capture complex non-linear relationships between energy variables. This technical approach enables the system to overcome computational barriers in DER optimization, producing quantifiable improvements in energy efficiency, grid stability, and carbon reduction that directly contribute to solving technical challenges in energy distribution and management systems.

Embodiments of the present invention incorporate real-time simulation capabilities for modeling microgrid systems that are inherently technical and necessarily rooted in computer technology. The variant evaluation module 310 performs complex simulations modeling interactions between multiple DER components, including transitions between grid-connected and islanded modes. These simulations process large volumes of data in millisecond intervals to accurately represent dynamic microgrid behavior, requiring computational speed and precision beyond human capabilities.

The module employs sophisticated numerical methods to solve complex differential equations governing electrical system behavior, accounting for power flow, voltage regulation, frequency control, and thermal constraints across interconnected components. These simulations may incorporate adaptive algorithms that continuously adjust models based on incoming data streams, perform parallel simulations of multiple scenarios simultaneously, and integrate machine learning models trained on historical data. The interface module 316 generates dynamic, interactive visualizations of these complex system behaviors, enabling analysis impossible with static, manually-produced representations. Through these advanced computational capabilities, the invention provides real-time insights into microgrid performance that extend beyond what is practically achievable through human mental processes alone.

Embodiments of the present invention address the technical problem of accurately predicting the behavior of complex distributed energy systems under varying operational conditions, which traditional simulation methods cannot adequately solve due to their inability to process the vast number of variables and non-linear interactions involved in real-world microgrids. This technical problem has significant industrial implications, as suboptimal DER configurations lead to grid instability, inefficient resource utilization, and increased operational costs. The technical solution provided by embodiments of the present invention's simulation features includes specialized algorithms that efficiently model power flow dynamics across heterogeneous energy resources, adaptive control mechanisms that maintain system stability during mode transitions, and predictive analytics that optimize resource dispatch based on forecasted conditions. These simulation capabilities enable more reliable integration of renewable energy sources into existing grid infrastructure, improve resilience against supply disruptions, and enhance overall system efficiency—delivering quantifiable industrial benefits including reduced energy costs, decreased carbon emissions, and improved grid stability across various industrial sectors.

Embodiments of the present invention incorporate machine learning techniques for generating synthetic customer-specific data that are inherently technical and necessarily rooted in computer technology. The synthetic data generation module 308 employs methods such as generative adversarial networks (GANs) and variational autoencoders (VAEs) to create artificial data mimicking real customer data's statistical properties. These techniques involve complex neural network architectures with millions of parameters being optimized simultaneously, requiring substantial computational resources that exceed human cognitive capabilities.

The synthetic data generation process handles large volumes of high-dimensional data, including time-series energy consumption patterns and complex facility characteristics. The module captures intricate relationships across thousands of data points simultaneously and may continuously refine its models through transfer learning or online learning. In some embodiments, the module generates conditional synthetic data adhering to specific constraints, solving complex optimization problems in high-dimensional spaces. The quality of generated data is evaluated using sophisticated statistical measures and machine learning-based assessment techniques that require significant computational resources.

By leveraging these techniques, embodiments of the present invention address technical challenges in data availability, privacy preservation, and scenario exploration critical for comprehensive DER evaluation. This capability enables more robust testing and validation of DER configurations, potentially leading to more accurate recommendations in complex energy environments.

The invention addresses the specific technical problem of insufficient or incomplete energy consumption data for accurate DER system evaluation in industrial settings. Traditional energy planning approaches are limited by data gaps, privacy restrictions on sharing actual consumption data, and inability to model rare but critical operational scenarios. The technical solution provided by the synthetic data generation features employs specialized neural network architectures that generate statistically representative synthetic interval data at granular time scales (down to seconds), accurately modeling industrial load profiles while preserving confidentiality. This solution enables comprehensive testing of DER configurations under diverse operational conditions, directly improving grid stability, energy efficiency, and carbon reduction in industrial facilities. The synthetic data generation capabilities have quantifiable industrial applications in manufacturing, healthcare, and data center environments, where they enable more precise sizing and configuration of energy systems, resulting in measurable improvements in operational reliability and cost efficiency across these sectors.

Embodiments of the present invention provide a computer-implemented method for generating at least one distributed energy resource (DER) system configuration. The method includes creating site-specific data comprising at least one of receiving facility load profile data, retrieving data from at least one source other than the facility, or generating synthetic load profile data. The method further includes receiving weighting parameters for a multi-objective optimization function, where the weighting parameters define relative priorities among a plurality of performance metrics. The method also includes evaluating a plurality of DER system variants by applying at least one machine learning model to the site-specific data to predict performance characteristics of the plurality of DER system variants. Additionally, the method includes generating a plurality of candidate DER system configurations by applying an optimization process using the weighting parameters, producing an output comprising the at least one DER system configuration selected from the plurality of candidate DER system configurations and associated analytical data, and outputting the at least one DER system configuration via an interface enabling adjustment of at least one of the weighting parameters or the site-specific data and comparison of the candidate DER system configurations.

In some embodiments, the method further comprises simulating microgrid operation for at least one of the plurality of DER system variants across a plurality of operational modes including at least a grid-connected mode and an islanded mode, wherein the associated analytical data includes operational continuity metrics derived at least in part from the simulated microgrid operation. In other embodiments, generating the synthetic load profile data comprises generating the synthetic load profile data using a generative neural network. The generative neural network may comprise at least one of a generative adversarial network (GAN) or a variational autoencoder (VAE).

In further embodiments, the interface enabling adjustment of at least one of the weighting parameters or the site-specific data and comparison of the candidate DER system configurations comprises a parametric sensitivity analysis interface that recalculates the associated analytical data in response to adjustment of at least one of the weighting parameters or the site-specific data. The site-specific data may comprise at least one of environmental data or tariff data retrieved from at least one source other than the facility. The associated analytical data may include financial projections, emission reduction calculations, and operational continuity metrics. The optimization process may comprise at least one of a genetic algorithm, a particle swarm optimization algorithm, or an NSGA-II algorithm. Evaluating the plurality of DER system variants may comprise simulating the performance of the plurality of DER system variants individually and in combination with each other. Generating the synthetic load profile data may comprise generating the synthetic load profile data to supplement incomplete facility load profile data.

Embodiments of the present invention also provide a system comprising at least one non-transitory computer-readable medium having computer program instructions stored thereon, the computer program instructions being executable by at least one computer processor to perform the method described above, including creating site-specific data, receiving weighting parameters for a multi-objective optimization function, evaluating a plurality of DER system variants by applying at least one machine learning model, generating a plurality of candidate DER system configurations by applying an optimization process, producing an output comprising the at least one DER system configuration and associated analytical data, and outputting the at least one DER system configuration via an interface enabling adjustment and comparison.

Embodiments of the present invention may process substantial volumes of data that exceed human cognitive capabilities. For example, the customer-specific data 318 may include:
At least 1 million time-series data points representing energy consumption at 1-minute intervals over a 2-year period
A minimum of 10,000 distinct facility characteristics, including equipment specifications, operational schedules, and environmental parameters
No fewer than 100,000 geospatial data points mapping energy infrastructure and potential DER installation locations

The variant evaluation module 310 may analyze performance characteristics 322 that encompass:
At least 500,000 simulated operating scenarios for each DER system variant
A minimum of 1,000 performance metrics evaluated for each scenario
No fewer than 10 million total data points processed to generate comprehensive performance profiles

The configuration generation module 312 may produce candidate DER configurations 324 involving:
At least 100,000 unique DER system combinations
A minimum of 1,000 parameters optimized for each configuration
No fewer than 1 billion total configuration variations evaluated

Machine learning models employed by the system may incorporate:
Neural networks with at least 100 layers and 10 million trainable parameters
Random forests comprising a minimum of 10,000 decision trees
Support vector machines operating in feature spaces with no fewer than 1,000 dimensions

The system may process these large datasets with remarkable efficiency:
Evaluating 1 million data points in under 100 milliseconds
Generating 100,000 candidate DER configurations in less than 1 second
Producing comprehensive DER recommendations from raw input data in under 5 minutes

These quantitative examples (which are merely examples) illustrate the scale and complexity of data processing performed by embodiments of the invention, demonstrating capabilities that far exceed human mental processing capacities.

The method 200 illustrated in FIG. 2 is presented as an integrated process for evaluating and recommending distributed energy resource (DER) system configurations. However, it is important to note that the steps of method 200 possess inherent flexibility and modularity. Any one or more of the steps of method 200 may be executed independently of any one or more other steps. This modular approach allows for customization and adaptation of the method to various use cases and scenarios.

Furthermore, the method 200 is not constrained to a fixed sequence or comprehensive execution. Any one or more steps of the method 200 may be omitted entirely, depending on the specific requirements or constraints of a given situation. This flexibility enables users to tailor the method to their particular needs, focusing on the most relevant aspects of DER evaluation and recommendation.

In addition, the method 200 may be designed to accommodate external inputs and partial execution. Any one or more steps of the method 200 may be performed externally, with the results of such external processes being integrated into the method 200 to inform one or more subsequent steps. This capability allows for seamless integration with existing systems, processes, or expertise that may exist outside the scope of the method 200.

As a specific example of this flexibility, consider a scenario in which a customer has already created or obtained their own DER system configuration through external means. In this case, the customer may provide their pre-existing system configuration to the method 200. The method 200 may then execute only a subset of its steps, such as generating a price estimate for the customer-provided system configuration. This partial execution demonstrates the method's ability to add value even when not performed in its entirety, adapting to the customer's specific needs and leveraging externally generated inputs.

In another example, a customer may provide an externally-generated DER configuration, and the method 200 may analyze this configuration using the variant evaluation module 310 to identify potential improvements. The method 200 may then recommend modifications to the customer's configuration, such as adjusting the sizing of components, suggesting additional complementary technologies, or proposing alternative operational strategies. These recommendations may be generated using any of the machine learning techniques, simulation capabilities, or optimization algorithms disclosed herein. For instance, the system may apply its predictive models to identify that adding a specific amount of battery storage to the customer's solar configuration could significantly improve its resilience metrics or financial performance.

This modular and flexible approach enhances the versatility and applicability of the method 200, allowing it to be tailored to a wide range of scenarios and user requirements in the complex landscape of distributed energy resource planning and implementation.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A computer-implemented method for generating at least one distributed energy resource (DER) system configuration, the method comprising:
(A) creating site-specific data comprising at least one of:
receiving facility load profile data;
retrieving data from at least one source other than the facility; or
generating synthetic load profile data;
(B) receiving weighting parameters for a multi-objective optimization function, the weighting parameters defining relative priorities among a plurality of performance metrics;
(C) evaluating a plurality of DER system variants by applying at least one machine learning model to the site-specific data to predict performance characteristics of the plurality of DER system variants;
(D) generating a plurality of candidate DER system configurations by applying an optimization process using the weighting parameters;
(E) producing an output comprising the at least one DER system configuration selected from the plurality of candidate DER system configurations and associated analytical data; and
(F) outputting the at least one DER system configuration via an interface enabling adjustment of at least one of the weighting parameters or the site-specific data and comparison of the candidate DER system configurations.

2. The method of claim 1, further comprising simulating microgrid operation for at least one of the plurality of DER system variants across a plurality of operational modes including at least a grid-connected mode and an islanded mode, wherein the associated analytical data includes operational continuity metrics derived at least in part from the simulated microgrid operation.

3. The method of claim 1, wherein generating the synthetic load profile data comprises generating the synthetic load profile data using a generative neural network.

4. The method of claim 3, wherein the generative neural network comprises at least one of a generative adversarial network (GAN) or a variational autoencoder (VAE).

5. The method of claim 1, wherein the interface enabling adjustment of at least one of the weighting parameters or the site-specific data and comparison of the candidate DER system configurations comprises a parametric sensitivity analysis interface that recalculates the associated analytical data in response to adjustment of at least one of the weighting parameters or the site-specific data.

6. The method of claim 1, wherein the site-specific data comprises at least one of environmental data or tariff data retrieved from at least one source other than the facility.

7. The method of claim 1, wherein the associated analytical data includes financial projections, emission reduction calculations, and operational continuity metrics.

8. The method of claim 1, wherein the optimization process comprises at least one of a genetic algorithm, a particle swarm optimization algorithm, or an NSGA-II algorithm.

9. The method of claim 1, wherein evaluating the plurality of DER system variants comprises simulating the performance of the plurality of DER system variants individually and in combination with each other.

10. The method of claim 1, wherein generating the synthetic load profile data comprises generating the synthetic load profile data to supplement incomplete facility load profile data.

11. A system comprising at least one non-transitory computer-readable medium having computer program instructions stored thereon, the computer program instructions being executable by at least one computer processor to perform a method, the method comprising:
(A) creating site-specific data comprising at least one of:
receiving facility load profile data;
retrieving data from at least one source other than the facility; or
generating synthetic load profile data;
(B) receiving weighting parameters for a multi-objective optimization function, the weighting parameters defining relative priorities among a plurality of performance metrics;
(C) evaluating a plurality of DER system variants by applying at least one machine learning model to the site-specific data to predict performance characteristics of the plurality of DER system variants;
(D) generating a plurality of candidate DER system configurations by applying an optimization process using the weighting parameters;
(E) producing an output comprising the at least one DER system configuration selected from the plurality of candidate DER system configurations and associated analytical data; and
(F) outputting the at least one DER system configuration via an interface enabling adjustment of at least one of the weighting parameters or the site-specific data and comparison of the candidate DER system configurations.

12. The system of claim 11, wherein the method further comprises simulating microgrid operation for at least one of the plurality of DER system variants across a plurality of operational modes including at least a grid-connected mode and an islanded mode, wherein the associated analytical data includes operational continuity metrics derived at least in part from the simulated microgrid operation.

13. The system of claim 11, wherein generating the synthetic load profile data comprises generating the synthetic load profile data using a generative neural network.

14. The system of claim 13, wherein the generative neural network comprises at least one of a generative adversarial network (GAN) or a variational autoencoder (VAE).

15. The system of claim 11, wherein the interface enabling adjustment of at least one of the weighting parameters or the site-specific data and comparison of the candidate DER system configurations comprises a parametric sensitivity analysis interface that recalculates the associated analytical data in response to adjustment of at least one of the weighting parameters or the site-specific data.

16. The system of claim 11, wherein the site-specific data comprises at least one of environmental data or tariff data retrieved from at least one source other than the facility.

17. The system of claim 11, wherein the associated analytical data includes financial projections, emission reduction calculations, and operational continuity metrics.

18. The system of claim 11, wherein the optimization process comprises at least one of a genetic algorithm, a particle swarm optimization algorithm, or an NSGA-II algorithm.

19. The system of claim 11, wherein evaluating the plurality of DER system variants comprises simulating the performance of the plurality of DER system variants individually and in combination with each other.

20. The system of claim 11, wherein generating the synthetic load profile data comprises generating the synthetic load profile data to supplement incomplete facility load profile data.
